(19) United States
(12) Patent Application Publication
(10) Pub. No.: US 2025/0223222 A1
(43) Pub. Date: Jul. 10, 2025

(54) Cementitious Materials And Structures Produced Therefrom

(71) Applicant: QUANTUM FORGE, LLC, College Station, TX (US)

(72) Inventors: Mark Holtzapple, College Station, TX (US); David Carrabba, Bryan, TX (US)

(21) Appl. No.: 18/844,329

(22) PCT Filed: Mar. 4, 2023
(86) PCT No.: PCT/US2023/063746

§ 371 Date: Mar. 13, 2025

Related U.S. Application Data
(60) Provisional application No. 63/316,974, filed on Mar. 5, 2022.

(51) Int. Cl. C04B 7/02; C04B 28/04; C04B 103/30

(52) U.S. Cl. CPC C04B 7/02; C04B 28/04; C04B 2103/308

(57) ABSTRACT

Cementitious materials can be used to create structures for energy-efficient buildings, roads, artificial reefs, fencing, decking, and other applications. Cementitious materials can be composed of calcium, magnesium, and iron carbonates, thus creating a beneficial use for captured carbon dioxide. In some cases, the raw materials from which the carbonates are derived are waste products from desalination and metal processing, thus creating a beneficial use for these materials as well. Cementitious materials can also be composed of pozzolanic materials. Various methods are employed to strengthen the cementitious materials, thus increasing the breadth of their applications.

### CROSS-REFERENCE TO RELATED APPLICATIONS

This application is a national stage filing of PCT Application No. PCT/US23/63746, which claims priority to U.S. Provisional Application No. 63/316,974 filed on Mar. 5, 2022. PCT Application No. PCT/US23/63746 and U.S. Provisional Application No. 63/316,974 are incorporated by reference for all purposes.

### TECHNICAL FIELD

This disclosure is generally directed to structures. More specifically, this disclosure is directed to cementitious materials and structures created therefrom.

To address climate changes, the global economy must adapt. Some examples of required adaptations follow:

Carbon sequestration—When carbon is removed from flue gas or the atmosphere, economics improve when the carbon dioxide is used productively. Use of carbonate building materials has the potential to sequester carbon dioxide in a beneficial application. Strengthening these carbonate materials increases the potential markets where they can be employed.

Water desalination—Increasing global temperatures will increase droughts in some regions of the planet. Water shortages can be overcome by desalinating seawater, oilfield brine, and subterranean brackish water. After water is recovered, the residual salt must be disposed. Traditionally, in the case of seawater, it has been disposed in the ocean as concentrated brine, which can damage marine ecosystems. Zero-liquid discharge has less marine damage, but the remaining salt must be disposed, preferably in a productive manner that creates economic value.

Energy efficiency—Improving energy efficiency will reduce carbon dioxide emissions from the combustion of fossil fuels. Furthermore, improved efficiency reduces requirements for renewable energy, which improves economics. Building HVAC (heating, ventilation, air conditioning) systems consume a large amount of energy. Improving insulation of walls, floors, and ceilings reduces the load on HVAC systems, which reduces energy consumption and associated carbon dioxide emissions.

Coral habitats—As ocean temperatures increase, native coral die off. Temperature-resistant species can be re-introduced by attaching them to artificial reefs.

The above adaptations benefit from inexpensive, dimensionally stable, corrosion-resistant, high-performance materials.

### SUMMARY

According to an embodiment of the disclosure, cementitious materials are used to create structures for energy-efficient buildings, roads, artificial reefs, fencing, decking, and other applications. The cementitious materials can be composed of calcium, magnesium, and iron carbonates, thus creating a beneficial use for captured carbon dioxide. In some cases, the raw materials from which the carbonates are derived are waste products from desalination and metal processing, thus creating a beneficial use for these materials as well. The cementitious materials can also be composed of pozzolanic materials. Various methods are employed to strengthen the cementitious materials, thus increasing the breadth of their applications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### BRIEF DESCRIPTION OF THE DRAWING

The various features and advantages of the technology of the present disclosure will be apparent from the following description of particular embodiments of those technologies, as illustrated in the accompanying drawings. It should be noted that the drawings are not drawn to scale; however, the emphasis instead is being placed on illustrating the principles of the technological concepts. Also, in the drawings, the like reference characters refer to the same parts throughout the different views. The drawings depict only typical embodiments of the present disclosure and, therefore, are not to be considered limiting in scope.

FIGS. 1A and 1B show processes for capturing carbon dioxide from the atmosphere so it can be incorporated into carbonate building materials.

FIG. 2 shows the cost of synthetic limestone created from calcium oxide (quick lime) and carbon dioxide.

FIG. 3 shows literature data that characterizes the strength of calcium carbonate, magnesium carbonate, and their mixtures.

FIG. 4 shows the impact of initial water content in a mixture of water and magnesium hydroxide that is subsequently carbonated.

FIGS. 5A and 5B show the impact of adding calcium carbonate whiskers to synthetic limestone.

FIG. 6 shows the compressive strength of carbonate synthetic stone made from magnesium hydroxide and calcium carbonate.

FIG. 7 shows the compressive strength of carbonate synthetic stone made from calcium hydroxide and calcium carbonate derived from coral.

FIGS. 8A, 8B, and 8C show the impact of press pressure on the compression strength of carbonate synthetic stone.

FIG. 9 shows the impact of press time on the compression strength of carbonate synthetic stone.

FIGS. 10 and 11 show the impact on compression strength when calcium carbonate synthetic stones are soaked in water.

FIG. 12 shows the impact of initial magnesium carbonate content on compression strength of magnesium carbonate synthetic stone.

FIGS. 13A and 13B show the impact of varying the composition of calcium carbonate and calcium hydroxide in the initial mixture.

FIG. 14 shows that the discs fail from the outer radius inward.

FIGS. 15A and 15B compare the compression strength of calcium and magnesium carbonates.

FIG. 16 compares the impact of the platen material on strength measurements.

FIG. 17 shows the impact of glass fibers on the strength of calcium carbonate.

FIG. 18A shows the impact of glass fibers and graphene on the strength of magnesium carbonate.

FIG. 18B shows the impact of glass fibers and carbon nanotubes on the strength of magnesium carbonate.

FIG. 18C shows the impact of glass fibers on the strength of calcium and magnesium carbonates.

FIGS. 19A and 19B show the impact of glass screens on the compression strength of calcium carbonate.

FIGS. 20 and 21 show the impact of column thickness on the compression strength of magnesium carbonate without and with glass fibers, respectively.

FIGS. 22 and 23 show the impact of column thickness on the compression strength of magnesium carbonate with glass fibers at two different diameters.

FIG. 24 shows the strength of magnesium and calcium carbonate blends.

FIG. 25 shows the strength of discs made with layers of magnesium and calcium carbonates.

FIGS. 26A and 26B show stress/strain curves for columns containing cementitious material.

FIG. 27 shows the strength of columns containing cementitious material.

FIG. 28 shows the strength-to-mass ratio of columns containing cementitious material.

FIG. 29 shows the impact of thickness and diameter on the strength of Sakrete high-strength (4000-psi) concrete.

FIG. 30 shows the compression strength of columns containing portland cement, dolomite, and glass fibers.

FIGS. 31A, 31B, and 31C show the compression strength of columns containing portland cement and powdered aggregates.

FIGS. 32A and B show the compression strength of columns made from reactive powdered concrete (RPC).

FIG. 33A shows the titration curves for three salts added to calcium carbonate.

FIG. 33B shows the titration curves for monocalcium phosphate added to calcium carbonate and magnesium carbonate.

FIG. 34 shows the sequential steps for pressing a disc in which the compositions of the core and surface differ.

FIG. 35 shows a mold for creating parts with a conical geometry.

FIG. 36A shows a column created from stacked carbonate discs separated by crack arresters and wrapped by a tube.

FIG. 36B shows a column created from stacked carbonate discs separated by crack arresters and wrapped by high-strength fibers.

FIG. 36C shows a column created from stacked carbonate separated by crack arresters. A pump pressurizes grout that flows between the stacked column and the outer tube.

FIG. 36D shows the finished product resulting from the apparatus depicted in FIG. 36C.

FIG. 36E shows a cooling jacket surrounding the column depicted in FIG. 3D.

FIG. 36F shows a steel jacket filled with pressurized fluid pozzolanic material.

FIG. 36G shows a steel jacket filled with pressurized solid pozzolanic material.

FIG. 36H shows a steel jacket filled with pressurized fluid pozzolanic material and a center tube.

FIG. 36I shows a steel jacket filled with pressurized solid pozzolanic material and a center hole.

FIG. 36J shows a pipe filled with pozzolanic material with crack arresters segmenting the concreted into sections.

FIG. 36K shows hollow cementitious discs stacked around a central column. Crack arresters separate each disc.

FIG. 36L shows stacked hollow cementitious discs that self-align.

FIG. 36M shows stacked solid cementitious discs that self-align.

FIG. 36N shows a column wrapped with wires.

FIGS. 36O, 36P, and 36Q show apparatuses for pressurizing pozzolanic materials to high pressures within a pipe.

FIG. 37 shows the fractional decomposition of calcium and magnesium carbonate as a function of temperature

FIGS. 38A, 38B, 38C, and 38D show connectors that join together two vertical columns.

FIG. 38E shows a connector that mounts at the top of a vertical column.

FIG. 38F shows a connectors mounted to vertical columns that support trusses.

FIG. 39A shows three views of a block with concave and convex alignment surfaces.

FIGS. 39B, 39C, and 39D show block patterns that can be used with a straight road or pathway.

FIG. 39E shows block patterns that make a curve.

FIG. 39F shows three views of a block with concave and convex alignment surfaces, except on the sides.

FIG. 39G shows three views of a block with concave and convex alignment surfaces, except on the sides. Holes are included to increase the carbonation rate, and to allow for water to drain.

FIG. 39H shows three views of a block with convex alignment surfaces, except on the sides and top.

FIG. 39I shows three views of a block with concave alignment surfaces, except on the sides and top.

FIG. 39J shows an arch made from blocks.

FIG. 40A shows the top view of an articulating block wall.

FIG. 40B shows a front view of an articulating block wall.

FIG. 40C shows three views of an articulating block that forms an intermediate section of a wall.

FIG. 40D shows three views of an articulating block that forms the top section of a wall.

FIG. 40E shows three views of an articulating block that forms the bottom section of a wall.

FIG. 41A shows a top view and side view of plates and columns that form an artificial reef.

FIG. 41B shows an embodiment in which the columns and plates are secured through an internal ring that hardens.

FIG. 41D shows an embodiment in which the plates are perforated.

FIG. 41E shows an embodiment in which the columns are PVC pipe.

FIG. 42A shows two walls joined together in which the gap between the walls is insulated.

FIG. 42B shows two walls joined together by plates.

FIGS. 42C and 42D show two walls, floors, or ceilings joined together by columns or tubes.

FIG. 42E shows two walls, floors, or ceilings joined by a column that is secured by a ring that hardens.

FIG. 42F shows two walls, floors, or ceilings joined by sleeves.

FIG. 43 shows two walls, floors, or ceilings that are stiffened by ribs.

FIG. 44A shows tongue-and-grove joints between two sections of a wall.

FIG. 44B shows tongue-and-grove joints between two sections of a floor or ceiling.

FIG. 44C shows an end cap that can be inserted into sections of a wall, floor, or ceiling.

FIG. 44D shows an end cap with a threaded insert.

FIG. 44E shows a splicing insert that joins two hollow panels together.

FIG. 44F shows a right-angle corner.

FIG. 44G shows various methods for joining hollow panels.

FIGS. 45A, 45B, and 45C show stackable blocks aligned with pins.

FIG. 45D shows a stackable block with plastic film that protects the interior insulation.

FIG. 45E shows a stackable block being filled with foamed insulation.

FIG. 45F shows stackable corner blocks.

FIG. 46 shows a building created from the walls, floors, and ceilings.

FIG. 47 shows a building created from walls, floors, and ceilings composed of insulation-filled columns.

FIG. 48 shows a building supported by piers and beams with a solar panel roof.

FIGS. 49A and 49B show couplers that allow a house supported by piers and beams to be leveled.

FIG. 50A shows solar panel arrays that form a roof.

FIGS. 50B and 50C show overlapping joints for a solar panel array that forms a roof.

FIG. 50D shows a gasket system for sealing a solar panel roof.

### DETAILED DESCRIPTION

The figures described below and the various embodiments used to describe the principles of the present disclosure in are for illustrative purposes only and should not be construed as limiting the disclosure in any way. The principles of the present disclosure can be implemented in any type of suitably arranged device or system, as will be apparent to those skilled in the art. Moreover, the drawings are not always drawn to scale.

The tables referenced herein are provided in Appendix listed as Tables.

### Chemistry

Building materials such as bricks, roofing tiles, and floor tile are created by heating the raw materials to high temperatures. Table 1 shows the typical composition of bricks. At high temperatures, the alkalis and oxides fuse with the alumina and silica to form the solid brick.

Building materials such as concrete, cement, and grout are created by reacting raw materials with water. Table 2 shows the typical composition of portland cement. The reactions that occur in portland cement are complex. The following reactions are important and illustrative:

2(3CaO·SiO₂)+6H₂Oà3CaO·2SiO₂·3H₂O+3Ca(OH)₂

2(2CaO·SiO₂)+3H₂Oà3CaO·2SiO₂·3H₂O+Ca(OH)₂

Importantly, these reactions cause concrete to shrink resulting in undesirable cracks.

The pozzolanic reaction occurs between calcium oxide, silicon oxide, and water:

CaO+SiO₂+3H₂O→CaH₂SiO₄·2H₂O

where the final product is a hard cementitious material. The same pozzolanic reaction can occur with MgO rather than CaO. [21]

Non-hydraulic cement is formed from limestone according to the following sequence of reactions:

CaCO₃àCaO+CO₂ (˜900° C., ˜10 h)

CaO+H₂OàCa(OH)₂ (hydration)

Ca(OH)₂+CO₂àCaCO₃ (carbonation)

Historically, the final reaction is performed in the atmosphere. Because the atmospheric concentration of carbon dioxide is low (˜410 ppm by volume), the reaction is very slow.

Seawater contains large quantities of magnesium chloride. Evaporating seawater and other brines produces salt crystals that can be separated by differences in density via elutriation. Magnesium chloride crystals can be processed as follows:

MgCl₂+H₂OàMgO+2HCl (˜500° C.)

MgO+H₂OàMg(OH)₂ (hydration)

Mg(OH)₂+CO₂àMgCO₃+H₂O (carbonation)

Iron sulfate is a byproduct from the pickling of steel with sulfuric acid. Iron hydroxide is insoluble and can be produced from reaction with sodium hydroxide

FeSO₄+2NaOHàFe(OH)₂+Na₂SO₄ (hydration)

Fe(OH)₂+CO₂àFeCO₃+H₂O (carbonation)

In embodiments of this disclosure, many of the binding agents for making synthetic stones are carbonates of calcium, magnesium, or iron. The raw ingredients are mixed with the hydroxide, pressed at high pressure, and then carbonated at high pressure.

### Carbon Capture From Air

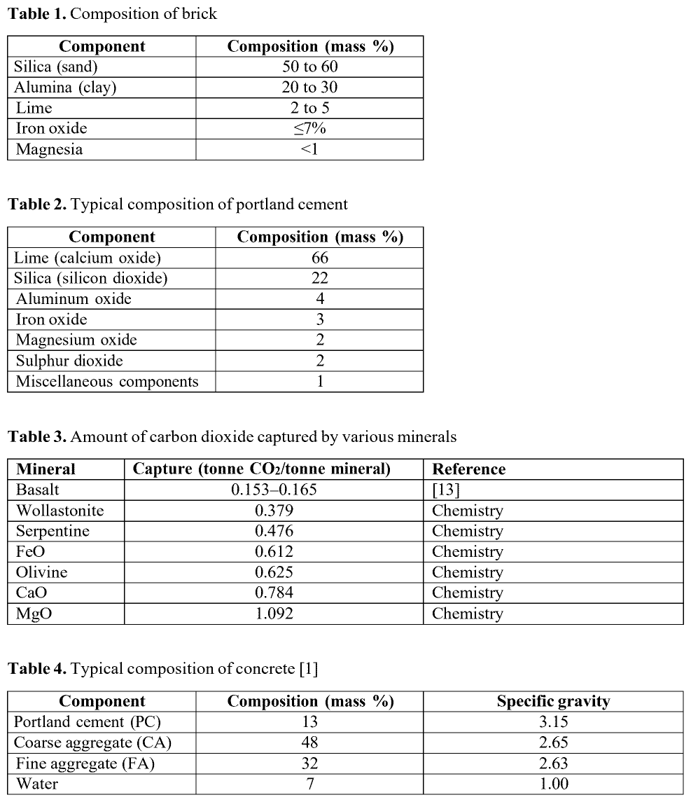

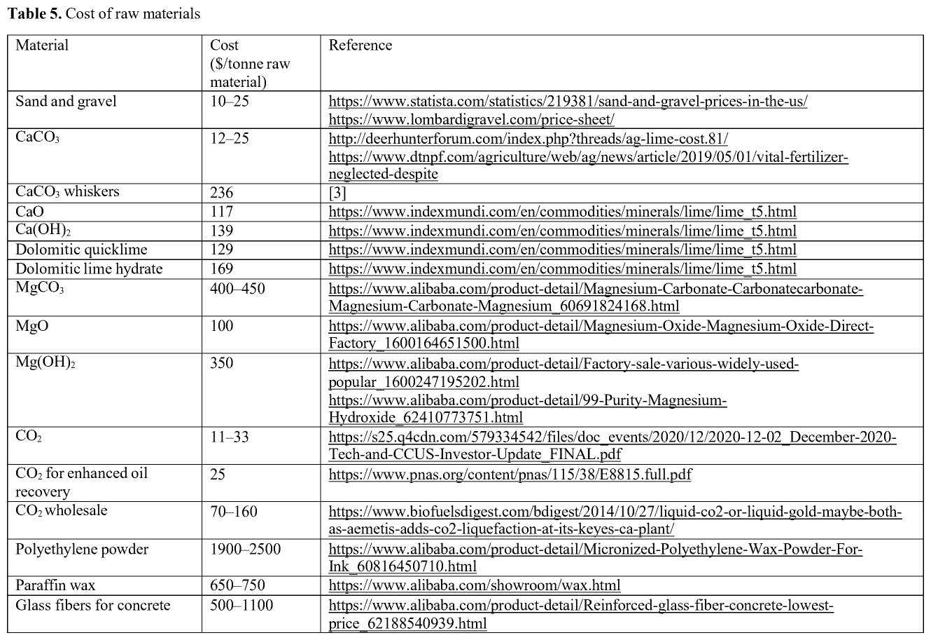

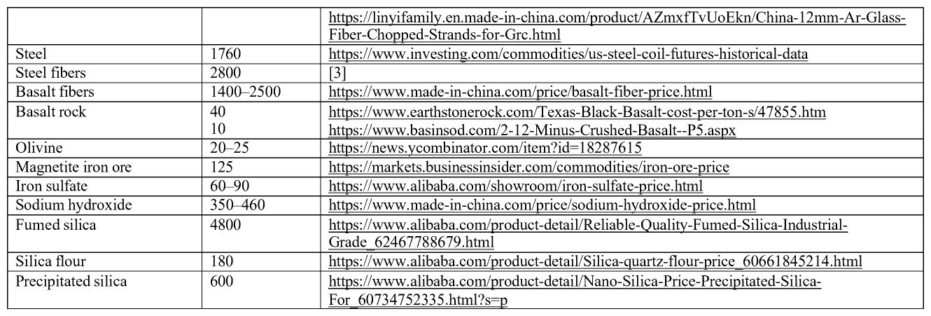

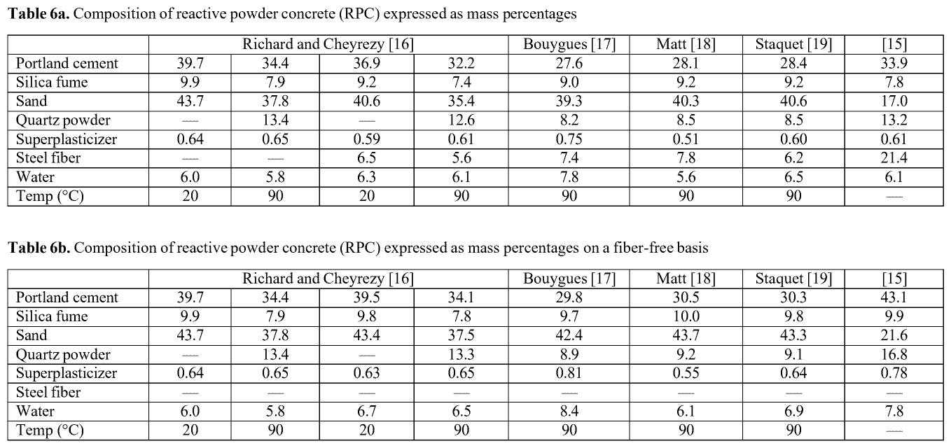

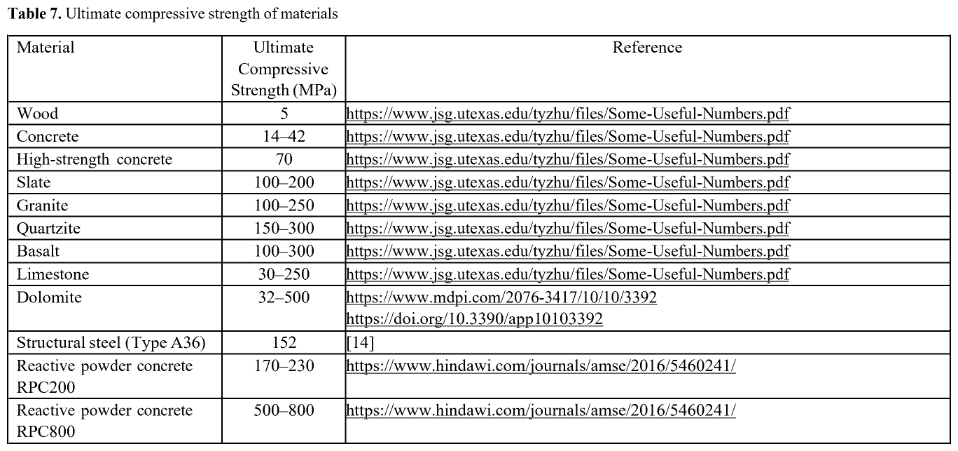

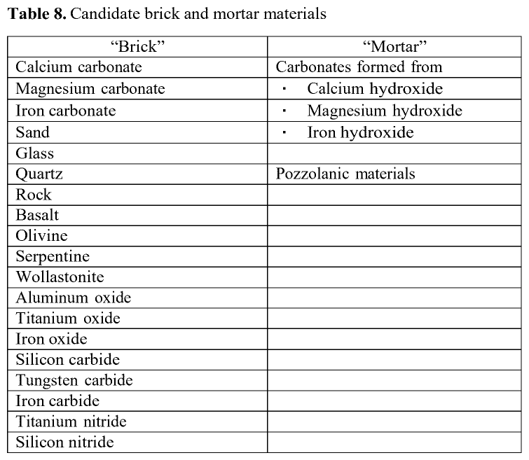

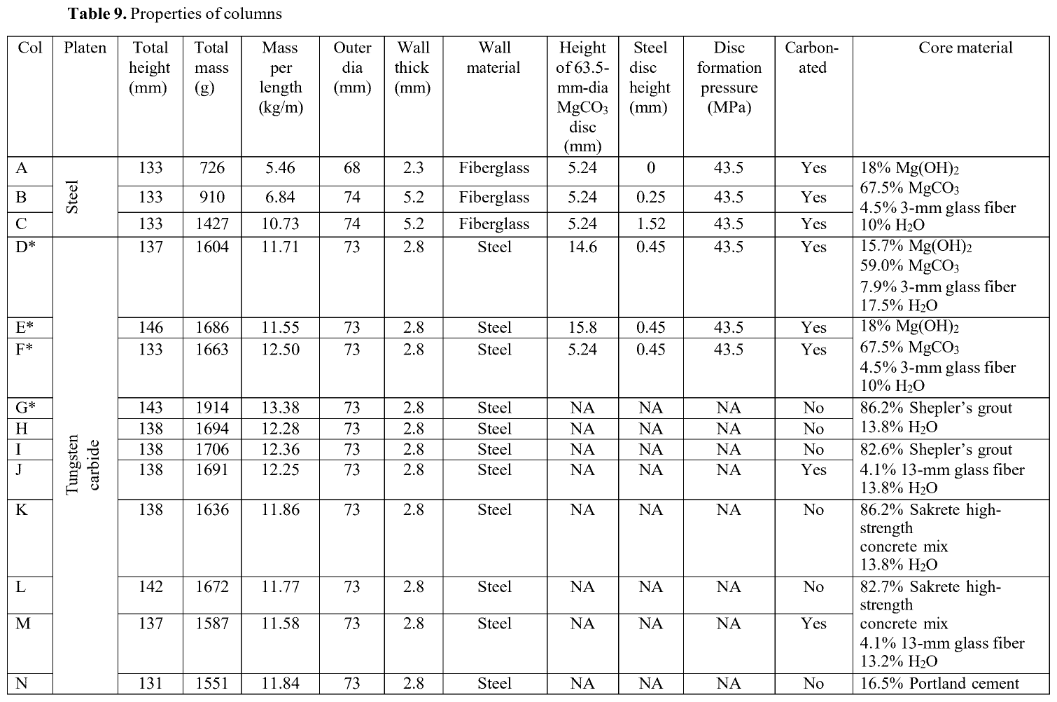

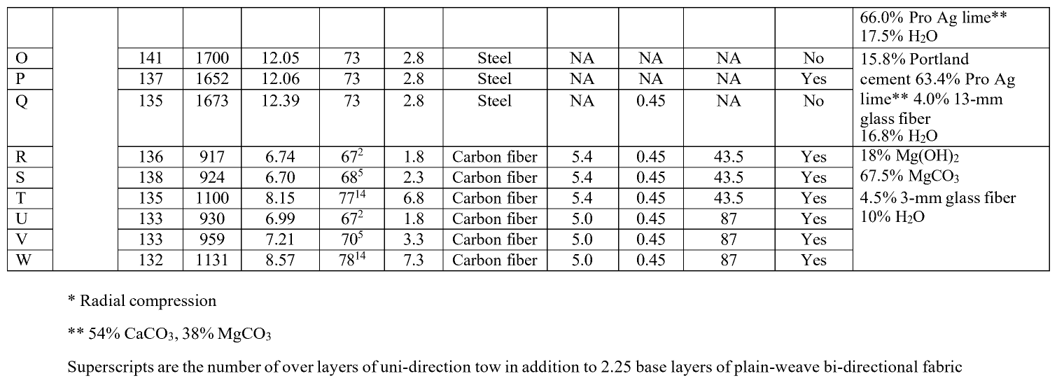

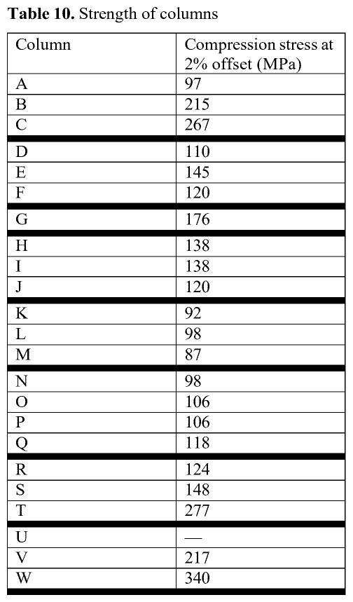

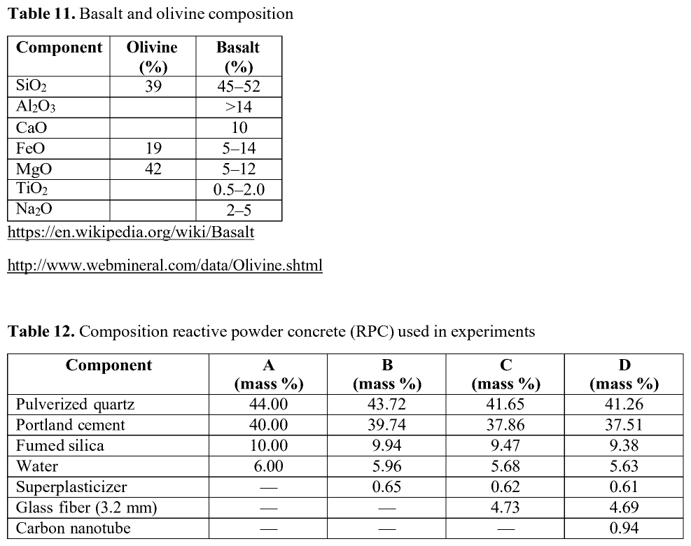

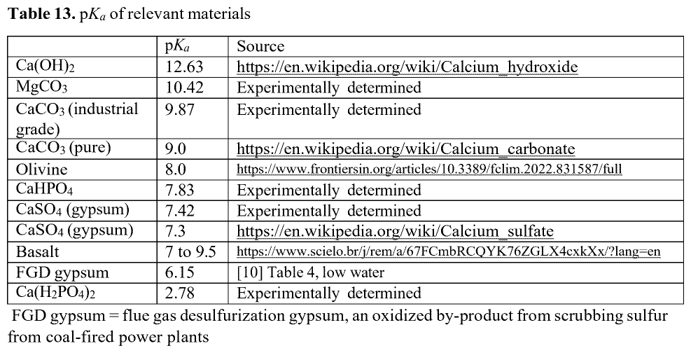

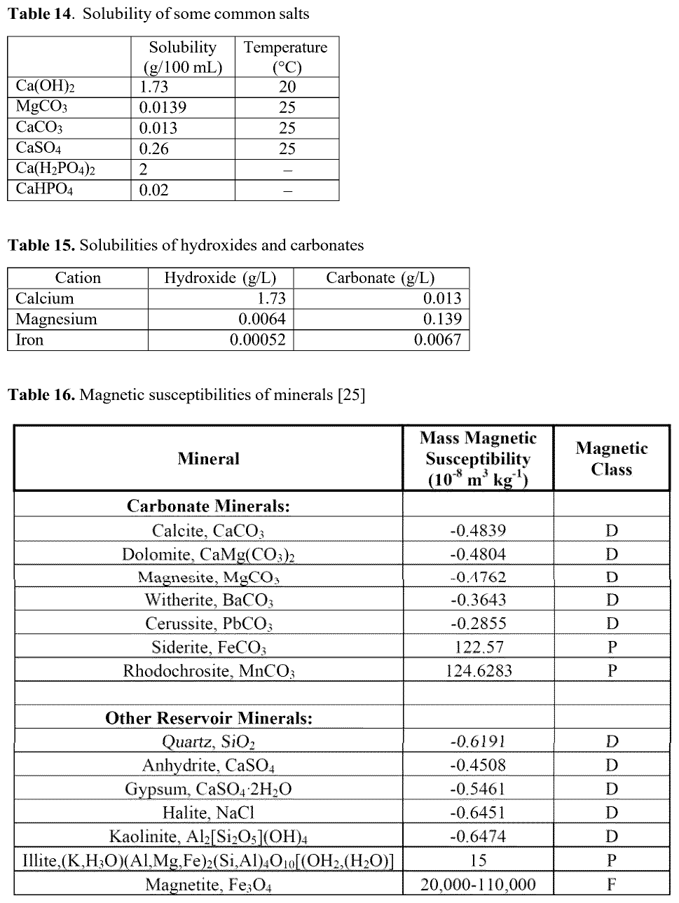

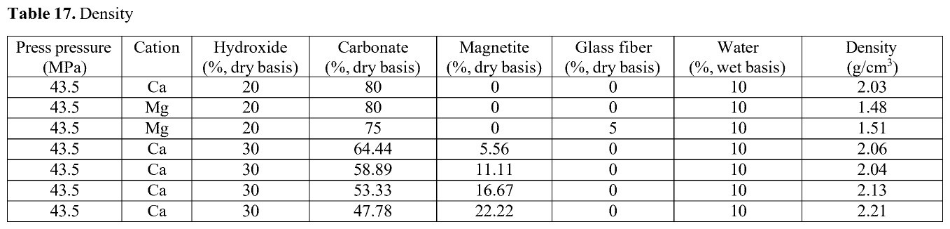

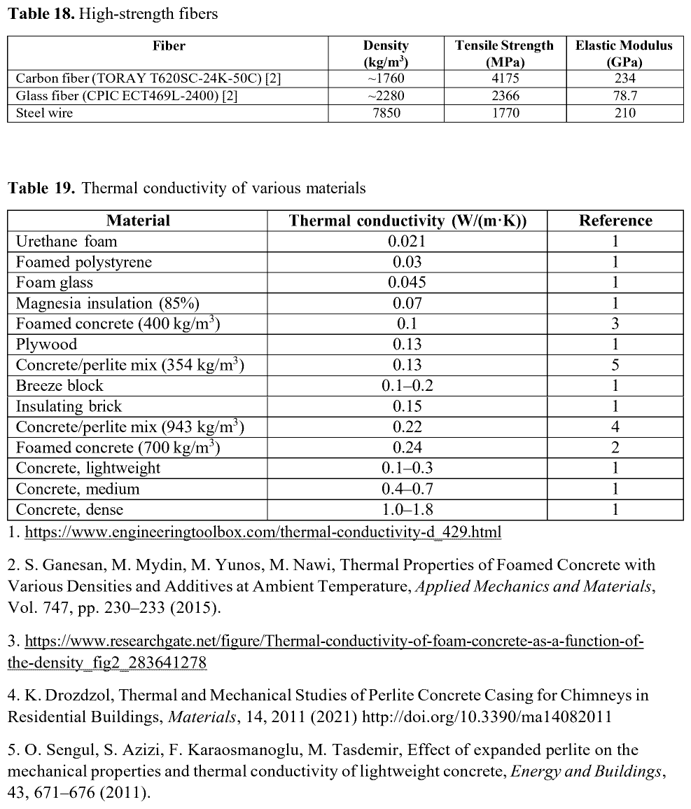

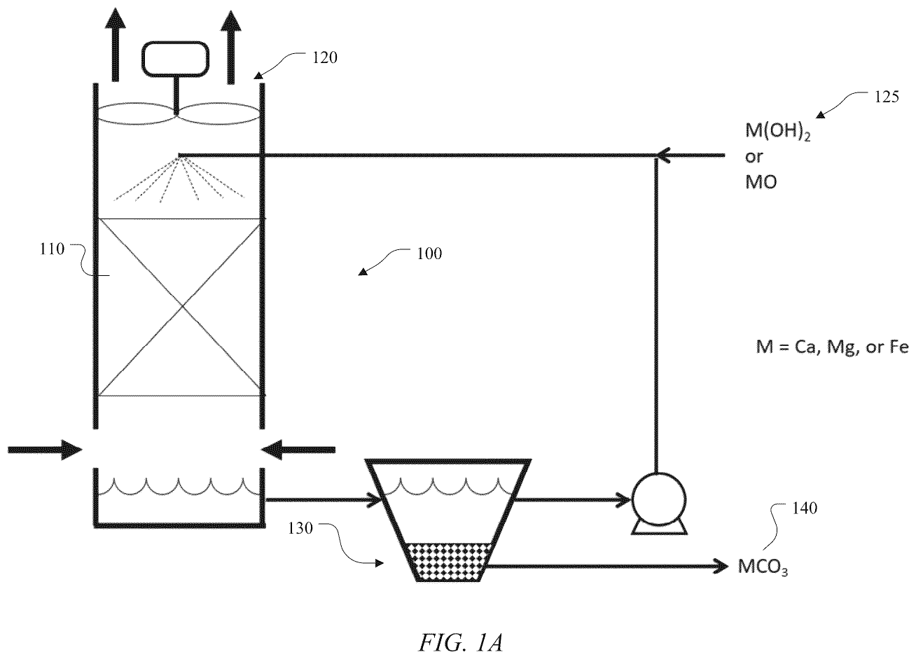

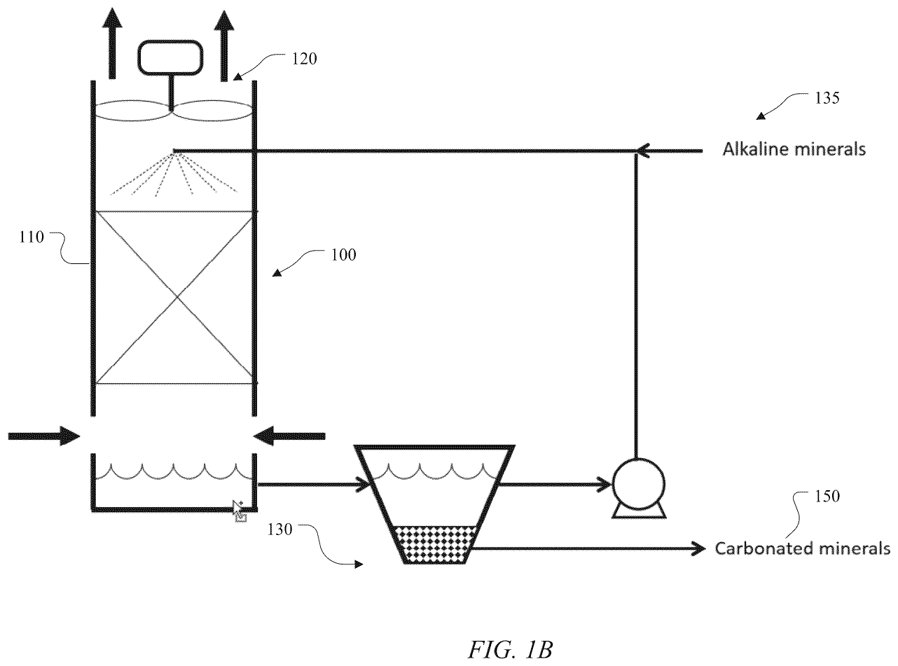

In some cases (calcium), carbonates are naturally present in abundance (e.g., limestone). In some cases, carbonates are naturally present in abundance as a mixture of calcium and magnesium carbonate (i.e., dolomite). In other cases (e.g., magnesium, iron), carbonates are not abundant and must be manufactured from abundant materials. In the latter cases, it is desirable to create the carbonates from atmospheric carbon dioxide, which is dilute and therefore difficult to capture and sequester. As shown in FIG. 1A, a conventional cooling tower 100 is employed. The cooling tower 100 is filled with a packing material 110 that enhances contact between water and air. Typically, a fan 120 enhances the flow of air through the wet packing 110. Such cooling towers are commonly employed in chemical plants, refineries, HVAC, and power plants. To maintain alkaline pH, the alkaline material 125—e.g., MgO (or Mg(OH)₂) or FeO (or Fe(OH)₂)—is metered into the circulating cooling water. As the alkaline components react with atmospheric carbon dioxide, the corresponding carbonates are formed. As the carbonate concentration rises, super-saturation is achieved causing the carbonates to precipitate allowing their removal in a settler 130. The settled carbonates 140 are harvested and incorporated into building materials. While specific details of one process is shown in FIG. 1A, one of ordinary skill will recognize that other configurations may contain more, less, or different components to yield the carbonates 140 Additionally, while specific carbonate are described here, other configurations may use other yielded carbonates.

FIG. 1B shows a process similar to FIG. 1B in which a fine suspension of naturally occurring alkaline minerals 135 circulates through the cooling tower 100. Non-limiting examples of such minerals include the following: basalt, olivine, serpentine, wollastonite. [12] When contacted with carbon dioxide from the atmosphere, carbonic acid forms and reacts with the alkaline components within the naturally occurring alkaline minerals, as shown in the following reactions:

Olivine: Mg₂SiO₄+2CO₂à2MgCO₃+SiO₂

Serpentine: Mg₃Si₂O₅(OH)₄+3CO₂à3MgCO₃+2SiO₂+2H₂O

Wollastonite: CaSiO₃+CO₂àCaCO₃+SiO₂

Basalt: CaO+CO₂àCaCO₃

MgO+CO₂àCaCO₃

FeO+CO₂àFeCO₃

Like FIG. 1A, the settled carbonates 150 are harvested.

Table 3 summarizes the amount of CO₂ captured by each mineral.

### Costs

Table 4 shows the typical composition of concrete, which is designed to be fluid so it can be pumped and cast in place. Typically, the coarse aggregate is stone and the fine aggregate is sand. Entrained air typically increases the volume by 4% [1]. Using the costs reported in Table 5, the cost of concrete can be estimated as follows:

$$\begin{matrix}Cost = \frac{0.13 t PC}{tonne} ′ \frac{\$124}{t PC} + \frac{0.48 t CA}{tonne} ′ \frac{\$25}{t CA} + \frac{0.32 t FA}{tonne} ′ \frac{\$25}{t FA} \\ = \frac{\$36 \text{.12}}{tonne concrete}\end{matrix}$$

The cost of synthetic limestone made from 10% Ca(OH)₂ and 90% CaCO₃ is estimate as follows:

$$\begin{matrix}Cost = \frac{0.1 t {{Ca ( OH )}_{2}}^{′} \begin{matrix}56 t CaO , \$117 \\ \end{matrix} + 0.1 t {{Ca ( OH )}_{2}}^{′} \begin{matrix}44 t {CO}_{2} , \$25 \\ \end{matrix} + 0.9 t {{CaCO}_{3}}^{′} \begin{matrix}\$25 \\ \end{matrix}}{0.1 t {{Ca ( OH )}_{2}}^{′} \begin{matrix}\overline{100 t {CaCO}_{3}} \\ 74 t {Ca ( OH )}_{2}\end{matrix} + 0.9 t {CaCO}_{3}} \\ = \frac{\$31 \text{.73}}{tonne {CaCO}_{3}}\end{matrix}$$

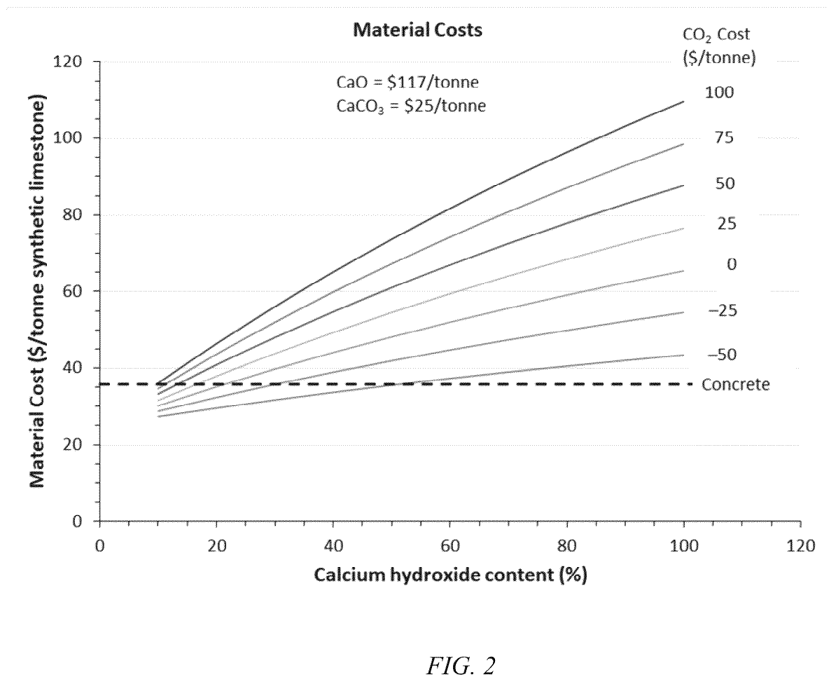

FIG. 2 shows the estimated material costs for other scenarios. The negative costs are based on tax credits for capturing carbon dioxide.

### Reactive Powder Concrete

Reactive powder concrete (RPC) can achieve exceptionally high compressive strengths [20]. Tables 6a and 6b describe typical compositions. The distinguishing features follow:
High percentage of portland cement
Low water: cement ratio
Addition of superplasticizer to enhance flowability at low water content
Finely divided components
Addition of high-surface-area silica (e.g., fumed silica) that undergoes pozzolanic reaction with cement
Formed at high pressure (e.g., 50 MPa)—optional
Addition of steel fibers to improve ductility—optional
Reacted at high temperature (90 to 400° C.)—optional

RPC utilizes very expensive components, so its use is limited to applications where high strength and low porosity are critical. The most expensive ingredient is fumed silica. The literature suggests that fumed silica can be replaced with less expensive materials (e.g., fly ash, rice husk ash, metakaolin, precipitated silica). Table 7 compares the strength of RPC to other materials.

### Literature Data

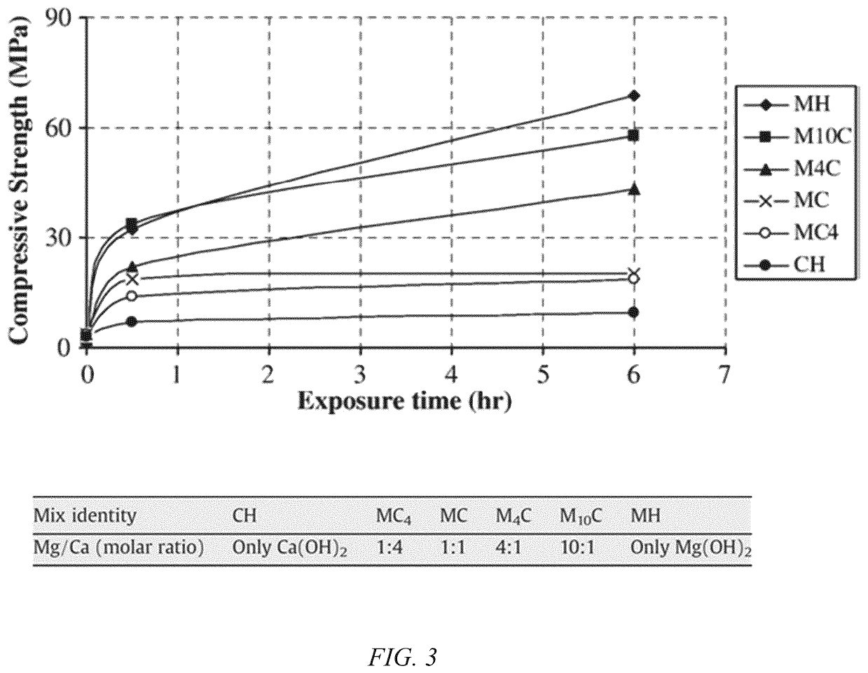

FIG. 3 shows literature data [23] describing the effect of carbonation time and Mg:Ca ratio on compressive strength. The conditions used in the experiment follow:
Water content=20% (wet basis)
Press pressure=2 MPa
Diameter=16 mm
Thickness=25 mm
CO₂ pressure=20 atm
Dry@23° C. for 24 h

After 6 h of carbonation, the compressive strengths of CaCO₃ and MgCO₃ are 10 and 70 MPa, respectively.

### Standard Experimental Procedure for Carbonated Materials

Weighed amounts of dry ingredients were placed in a container and shaken for a few minutes. Periodically, the container would be opened so contents that adhered to the wall could be scraped off. Shaking would resume for a few more minutes until the contents were well mixed. Then, water was added and mixed with a spoon until the contents were uniformly wet. To prevent adherence when pressing wet Ca(OH)₂/CaCO₃, plastic sheet was placed in the bottom and top of the mold. In contrast, wet Mg(OH)₂/MgCO₃ did not adhere to the mold, so plastic sheets were not required. A measured quantity of wet solids were placed in the mold. A constant pressure was applied for a time period, typically sufficiently long that the pressure would no longer change as the material rearranged itself under the effects of pressure. After the “greenware” pressed material was removed from the mold, it was placed in a pressure vessel. Initially, to purge air from the vessel, it was pressurized to 6.8 bar with CO₂, and then slowly (˜30 min) released. Then, the vessel was pressurized to 15 bar with CO₂ at ambient temperature. To ensure complete carbonation, the contents were held for at least 5 days. While such a period is described, in particular configurations, the optimal time can be determined based on the shape/size of the object, the CO₂ pressure, and temperature. After the carbonation was completed, the pressure was slowly (˜30 min) released to ensure no pressure gradients within the material caused damage. After removing the carbonated objects from the pressure vessel, to dry them, they were placed in an oven at ˜80° C. for about 2 days. Like before, while such a particular time is described, in particular configurations, the time can be determined based on the shape/size of the object, air circulation rate, and temperature. In this particular configuration, temperatures above 100° C. were avoided to ensure that the internal liquid water did not vaporize to steam and thereby create internal pressures that would break the carbonated materials. Exceptions to this protocol are noted on individual data sets.

Test samples were placed in a 100-ton press using platens of steel or tungsten carbide. During the press, two types of failure are reported typically:
Initial failure—Visual observation reveals a few cracks (3 to 5) on the outer perimeter.
Complete failure—The material fails catastrophically or is unable to maintain press pressure because it flows.

In some cases, the material reached the limit of the press, which is indicated as a horizontal dashed line in the graphs.

### Experimental Data

### Survey of Operating Conditions

This section is a survey of operating conditions. The material formulations and methods were tested using short pucks (a.k.a., discs), which conserves resources (materials, space in the carbonation reactor).

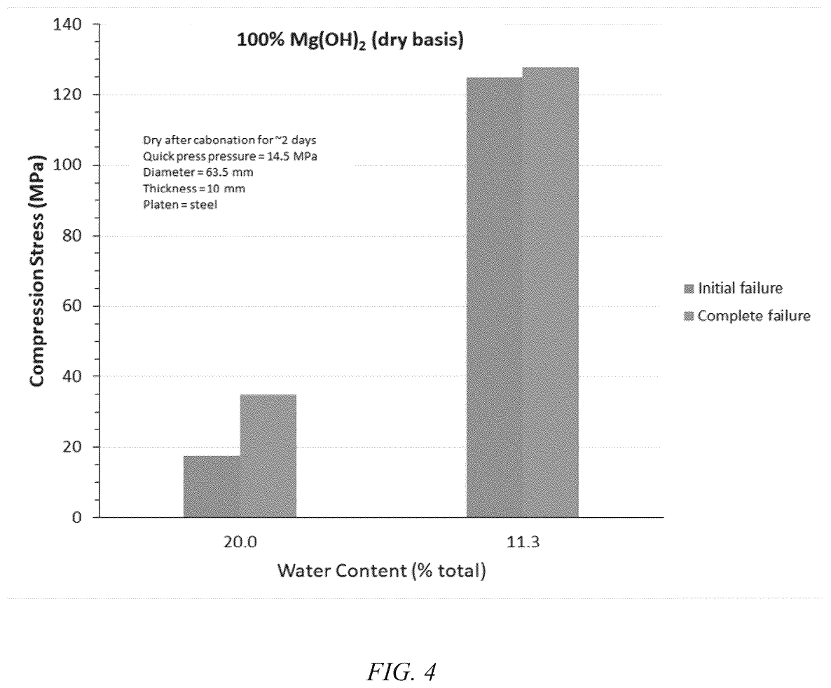

FIG. 4 shows the impact of two levels of water addition to Mg(OH)₂ during the press process. In this figure, the darker shading represents initial failure whereas the lighter shading represents complete failure. The lower water level is stronger. Some experiments were conducted with no water addition; however, the materials did not exit the press intact. Some water addition is helpful because it lubricates and allows the material to exit the press intact. In general, most of the experiments were conducted with 10% (wet basis) water addition. In many cases for Ca(OH)₂/CaCO₃, this amount of water addition was excessive and free water was observed after the press. For Mg(OH)₂/MgCO₃, no free water was observed after the press.

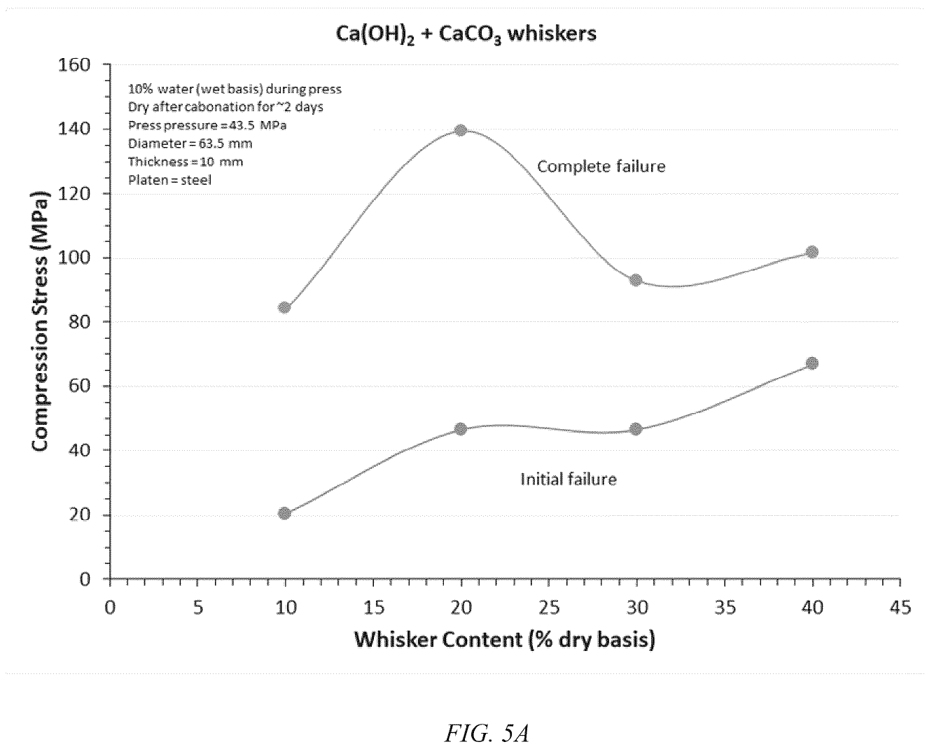

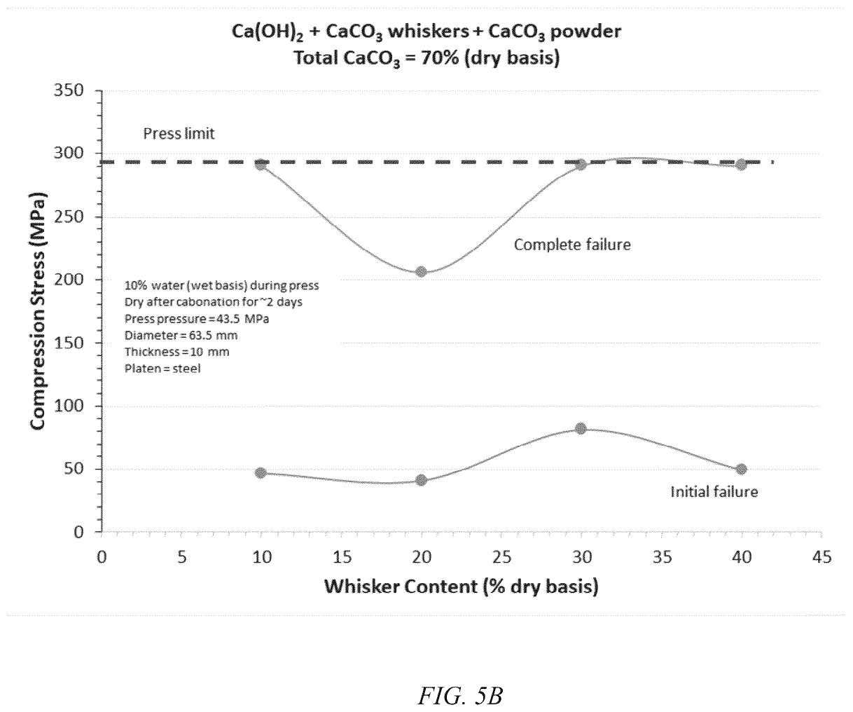

FIGS. 5A and 5B show the impact from adding CaCO₃ whiskers (20- to 30-micrometers) to strengthen carbonated Ca(OH)₂/CaCO₃. The compression strength is similar to other experiments without whiskers. Because whiskers are expensive, this additive was not investigated further.

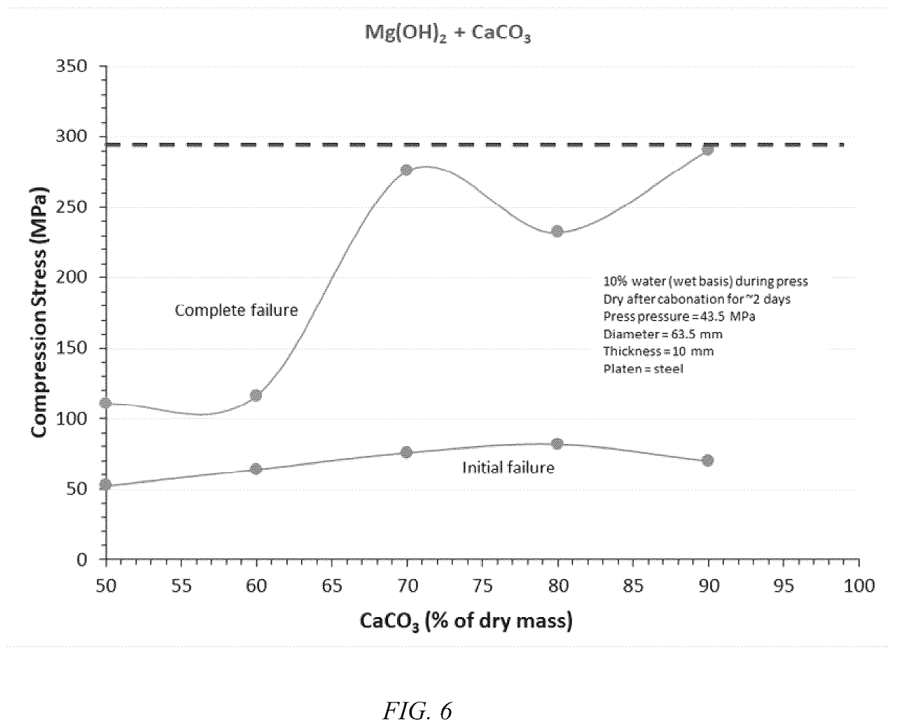

FIG. 6 shows the results from binding CaCO₃ by carbonating Mg(OH)₂. The results are similar to other experiments using Ca(OH)₂ as the binder, so this combination was not investigated further.

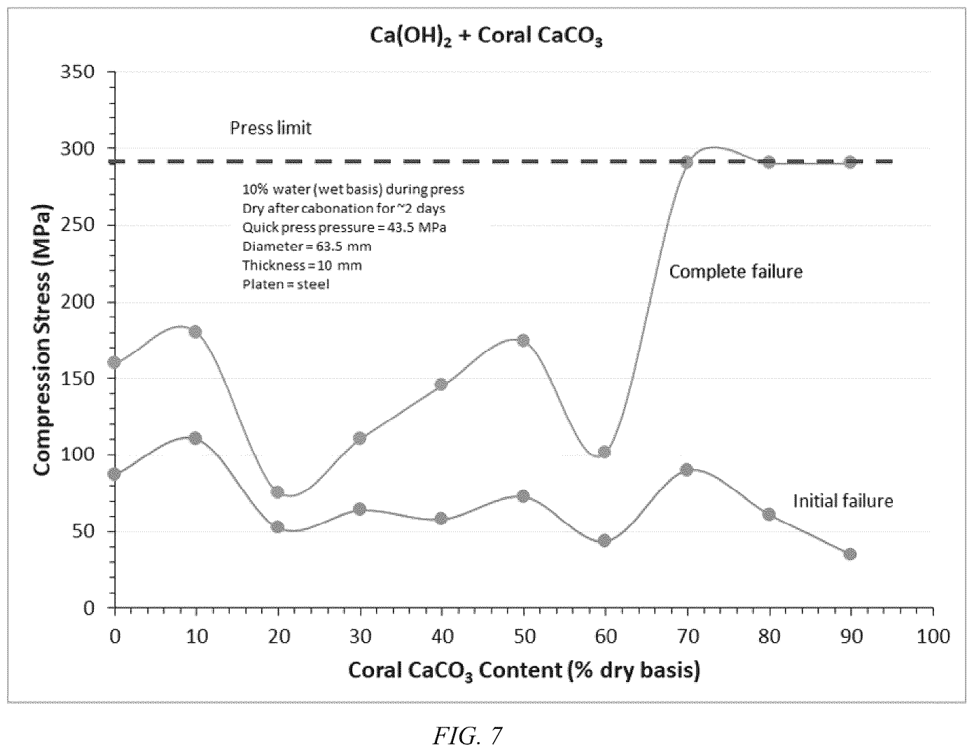

FIG. 7 shows the impact of adding CaCO₃ derived from coral. In coral, the crystalline structure of CaCO₃ is aragonite rather than the more common calcite found in limestone. The compression strength of aragonite is reported to be greater than calcite. At an optimal composition (about 70% CaCO₃), the resulting initial-failure compression stress (90 MPa) is less than limestone-derived CaCO₃ (145 MPa), so this material was not investigated further.

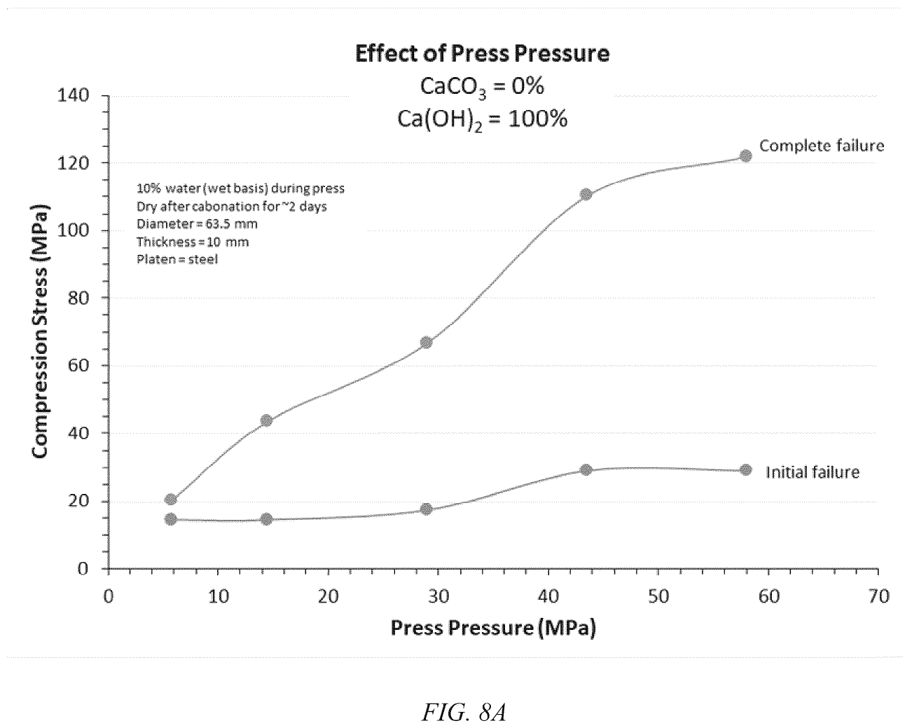

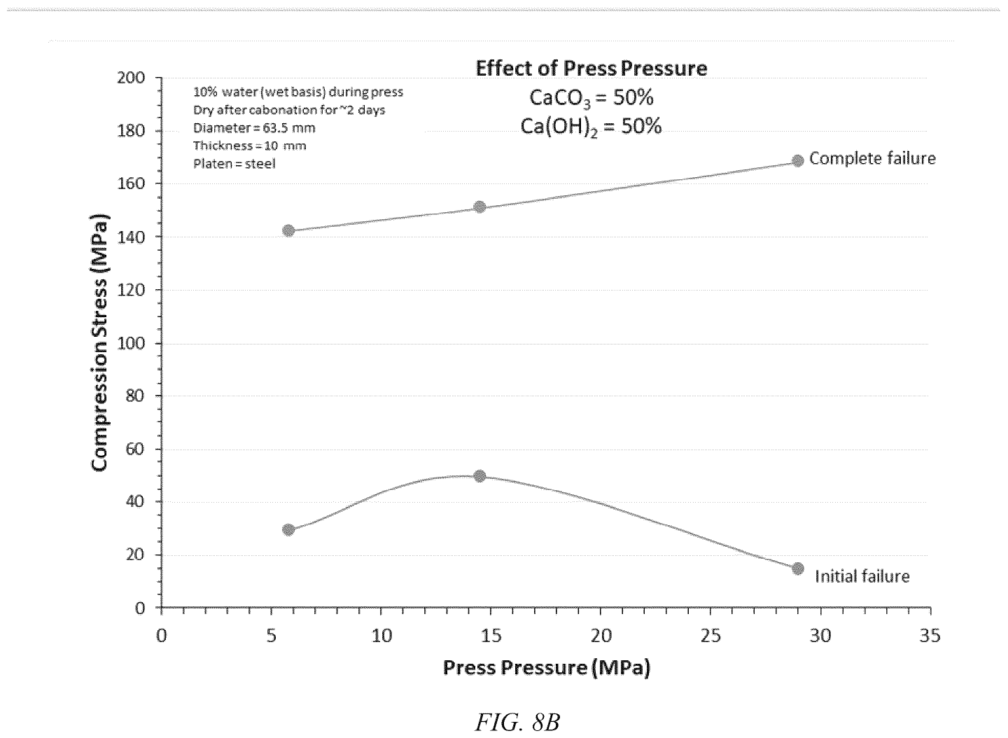

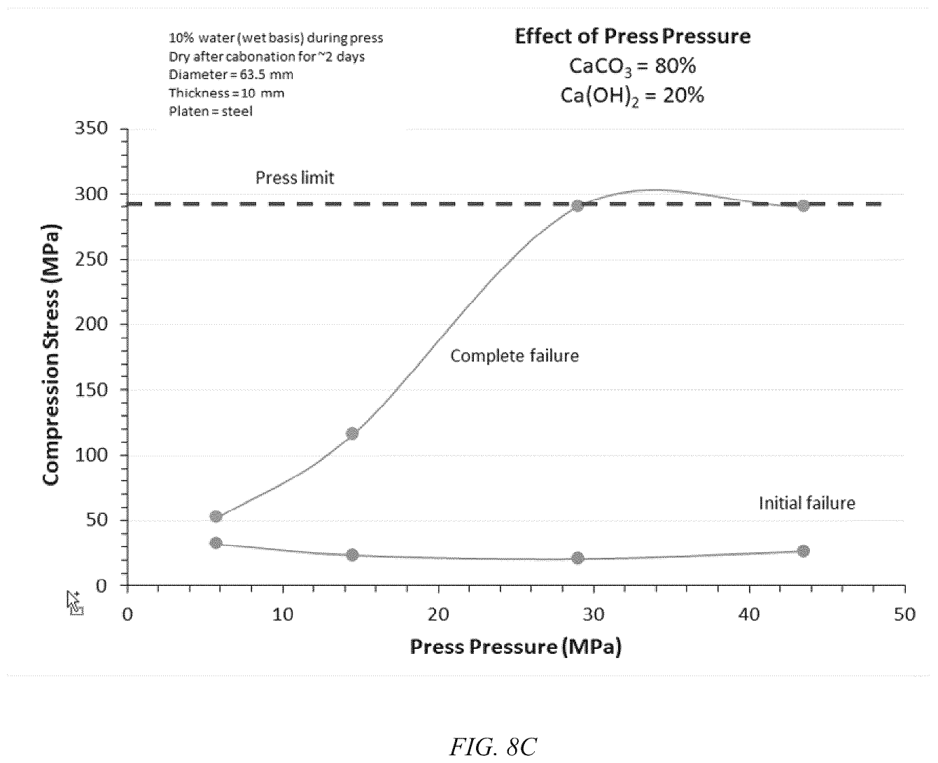

Using a variety of compositions, FIGS. 8A, 8B, and 8C show the impact of press pressure in the mold. The general trend is that the material is stronger as the applied pressure increases. If the pressure is too high, when removed from the mold, the “greenware” material forms a “croissant,” meaning it separates into layers as the pressure is relieved. For the remaining experiments, the press pressure was standardized as follows:

| Diameter (mm) | Press pressure (MPa) |
|---|---|
| 63.5 | 43.5 |
| 38.1 | 60.5 |

The above press pressures are for guidance only. In particular configurations, the optimal press pressure must be determined for the given material composition, geometry, and time under press.

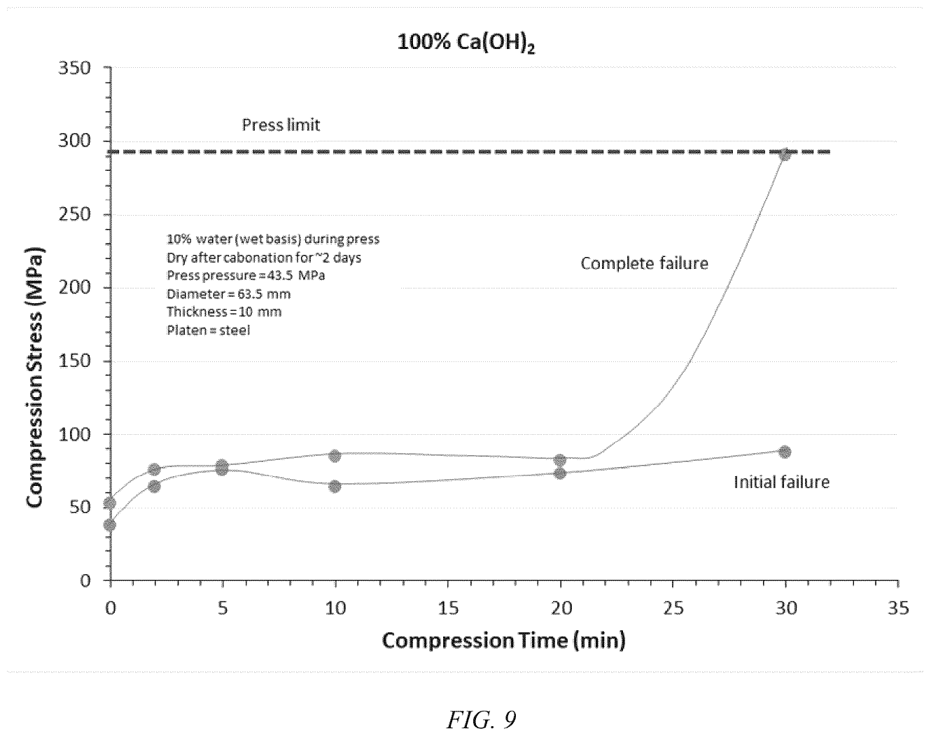

FIG. 9 shows the impact of time under pressure while pressing the discs. The data show that strength increases with longer time, and then reaches a plateau. While pressing the discs, initially the pressure drops as the material rearranges itself under the effect of pressure. This observation is more pronounced with thicker materials. Eventually, the pressure no longer changes and the material comes to “equilibrium” under the effect of pressure. For the remainder of the figures—unless otherwise noted—the indicated press pressure is the “equilibrium” pressure, meaning that it sustained that pressure for a few minutes without changing.

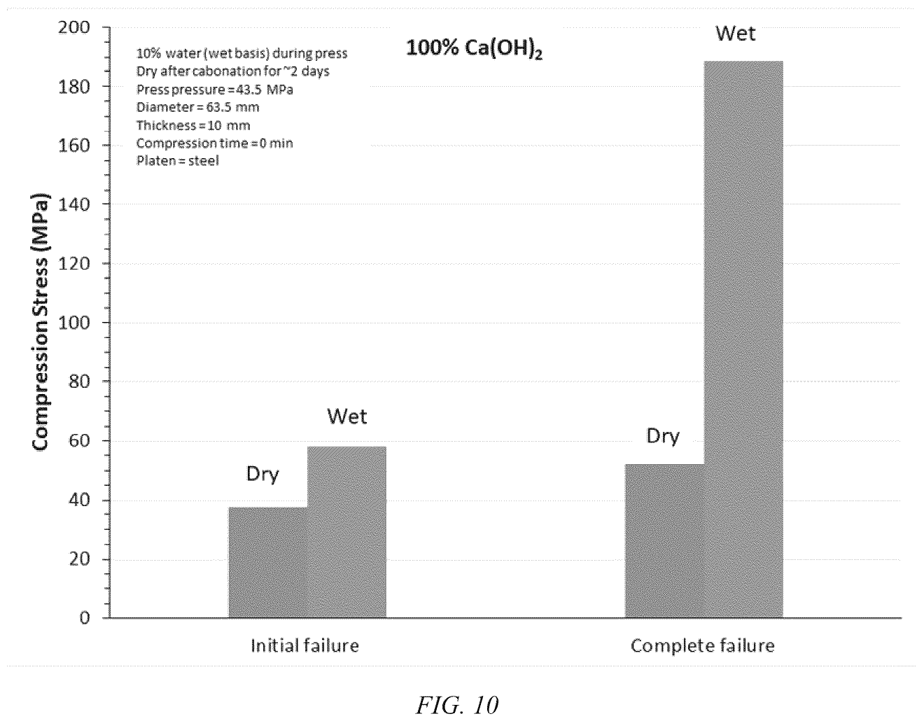

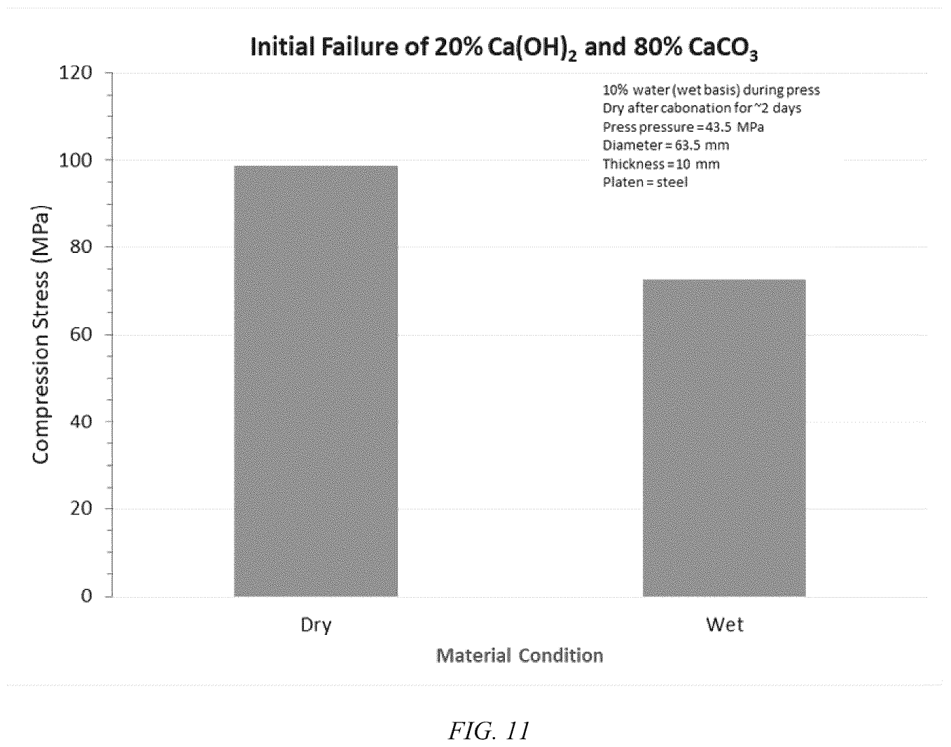

FIGS. 10 and 11 show the impact of soaking CaCO₃ for 2 days in water. In FIG. 10, the CaCO₃ was made by carbonating 100% Ca(OH)₂. When the material is saturated with water, the initial-failure compression stress increases by 54%. In FIG. 11, the CaCO₃ was made by carbonating 20% Ca(OH)₂ and 80% CaCO3. When the material is saturated with water, the initial-failure compression stress decreases by 26%. The following is a potential explanation of these contradictory results: In FIG. 10, the carbonation process required a large amount of reaction with CO₂, which introduced internal stresses into the material. Soaking in water “lubricates” the material, which allows these internal stresses to relax and thereby increase strength. In FIG. 11, the carbonation process required a small amount of reaction with CO₂, so there is not as much internal stresses in the material. In this case, when water “lubricates” the material, it interferes with bonds that provide strength.

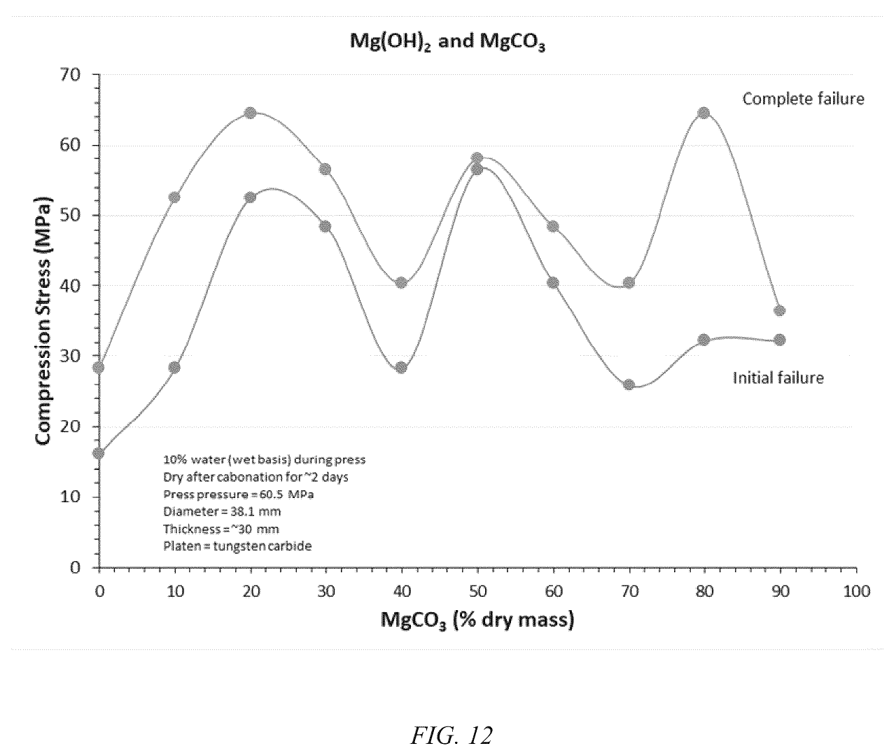

FIG. 12 shows the impact of blending various ratios of Mg(OH)₂ and MgCO₃ prior to carbonation. The data show two peaks in initial-failure compression stress: 20 and 50% MgCO₃.

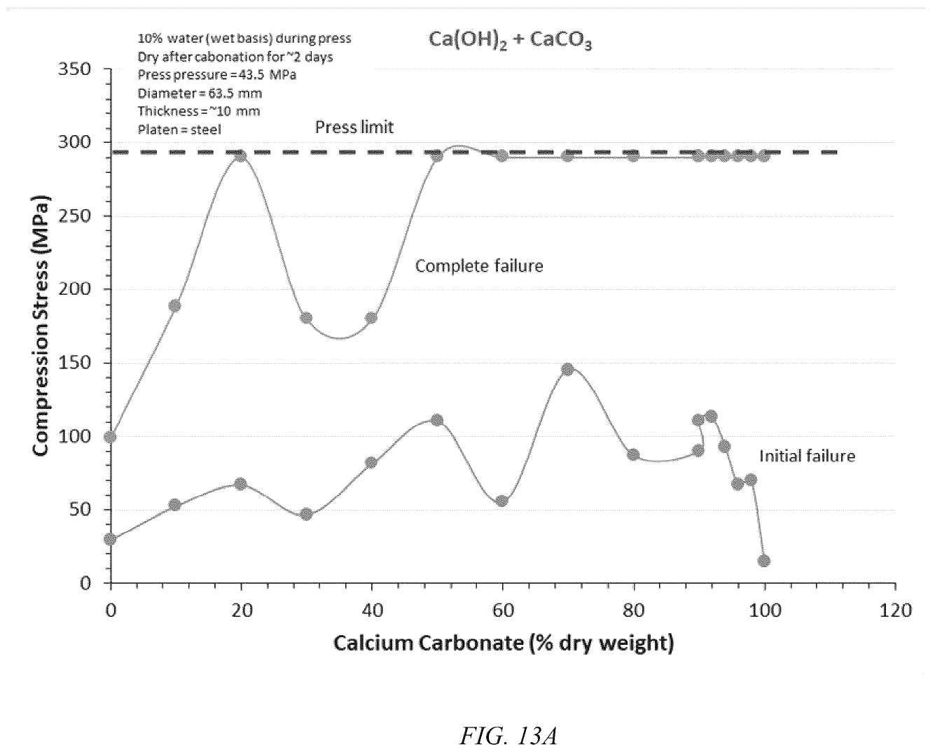

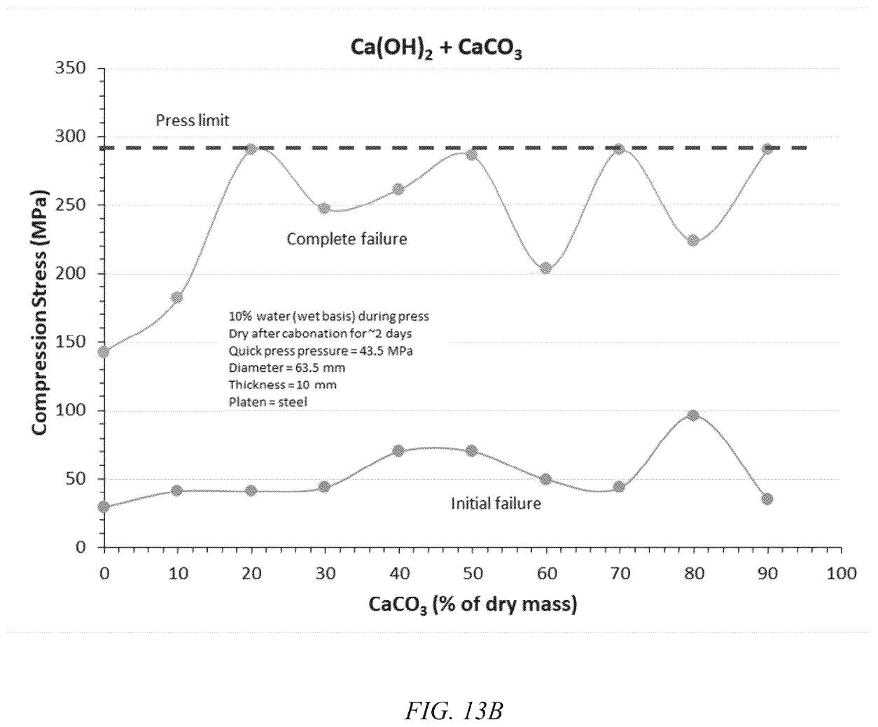

FIG. 13A shows the impact of blending various ratios of Ca(OH)₂ and CaCO₃ prior to carbonation. The CaCO₃ serves as “brick” and Ca(OH)₂ serves as “mortar.” CaCO₃ is less expensive than Ca(OH)₂, so it is advantageous to incorporate as much CaCO₃ as possible. Based on maximum initial-failure compression stress, the optimal ratio is about 70% CaCO₃ and 30% Ca(OH)₂. In all cases, after carbonation, the final material is 100% CaCO₃, so the final compositions do not differ; rather, the differences relate to the internal structure of the material. At high concentrations of CaCO₃, there is insufficient “mortar” to bind the structure. At low concentrations of CaCO₃, there is excess mortar and in principle, the material should be stronger; however, that is not the case. A possible explanation follows: During the carbonation process, Ca(OH)₂ reacts with CO₂ and eliminates H₂O. The diameter of a CO₂ molecule is 0.334 nm whereas the diameter of a H₂O molecule is 0.275 nm. When the larger CO₂ replaces the smaller H₂O, it creates internal strain that negatively affects strength. Potentially, this internal strain could be reduced by raising the temperature and thereby annealing the material; however, this adds an extra step with associated cost and complexity.

The above “brick” and “mortar” discussion can also correspond to the example materials in Table 8. Candidate “mortar” materials form insoluble carbonates that can bind the material together when the hydroxide is carbonated. Candidate “brick” materials are insoluble solids, preferably those that are inexpensive and have other desirable properties, such as strength, abrasion resistance, etc. While a listing is provided for “mortars” and “brick,” other non-listed materials may also benefit from this disclosure's teachings.

FIG. 13B shows a similar study as in FIG. 13A, but the press pressure was not sustained to reach “equilibrium.” The compression strength is less, so it is important to provide sufficient time for the press pressure to reach equilibrium. In an industrial setting, to achieve a desired compression strength, it might be possible to over-pressure the material for a short duration, and thus avoid the cost of spending sufficient time to reach equilibrium at a lower pressure.

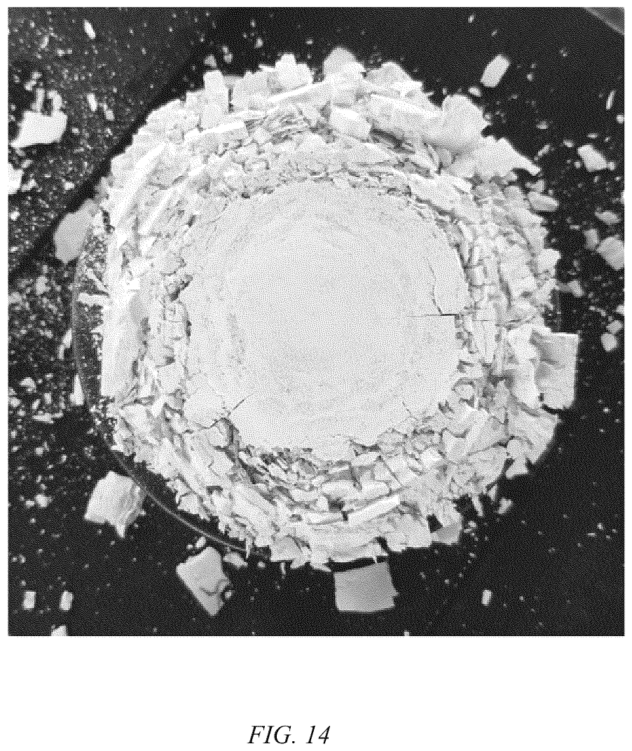

FIG. 14 shows the top view of a disc that failed under compression. As seen, failure occurred from the outer radius inward. The core was intact presumably because it is surrounding material that prevents it from flowing outward in the radial direction and thereby failing.

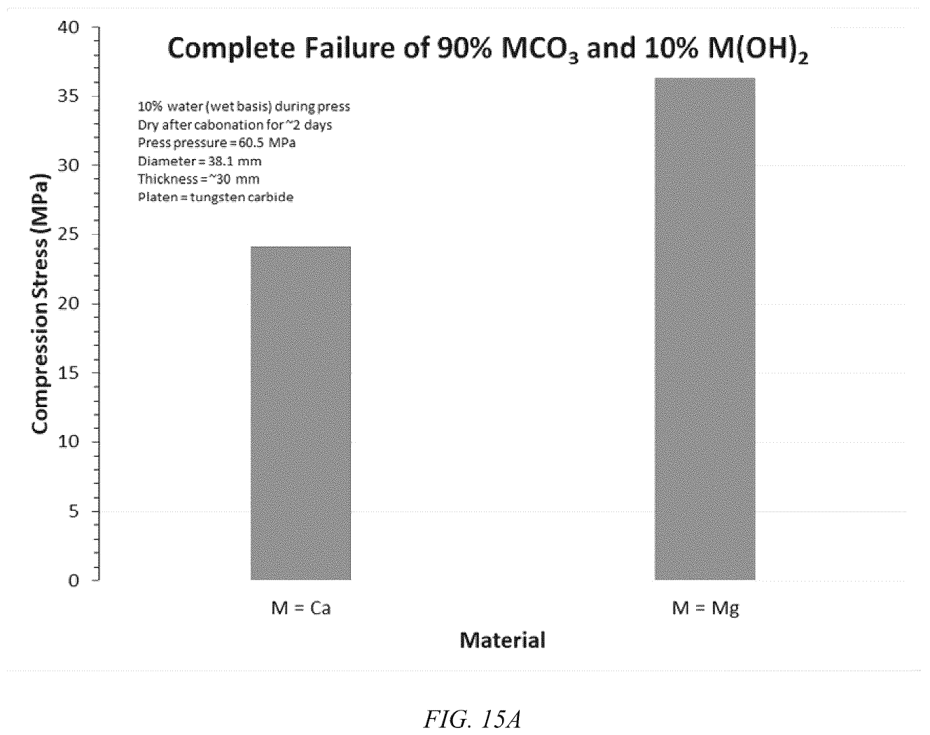

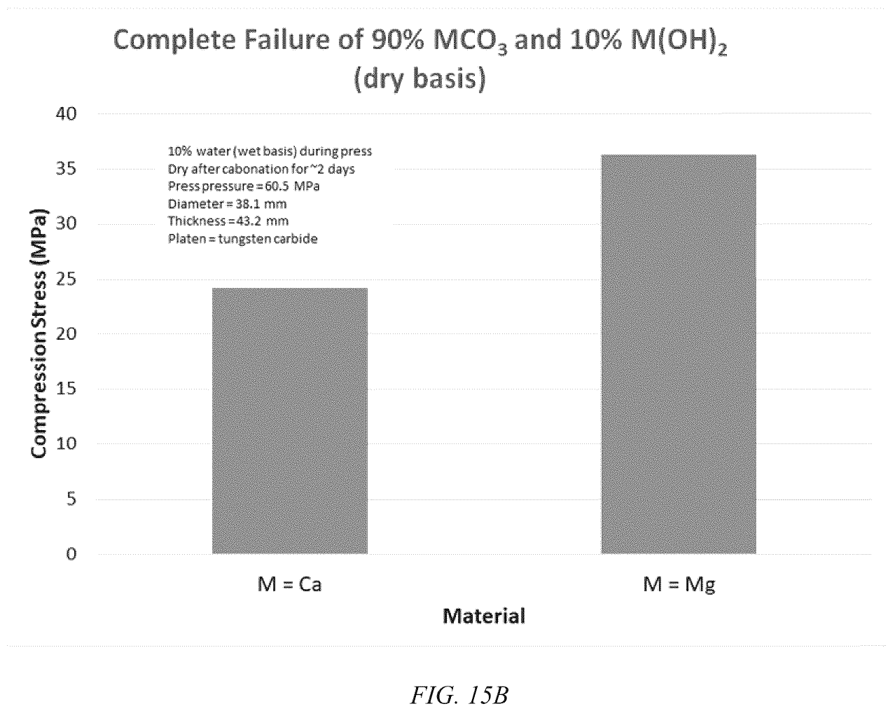

FIGS. 15A and 15B compare the compression strength of two columns, each with identical dimensions. Both figures have the same column diameter, but differ in thickness. Both figures show that in their raw form, MgCO₃ is stronger than CaCO₃. Under these conditions, there was no impact from thickness.

### Glass Fiber Addition

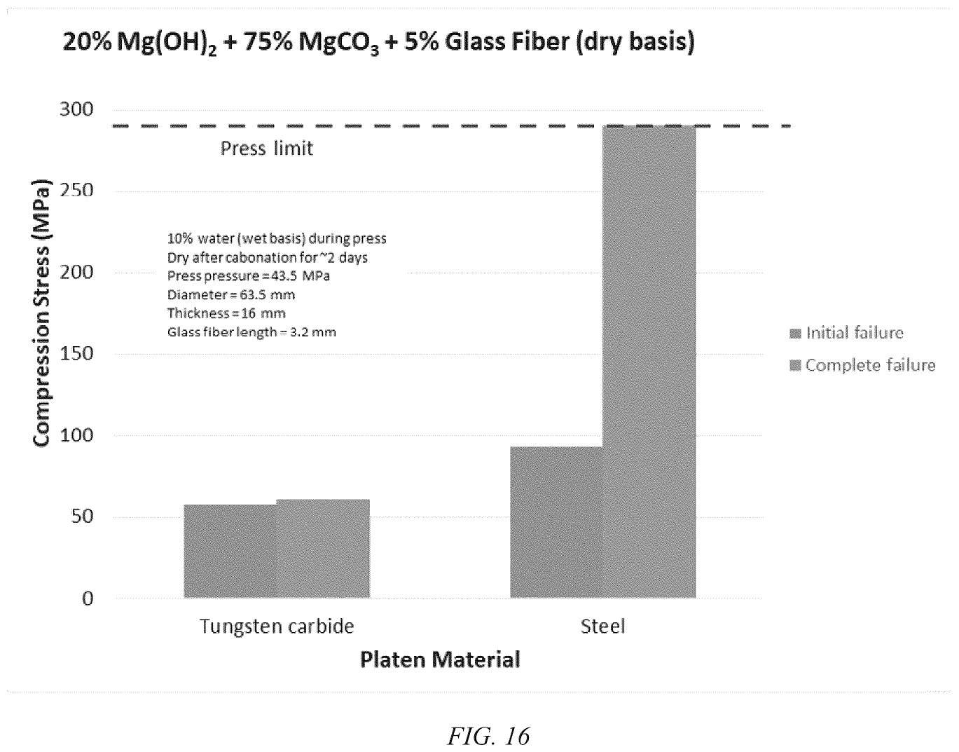

FIG. 16 shows identical materials—each containing 3.2-mm-long glass fibers—tested with both steel and tungsten carbide platens. When tested with the steel platen, the material exhibits greater compression strength. A potential explanation of this unexpected result follows: The material fails from the outer radius inward (FIG. 14). Presumably, the material has a greater coefficient of friction with steel than tungsten carbide. The result is that the steel holds the material together in the radial direction and thereby strengthens it.

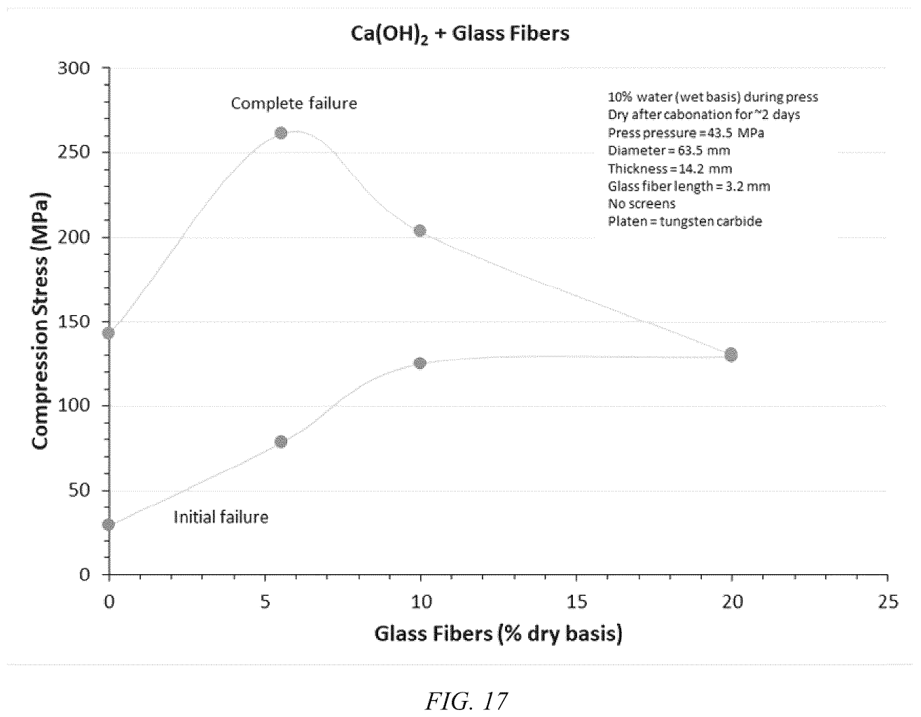

FIG. 17 shows the effect of adding 3.2-mm-long glass fibers to carbonated Ca(OH)₂. The recommended addition is 5 to 10% (dry basis).

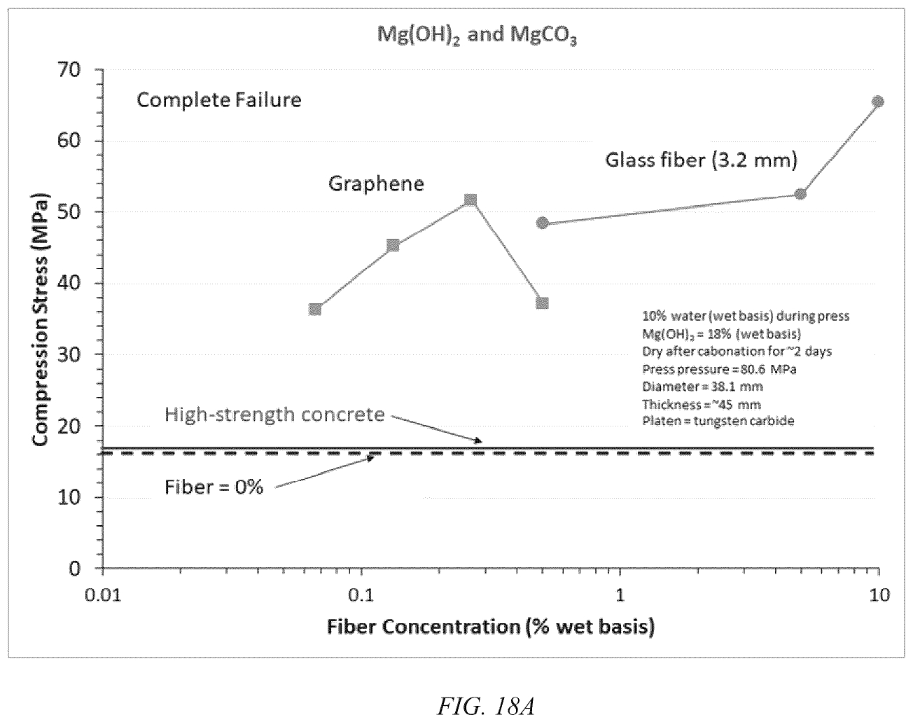

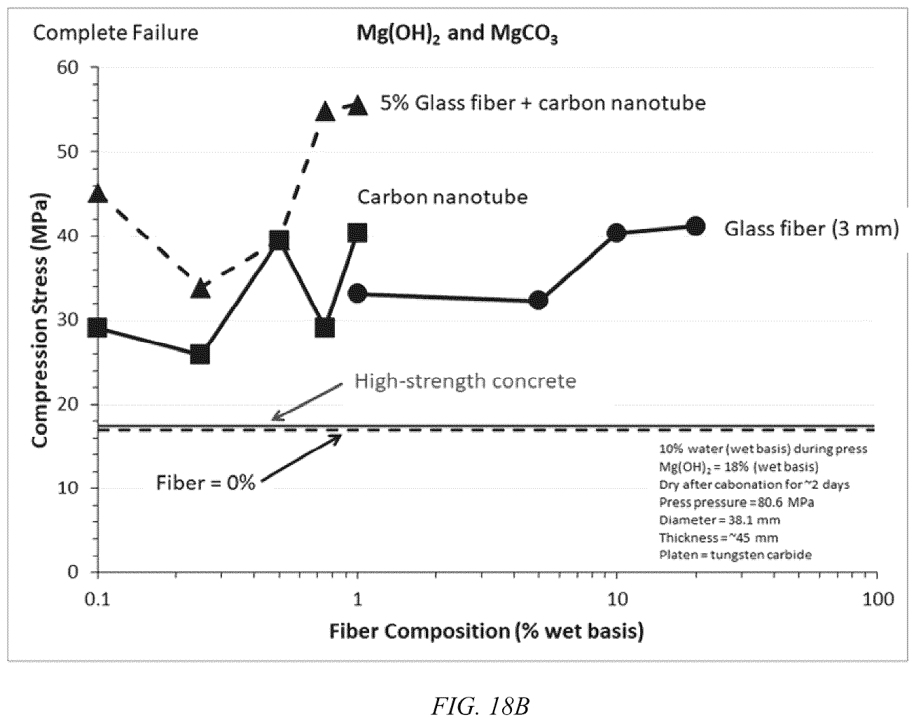

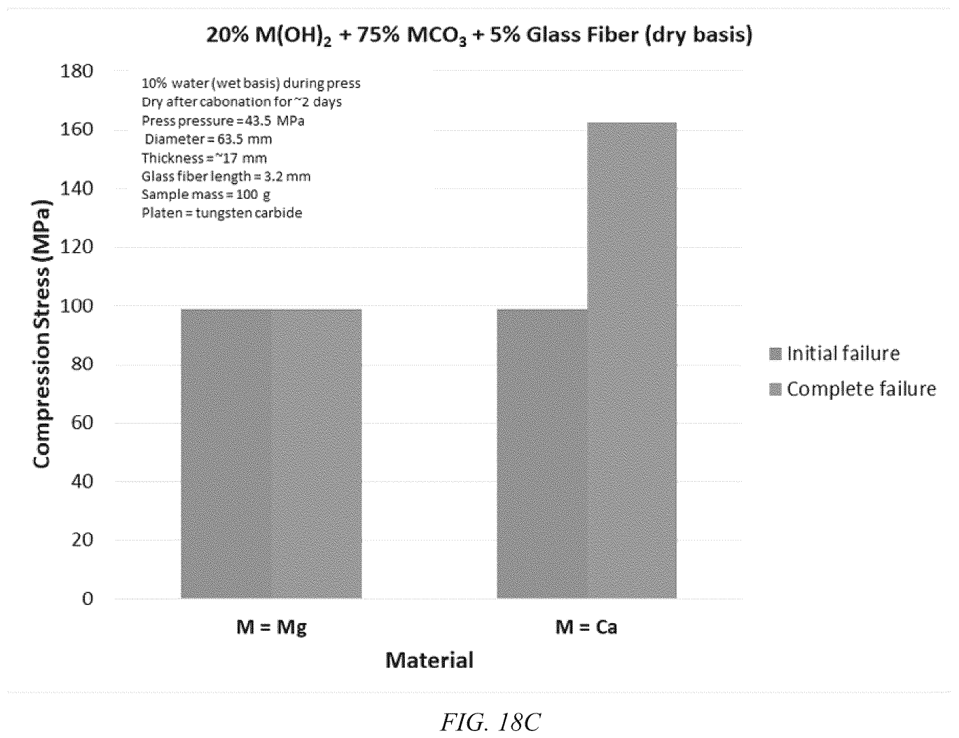

FIG. 18A shows the effect of adding graphene or 3.2-mm-long glass fibers to carbonated Mg(OH)₂. Compared to Sakrete high-strength (4000-psi) concrete, the fibers increase compression strength by 2 to 4 times.

FIG. 18B shows the effect of adding the following to carbonated Mg(OH)₂:
carbon nanotubes
3.2-mm-long glass fibers
mixtures of carbon nanotubes and 3.2-mm-long glass fibers

While carbon nanotubes are shown in this configuration, in other configurations, graphene could replace carbon nanotubes. Similarly, metal, carbon, or plastic fibers could replace glass fibers. The addition of carbon nanotubes or glass fibers increase strength by roughly 2 times; however when combined, the strength increases by roughly 3 times. The synergistic benefits of the mixture can be explained as follows: carbon nanotubes prevent cracks at the microscale whereas the glass fibers prevent cracks at the macroscale.

The results for graphene and carbon nanotubes described in FIGS. 18A and 18B show much greater strength increases (˜100%) compared to the 3 to 21% increase reported in the literature. [24] Potential explanations for the significant improvements reported herein follow:
The literature report used much smaller additions of carbon nanotubes (0.01 to 0.1%) vs. the higher loading reported here (0.1 to 1.0%)
The literature materials contained coarse aggregate, which is typical of conventional concrete, whereas the samples materials herein were uniformly finely divided.
The literate materials where not pressed, whereas the samples herein were pressed at high pressure to ensure intimate contact of the particles.

FIG. 18C shows the impact of glass fibers on the strength of calcium and magnesium carbonates, each with 5% glass fibers. The initial-failure compression stress is identical whereas the complete-failure compression stress is much higher for CaCO₃. MgCO₃ fails instantaneously in a brittle manner. In contrast, CaCO₃ plastically deforms and fails from the outer radius inward. With the addition of glass fibers, CaCO₃ matches the strength of MgCO₃. In contrast, without glass fibers, MgCO₃ is stronger than CaCO₃.

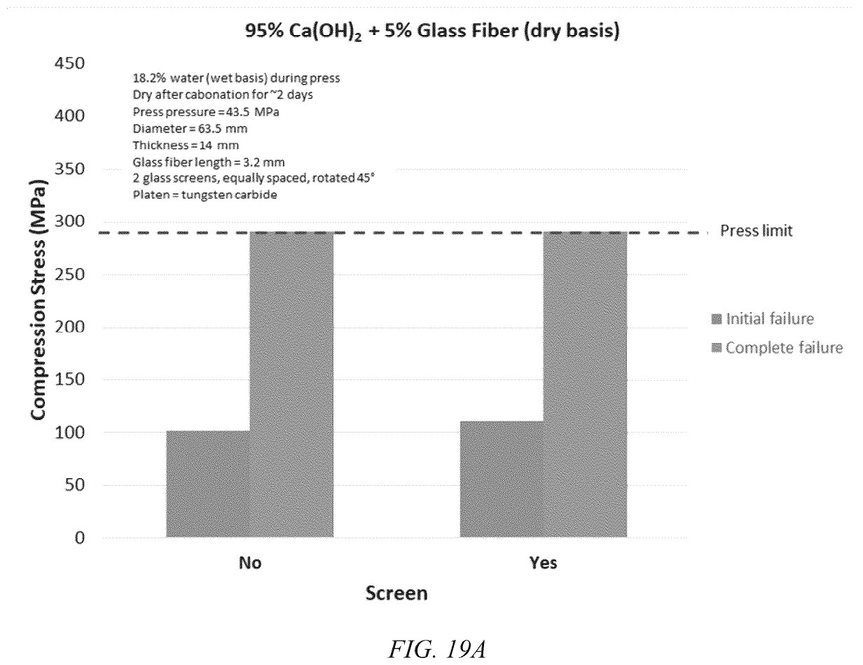

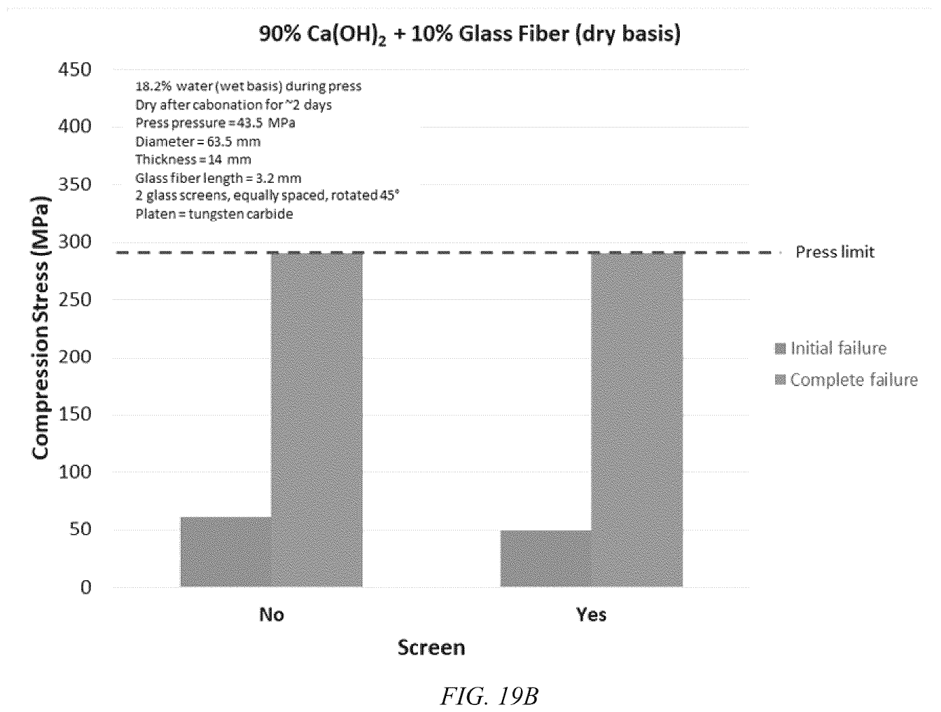

FIGS. 19A and 19B show the impact of incorporating glass window screen into the disc, with 5 and 10% glass fibers, respectively. In principle, the window screen will reinforce the structure, much like rebar added to concreate. In both cases, the compression stress was not improved by adding glass window screen. Potentially, adding window screen will improve tensile and bending strength.

### Effect of Material Thickness

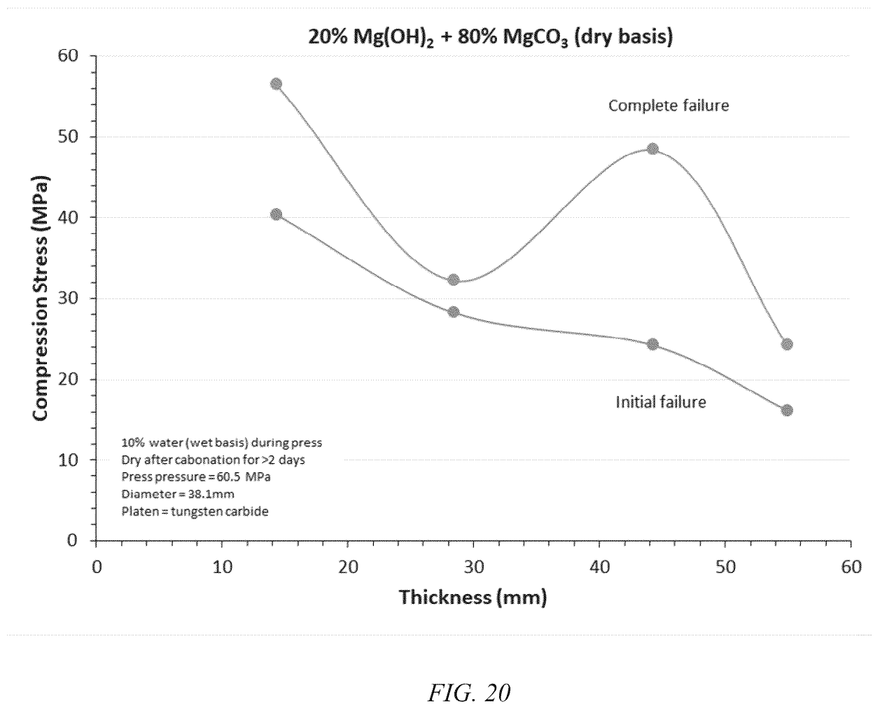

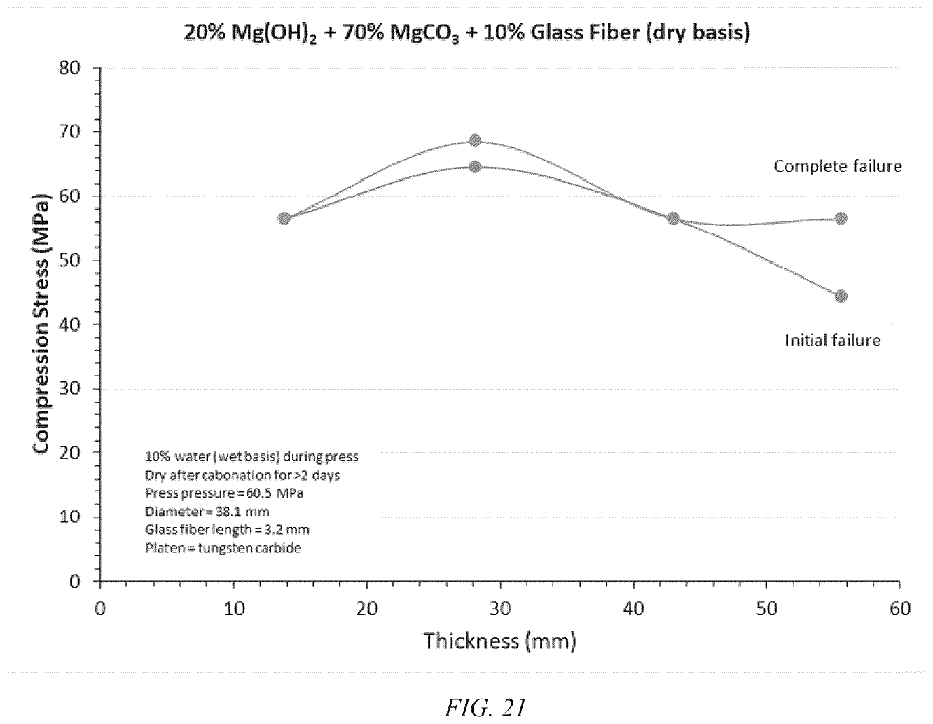

FIGS. 20 and 21 show the impact of MgCO₃ thickness on compression strength. FIG. 20 does not contain glass fibers whereas FIG. 21 does. These data show that adding glass fibers increases compression strength. For example, at a thickness of 55 mm, the initial-failure compression stress increases from 16.1 to 44.4 MPa.

Using a small diameter (38.1 mm), FIG. 21 shows the impact of material thicknesses. As the material becomes thicker, the compression strength reduces. A possible explanation follows: The material fails from the outer radius inward (as shown in FIG. 14). Through its coefficient of friction, the material interacts with the platen. If the material is thin, all the material is in close proximity to the platen and can thereby gains strength from it. In contrast, if the material is thick, the center is distant from the platen and cannot gain strength from it.

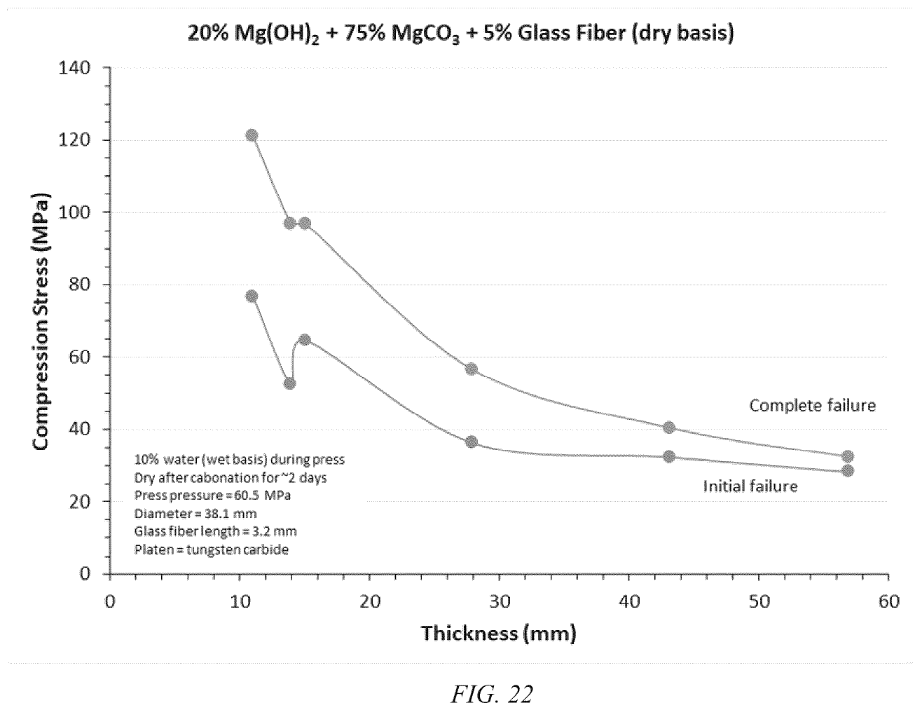

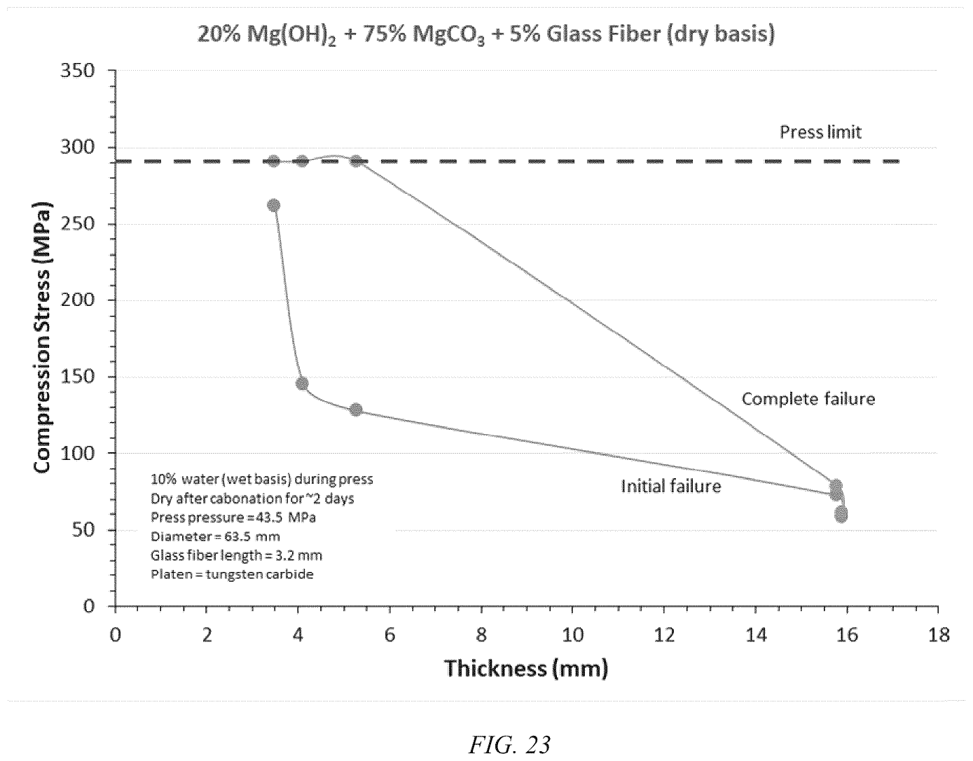

Compared to FIG. 22, FIG. 23 is similar except that a larger diameter (63.5 mm) is employed. The same phenomenon is observed: thinner materials are stronger.

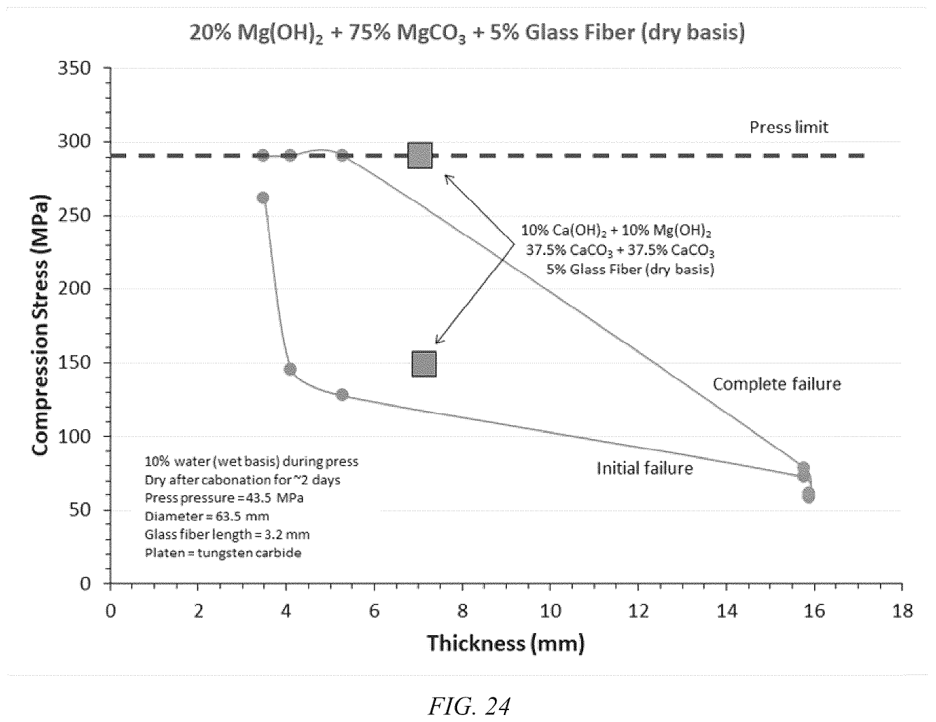

FIG. 24 shows that a 50:50 mixture of calcium and magnesium carbonate is slightly stronger than magnesium carbonate alone.

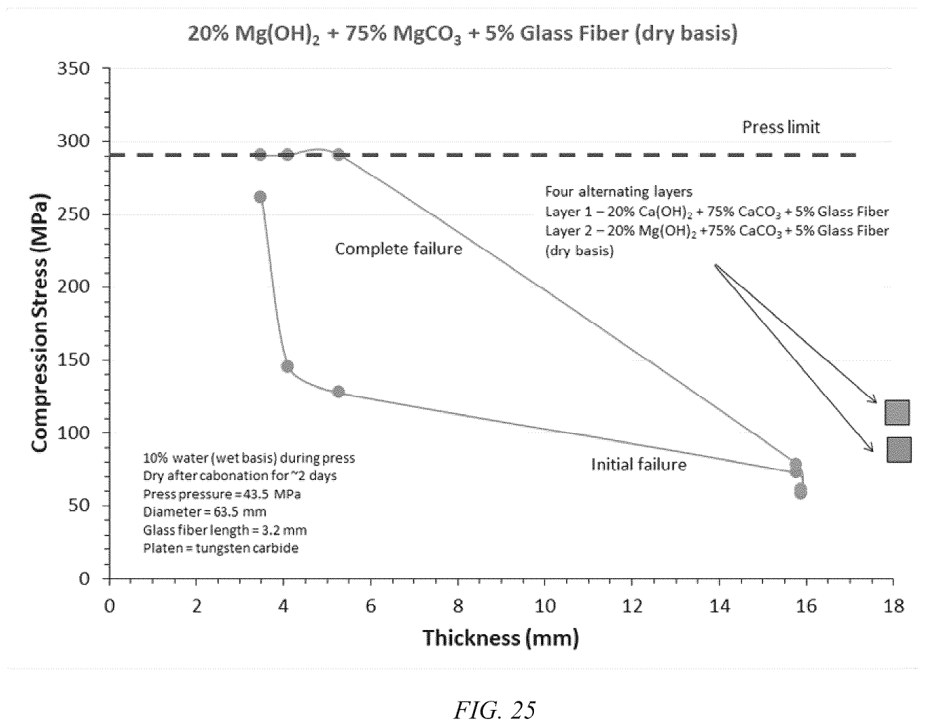

FIG. 25 shows that layering calcium and magnesium carbonate is slightly stronger than magnesium carbonate alone. The layers did not adhere well and exhibited the “croissant” effect.

### Columns

The previous testing was performed with bare samples that were not contained or wrapped. Furthermore, in many cases, the samples were thin relative to the diameter.

In this section, columns were prepared that were wrapped with fiber composites or steel jackets. In all cases, the column height was about 2 times the column diameter. Multiple columns were prepared according to the description in Table 9, and are described in greater detail below:

### Columns A to C—MgCO₃ Core, Fiberglass Jacket

Ordinary automotive plain-weave bi-directional fiberglass was employed. The resin, Evercoat Fiberglass Resin Finish Coat, was included in the fiberglass repair kit (EVR 100917) from Tasco, Bryan, TX.

### Columns D to F—MgCO₃ Core, Pressurized Steel Jacket

The 63.5-mm-diameter MgCO₃ discs were stacked with thin steel discs between each MgCO₃ disc. The MgCO₃/steel discs were glued together with Evercoat Fiberglass Resin Finish Coat. To waterproof the MgCO₃ column, the exterior surface was coated with Evercoat Fiberglass Resin Finish Coat. The column was inserted into a 2.5-in Schedule-10 steel seamed pipe equipped with female pipe-thread nipples, one at each end of the pipe on opposite sides of the circumference. The thin annular gap between the 63.5-mm-diameter discs and the 66.9-mm-inside-diameter pipe was filled with cement isolated from Shepler's grout. The cement was isolated from the Shepler's grout using a fine-mesh screen that ensured sand and grit was removed. The cement was mixed with water to make a slurry of 20% water and 80% cement. It was a thick thixotropic paste that would flow when dripped from a spoon. Using a batch piston pump (no valves), the paste was pumped into the lower nipple through 12.7-mm-diameter stainless steel tubing. The paste entered the lower nipple and exited the upper nipple. Once air had been cleared from the flowing paste, the outlet stainless steel tubing was crimped shut while 36.4-MPa pressure was applied for about 1 minute. Then, the inlet stainless steel tube was crimped shut, which allowed the grout to cure.

### Column G—Grout Core, Pressurized Steel Jacket

The entire column was filled with Shepler's grout directly taken from the bag without filtering sand and grit. Once the column was filled with Shepler's grout, it was pressurized with cement isolated from Shepler's grout according to the procedure described above.

### Columns H to J—Grout Core, Non-Pressurized Steel Jacket

The steel jacket was a section of 2.5-in Schedule-10 steel seamed pipe. The pipe was vertical with waxed-paper at the base. Grout was poured until it filled the pipe. The grout was thick, so while filling, it was hand-packed into the pipe using a rod, which ensured there were no voids.

For Column J, a straw was inserted down the middle of the pipe and the grout was poured around it. After curing, the straw was removed, which left a hole down the middle of the pipe. Then, after curing for about one week, the column was inserted into a pressurized vessel with 1.5-MPa CO₂ for one week.

In all cases, the columns were allowed to cure for a few months before testing.

### Columns K to M—Concrete Core, Non-Pressurized Steel Jacket

The procedure was identical to that described for Columns H to J.

### Columns N to Q—Concrete Core, Non-Pressurized Steel Jacket

The procedure was identical to that described for Columns H to J.

For Column Q, seven evenly space steel discs were inserted during the filling process.

### Columns R to W—MgCO₃ Core, Carbon Fiber Jacket

The 63.5-mm-diameter MgCO₃ discs were stacked with thin steel discs between each MgCO₃ disc. The MgCO₃/steel discs were glued together with Evercoat Fiberglass Resin Finish Coat. To waterproof the MgCO₃ column, the exterior surface was coated with Evercoat Fiberglass Resin Finish Coat.

Each column was wrapped with 2.25 layers of plain-weave bi-directional carbon fiber fabric (5 ft×12 in Carbon Fiber Fabric—Plain Weave, 3K, 220 GSM, Innovative Composite Technologies, purchased from Amazon). After wrapping the fabric, it was sealed using 820 Resin (Epoxy) available from Soller Composites. After the bi-direction carbon fiber fabric cured, it was wrapped circumferentially with layers of carbon fiber tow (Fibre Glast, 24K tow, Item Number B242393-C). The columns with 2 and 5 layers were wrapped once and sealed using 820 Resin. The columns with 14 layers were wrapped multiple times (5+4+1+1+2+1). After each wrap, the 820 Resin was allowed to cure before another wrap was added.

### Procedure for Column Testing

In all cases, the tungsten carbide platen that loaded the column was 63.5 mm in diameter. It was centered on the column so that only the core was loaded axially.

In the cases of the fiberglass and carbon fiber jackets, the wrap extended slightly longer than the core, so the platen was easily centered in the “pocket” created by the extended jacket. In the cases of steel jackets, the jacket and core were the same length. To ensure that the platen was centered on the core, a removable centering guide was added to the jacket through which the platen was placed.

In all cases, the jacket was not loaded axially; only the core was loaded axially. The function of the jackets is to counteract the radial load from the radially expanding core. Ideally, the jacket only resists hoop stress.

### Results for Column Testing

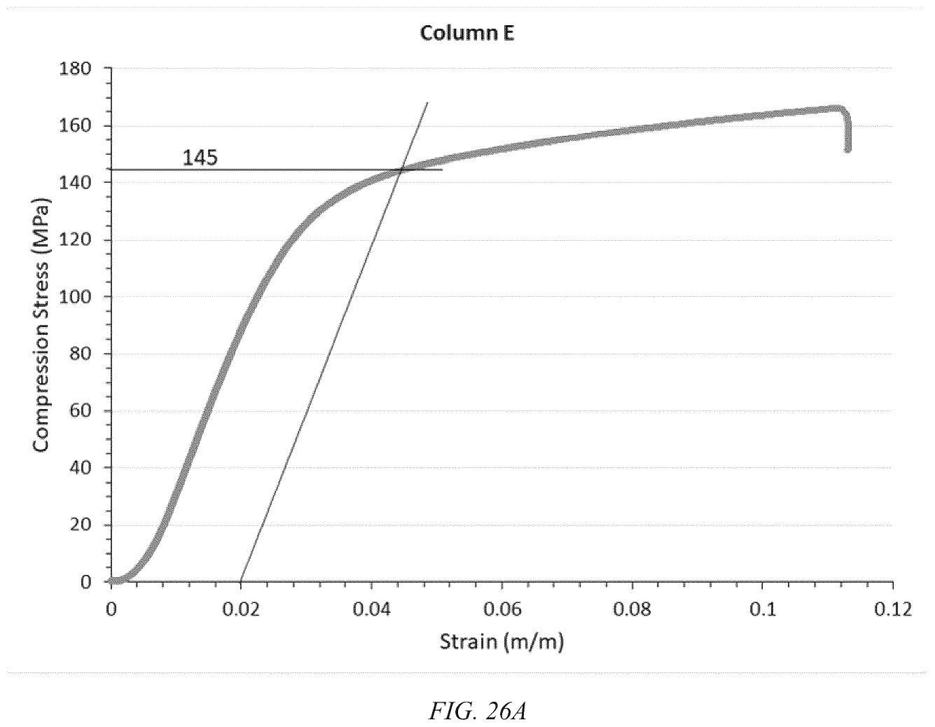

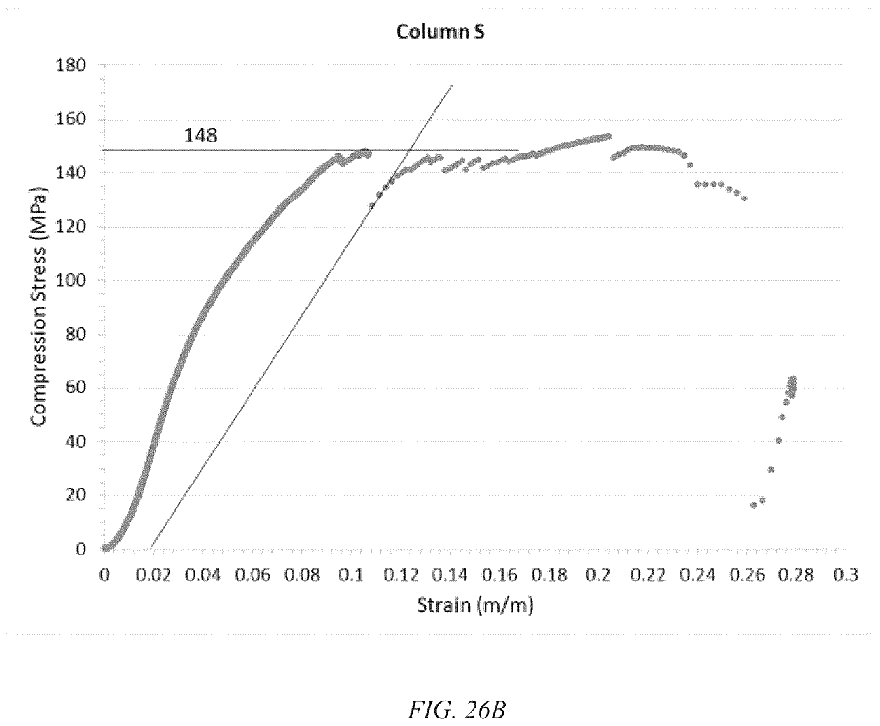

FIGS. 26A and 26B show typical stress/strain curves for ductile and brittle columns, respectively. The stress that occurs with a 2% strain offset is used to characterize the strength of each column (Table 10).

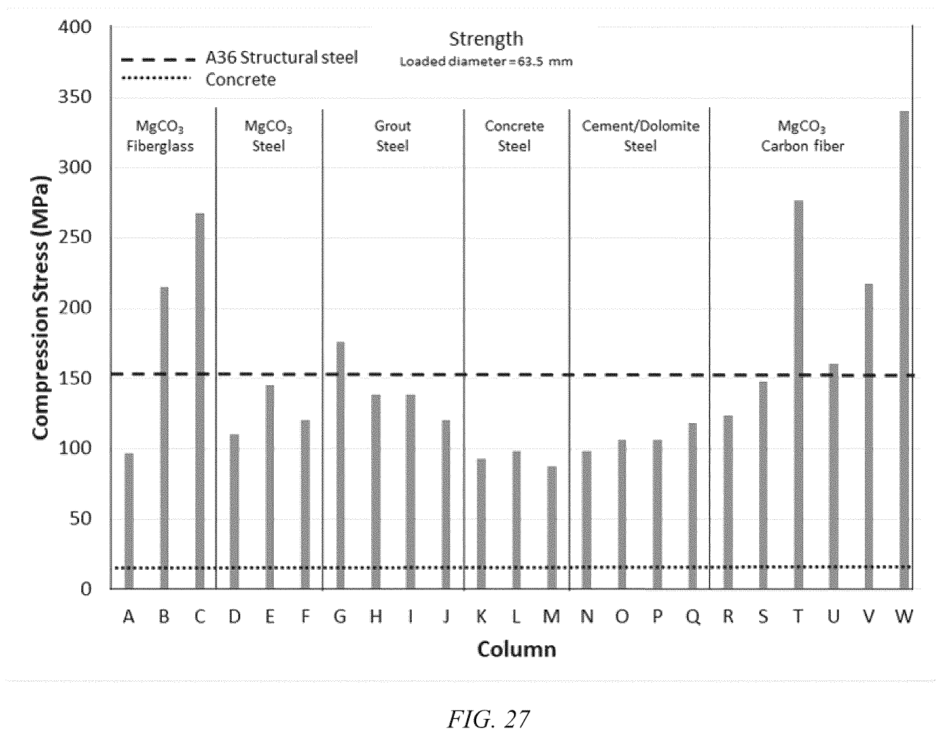

FIG. 27 compares the compression strength of each column to concrete and steel. In all cases, the strength is significantly greater than Sakrete high-strength (4000-psi) concrete. In many cases where the columns were wrapped with glass fibers (Columns B, C) and carbon fibers (Columns T-W), the strength exceeded steel. In the case of pressurized grout in a steel jacket (Column G), the strength exceeded steel. Comparing Column A to Columns B and C, the benefits of adding the steel disc crack arresters is very evident. When Column A failed, a large crack propagated through all the discs as though it were a single material. In contrast, when Columns B and C failed, the damage was localized to a few discs.

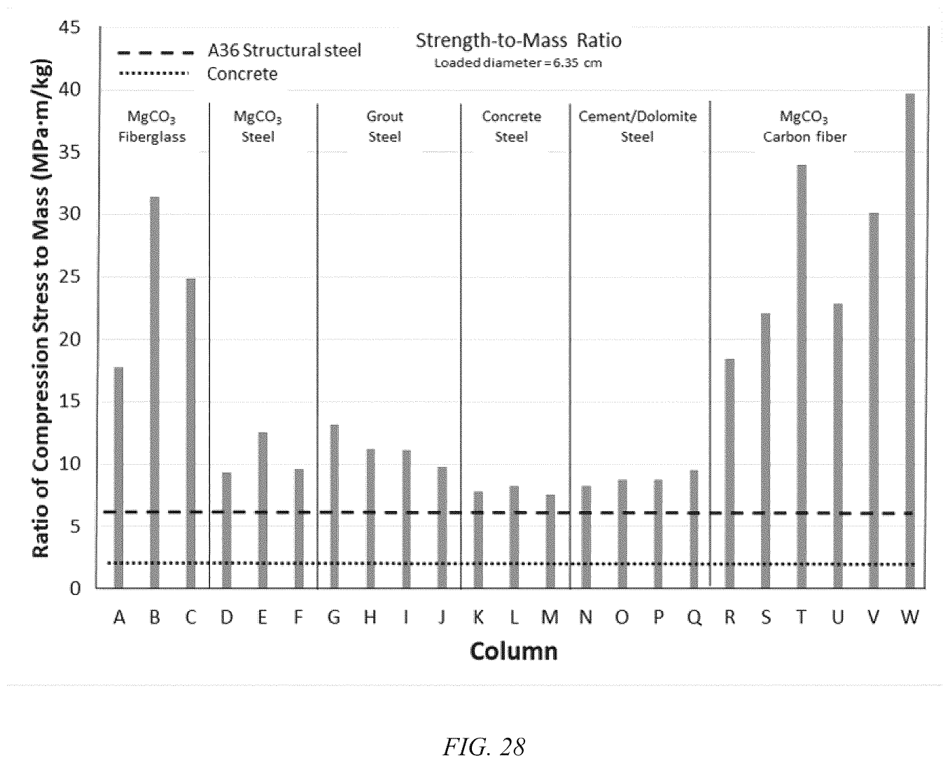

FIG. 28 shows the strength-to-mass ratio for each column, which in all cases exceeded both concrete and steel, often by large margins.

### Pozzolanic Materials

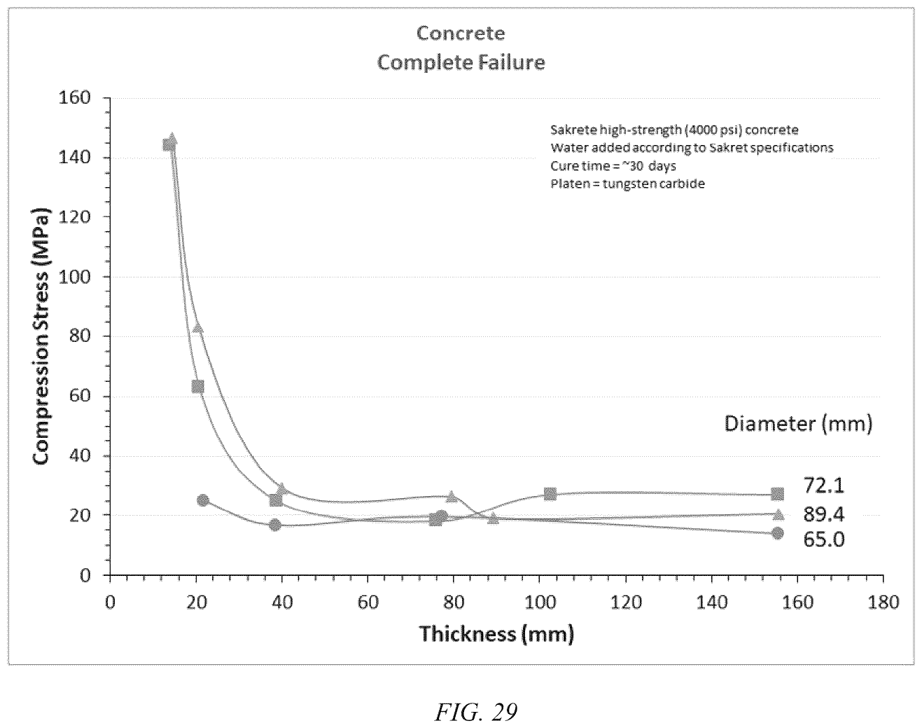

FIG. 29 shows complete-failure compression stress for Sakrete high-strength (4000-psi) concrete columns cast in a variety of diameters and thicknesses. In all cases, small thicknesses were much stronger; the effect was greater at larger diameters. In all cases, above a thickness of 40 mm, the complete-failure compression stress was similar.

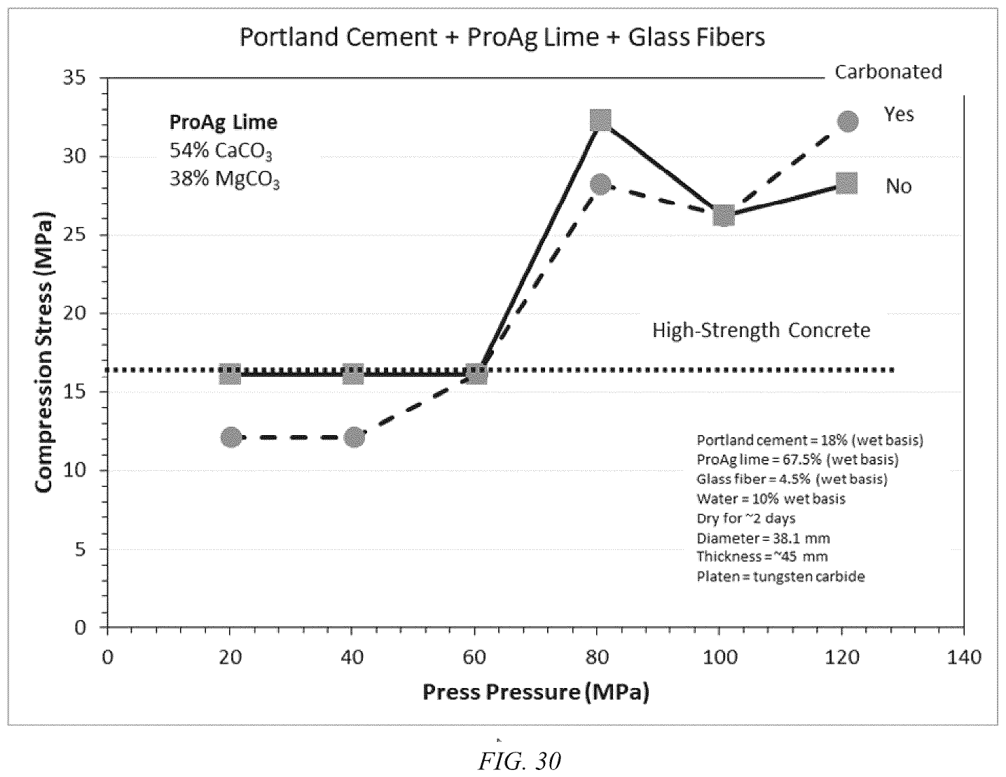

FIG. 30 shows the complete-failure compression stress for Portland cement and ProAg Lime (54% CaCO₃ and 38% MgCO₃) reinforced with glass fibers as a function of press pressure. The trend shows that compressing the material increases strength. The maximum strength is about twice the strength of Sakrete high-strength (4000 psi) concrete with similar geometry. The results with and without carbonation of the final cured product are similar, so there is no apparent benefit to carbonation.

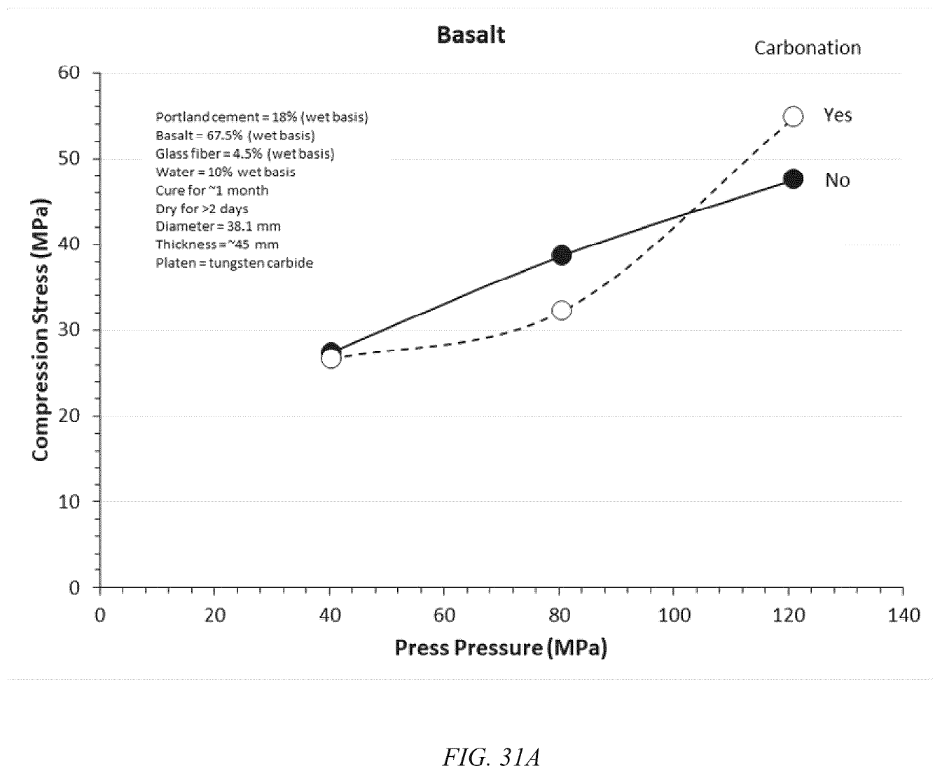

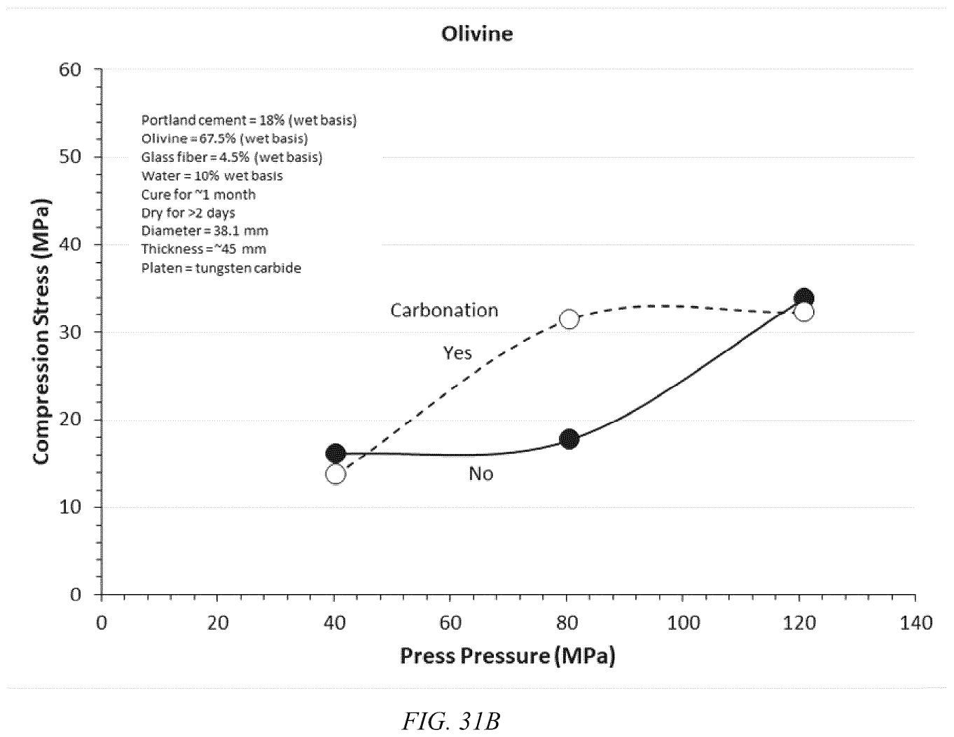

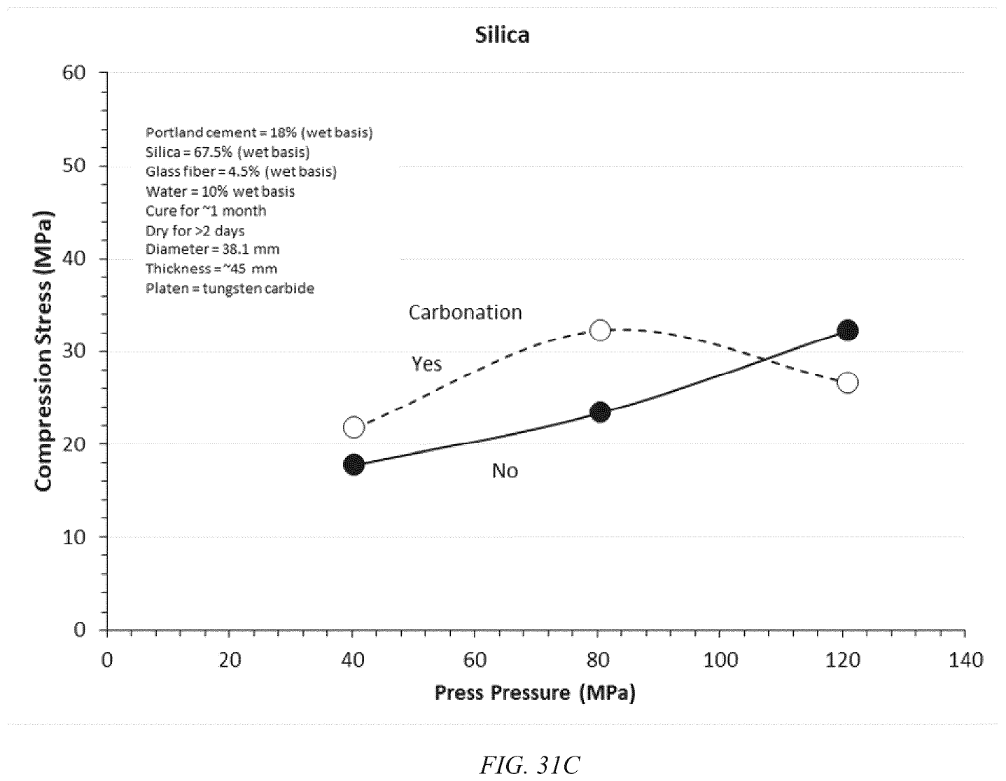

Table 11 shows typical compositions of basalt and olivine. FIGS. 31A, 31B, and 31C3 show the compression strength for pozzolanic materials containing fine aggregates of basalt, olivine, and silica, respectively. Basalt is significantly stronger than olivine or silica. Universally, the data show that increasing the press pressure increases the strength. Universally, carbonation does not have a discernable effect on strength.

Table 12 shows the compositions of the RPC samples tested.

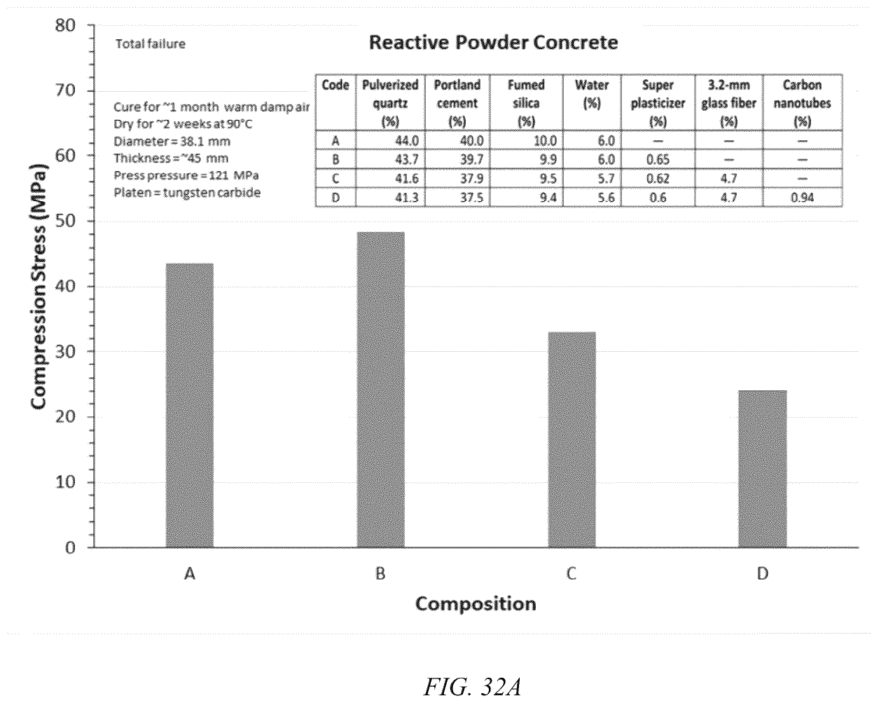

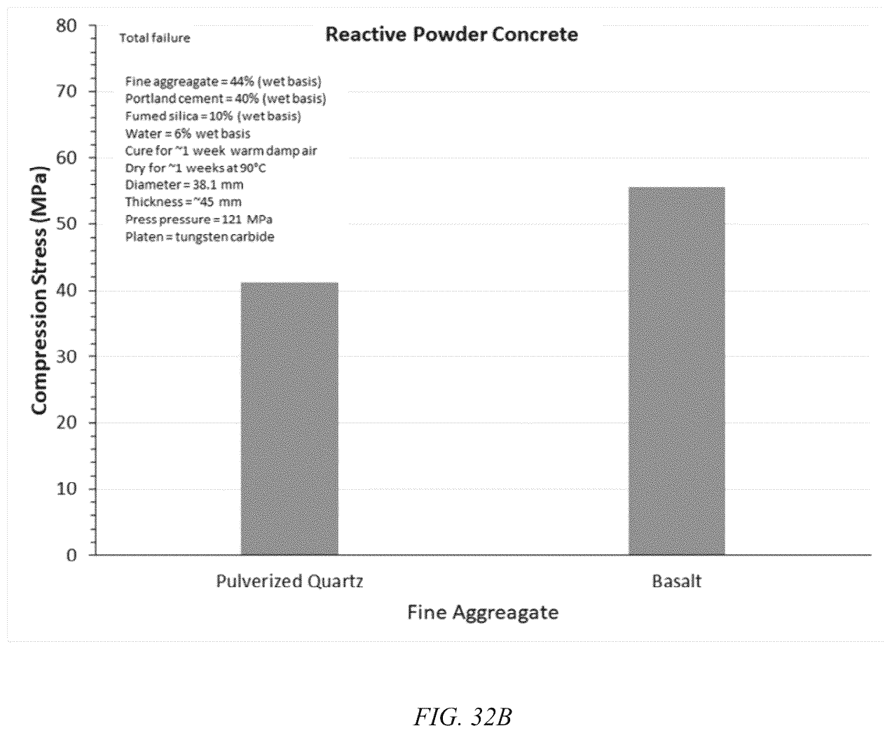

FIG. 32A shows that adding superplasticizer increases strength slightly; however, adding glass fibers and carbon nanotubes reduces strength significantly. Under the conditions tested, RPC was not as strong as the strongest material described in FIG. 31A, which contained basalt as the fine aggregate.

FIG. 32B compares pulverized quartz to basalt in the RPC formulation. Consistent with the data in FIGS. 31A and 31C, basalt is a stronger fine aggregate than quartz/silica. The RPC formulation is not stronger than the strongest material described in FIG. 31A. Considering the high expense of RPC, this observation has significant economic impact.

### Additives

Various additives can be included in the mixture to accomplish particular goals.

### Fibers

To increase strength, fibers can be added to pozzolanic concrete. Similarly, fibers can be added to synthetic stone to increase strength. The previously presented data (FIGS. 17, 18, and 19) show that adding glass fibers increased strength substantially. In pozzolanic concrete, the presence of Ca(OH)₂ causes the pH to be alkaline (12 to 13). Glass is stable towards acid, but does not resist alkali above pH 9.0 [4]. As a result, glass fibers used in pozzolanic concrete must resist alkali. Typically, glass fibers for pozzolanic concrete contain >16% zirconia, which is expensive.

Table 13 shows the pK_{α} of relevant materials. In a saturated solution of salt, the solution pH is approximately the pK_{α}. Because MgCO₃ and CaCO₃ have a significantly lower pK_{α}, they will be less aggressive towards glass, thus allowing the use of less expensive grades of glass fibers. Furthermore, addition of less alkaline minerals to the mix will lower the pH and thereby protect less-expensive grades of glass fibers from degrading.

Tables 14 and 15 show the solubility of some common salts. In the presence of water (e.g., rain), those with high solubility are easily washed out of a cementitious material. If a cementitious material is encapsulated in a steel of composite fiber jacket, this is less of an issue.

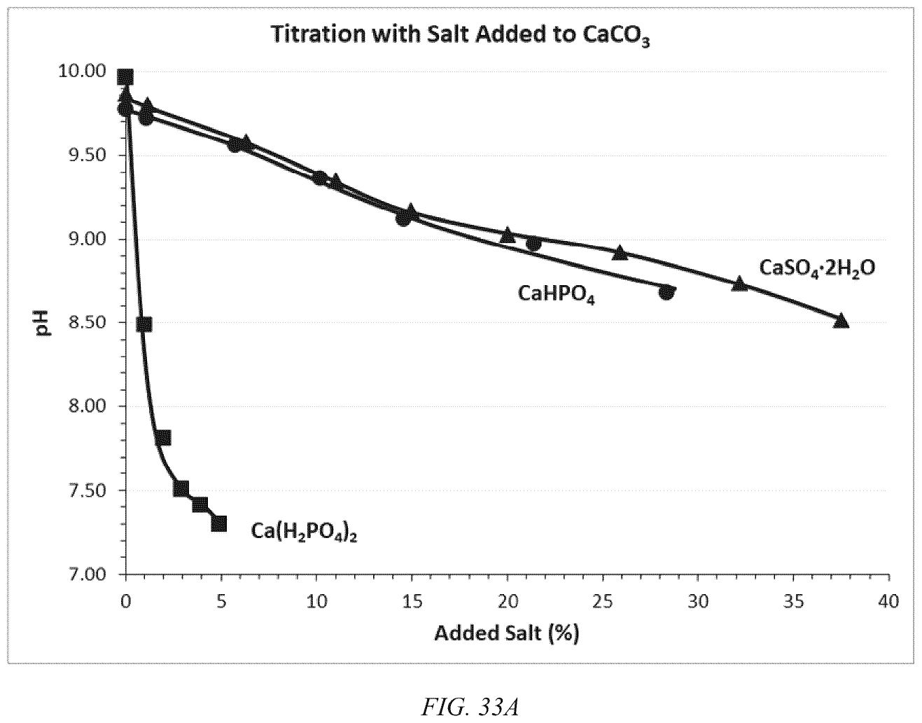

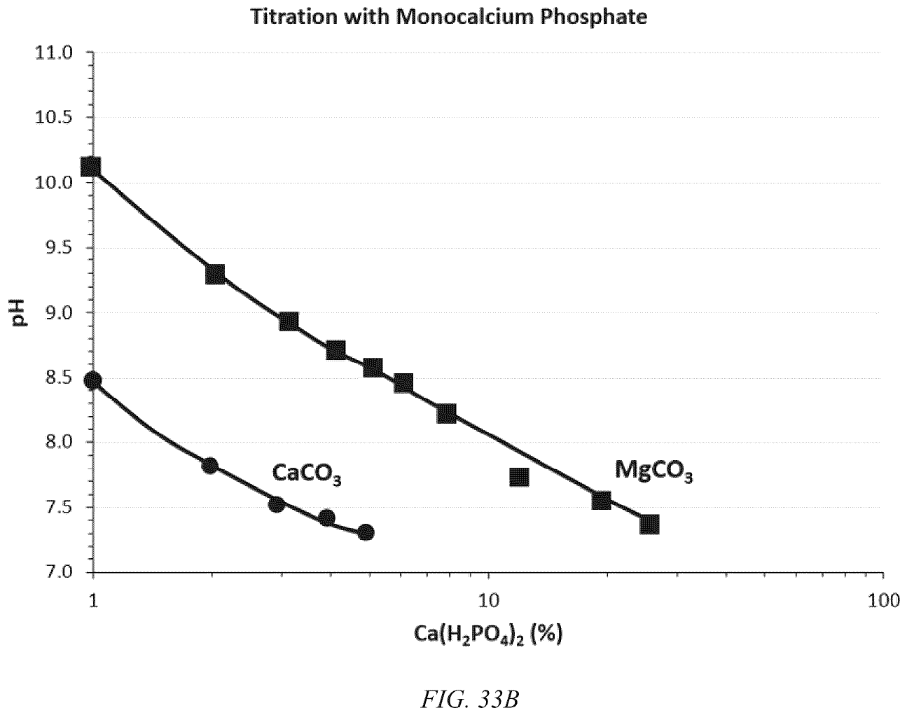

FIG. 33A shows a titration of saturated CaCO₃ with three salts: CaSO₄·2H₂O, Ca(H₂PO₄)₂, and CaHPO₄. Reaching a pH of 8.5 (where ordinary glass is stable) requires a about 35% blend of CaSO₄·2H₂O or CaHPO₄, but only 1% Ca(H₂PO₄)₂. The Ca(H₂PO₄)₂ is more acidic, so less is required. On the other hand, it is moderately water soluble, so it could be leached from the synthetic stone if subjected to flowing water.

FIG. 33B shows a titration of saturated CaCO₃ and MgCO₃ solutions with Ca(H₂PO₄)₂. Reaching a pH of 8.5 (where ordinary glass is stable) requires a blend of 1 and 6% Ca(H₂PO₄)₂ with CaCO₃ and MgCO₃, respectively.

In addition to glass, other fibers that may be added include those made from metal (e.g., steel), carbon, and plastic (e.g., polypropylene).

### Pigments

Numerous mineral pigments are available in a large variety of colors. For example, iron oxide is available in the following colors: red, yellow, black, brown, orange, green, and blue [5]. Titanium dioxide can be added as a white pigment. These pigments can be added to the formulation as permanent colors that do not fade. Furthermore, multiple colors can be used to create interesting swirl patterns.

Phosphorescent pigments can be added that allow the material to glow in the dark. Examples of such pigments include strontium aluminate. When doped with europium, various colors can be created. Phosphorescent pigments are particularly useful in road applications where the road can be illuminated without street lamps.

### Abrasion-Resistant Components

Some applications, such as roads and floor tiles, are subjected to heavy traffic that can cause wear. Including wear-resistant components will extend the life. Examples of wear-resistant components include granite, alumina, silicon carbide, tungsten carbide, diamond, and zirconia.

### Hydrophobic Components

Cementitious material is porous and hence will absorb water. Some applications, such as roofing tiles and road beds, need to be water repellant and water impermeable. These properties can be achieved by incorporating hydrophobic components into the mixture, such as powders composed of polyethylene, polypropylene, polytetrafluoroethylene, or wax. After the cementitious material is cured, the temperature can be raised causing the added powder to soften or melt, and thereby distribute through the pores in the material.

After the material is fabricated, hydrophobic paints and coatings can be applied that adsorb into the material. Examples include polyvinylidene fluoride paint, and Ultra-Ever Dry and NeverWet coatings. Similarly, to protect the synthetic stone from freeze-thaw cycles by locking out moisture, commercially available sealants (e.g., TSS250, SILOXA-TEK® 8500) can be applied to dry materials.

### Magnetic Components

The final product can become magnetic by incorporating magnetic materials such as magnetite, samarium cobalt, alnico, and rare earths such as neodymium. Because of it low cost, magnetite is of particular interest. The binder can include carbonates of calcium, magnesium, and iron. Iron carbonate is particular desirable because it also is magnetic and will contribute to the overall strength of the magnet (Table 16).

Table 17 presents the densities of carbonate materials, some of which contain magnetite, which is both a pigment and a magnetic material.

A magnetic disc (63.5-mm diameter, 10.1-mm thickness) was fabricated from 27% calcium hydroxide, 63% synthetic magnetite, and 10% water. After magnetic saturation, the residual magnetism was 8.3 gauss on the north pole and −13.6 gauss on the south pole.

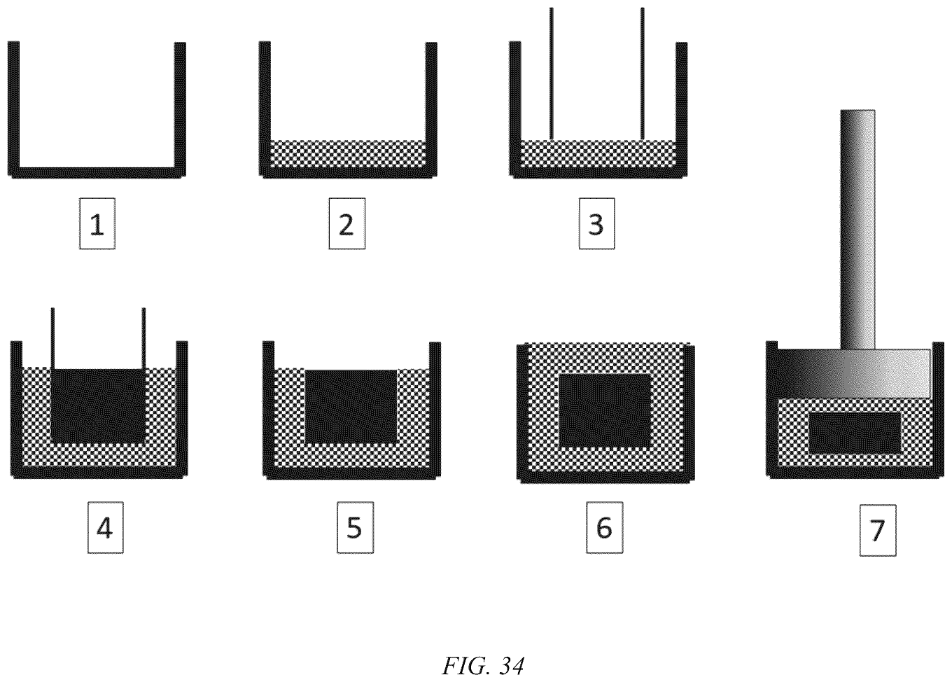

A magnetic column (63.5-mm diameter, 60.5-mm thickness) was fabricated using the technique described in FIG. 34. Further details are provided below. The outer surface was made from 67.5% calcium carbonate, 18% calcium hydroxide, 4.5% 3.2-mm glass fiber, and 10% water. The core was 100% natural magnetite. The wall thickness was about 5 mm. After magnetic saturation, the residual magnetism was 32.6 gauss on the north pole and −23.4 gauss on the south pole.

### Catalytic Components

Catalysts can be included as a component of the material. For example, titanium dioxide (anatase polymorph) will serve as a photocatalyst that helps degrade volatile organic compounds that touch the surface, thus creating self-cleaning buildings [7].

### Fabrication Methods

### Layering

The final cementitious product can be constructed in layers. For example, the core could contain glass fibers for strength whereas the surfaces could contain pigments for aesthetic appeal. FIG. 34 shows how layers can be created during the molding process:
1. Mold is emptied
2. Bottom layer is added
3. Sleeve is inserted
4. Center layers and side layers are added
5. Sleeve is removed
6. Top layer is added
7. Material is pressed

After the material is pressed into “greenware” solid, then it is cured.

### Conical Tubes

Conical tubes can be employed in towers, such as electric utility poles, cell phone towers, antennae towers, and wind turbine towers—among others. FIG. 35 shows a conical mold. The annual space 3500 between the male and female portions of the mold are filled with the raw powdered ingredients. After the press is completed, the male portion of the mold is removed and the conical part is recovered as “greenware” solid, and then cured by carbonation or undergoing the pozzolanic reaction.

### High-Strength Columns

High-strength lightweight columns are needed for large structures, such as bridges and high-rise buildings. In the following discussions, it is assumed that the discs are made from synthetic stone (e.g., calcium, magnesium, or iron carbonates); however, the disc can be made from other pozzolanic materials such as cement or concrete.

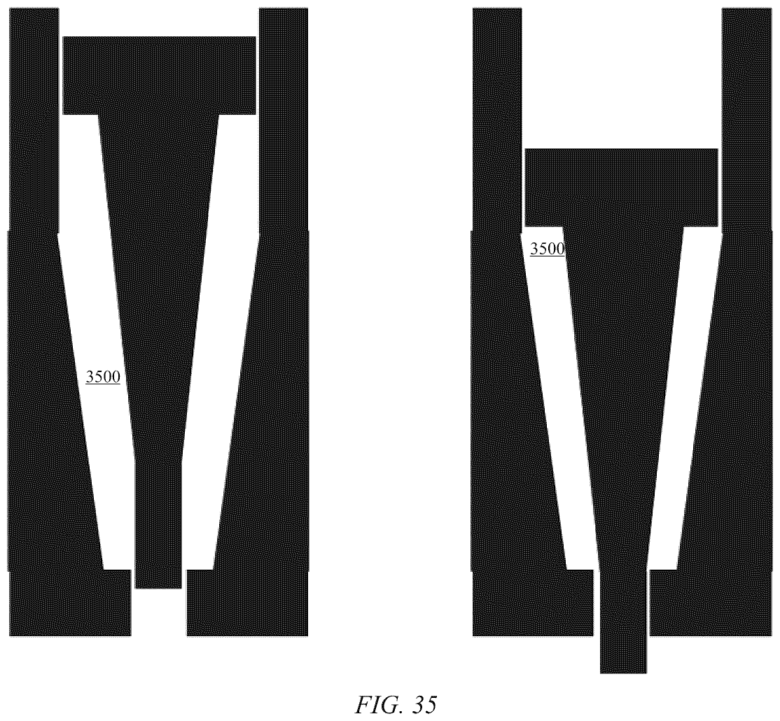

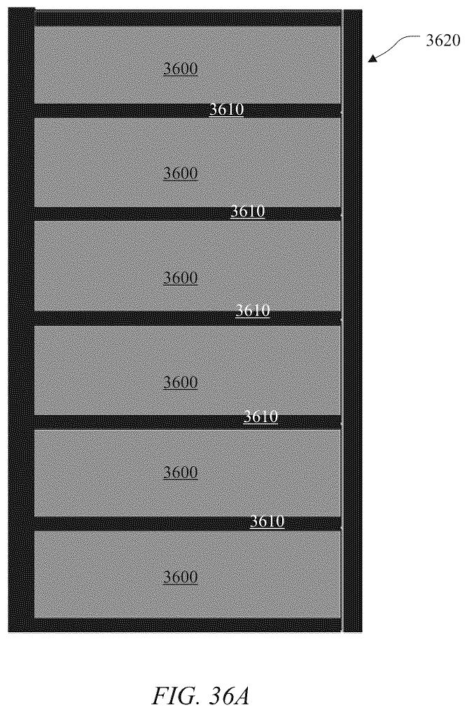

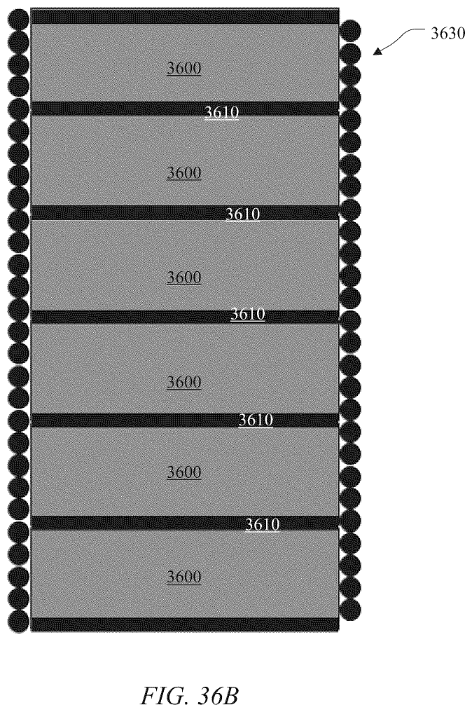

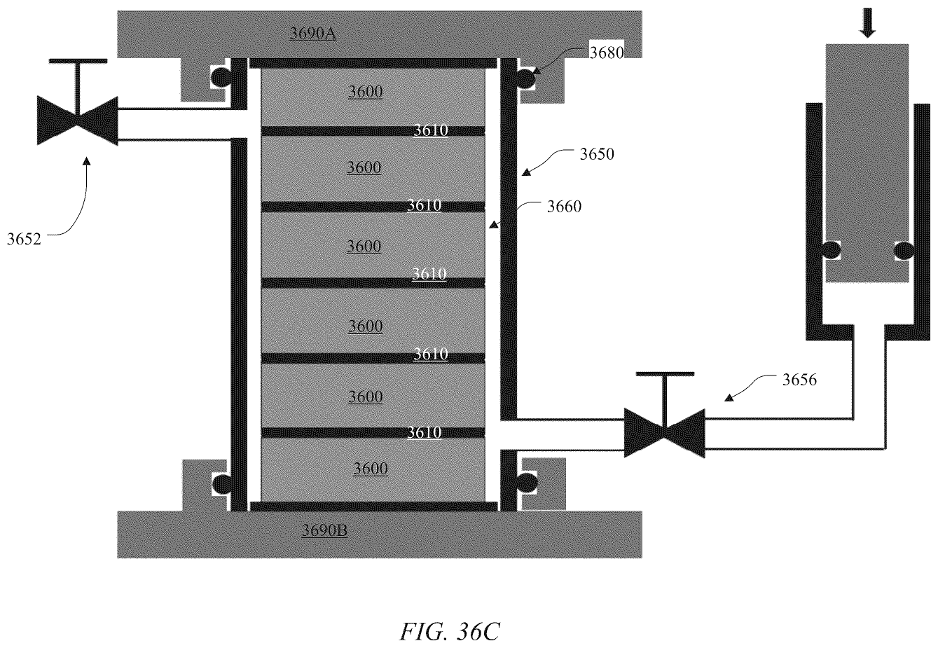

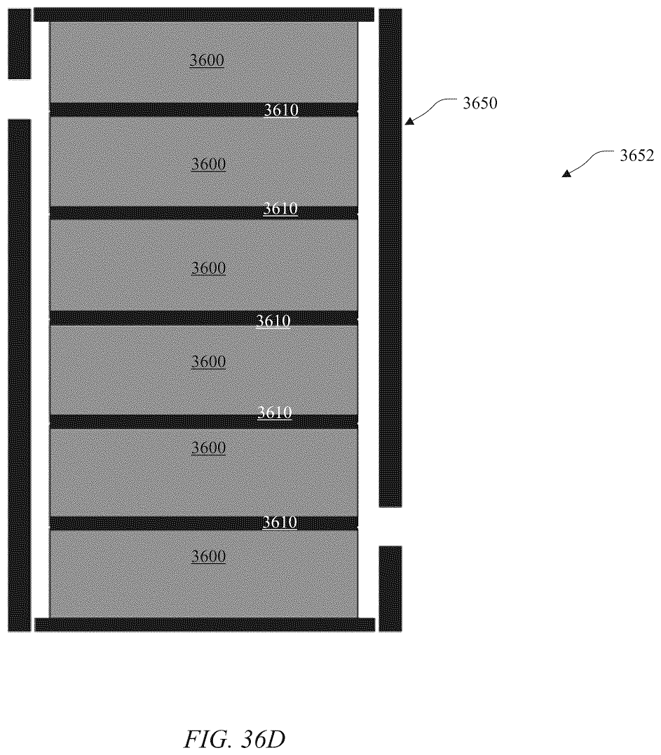

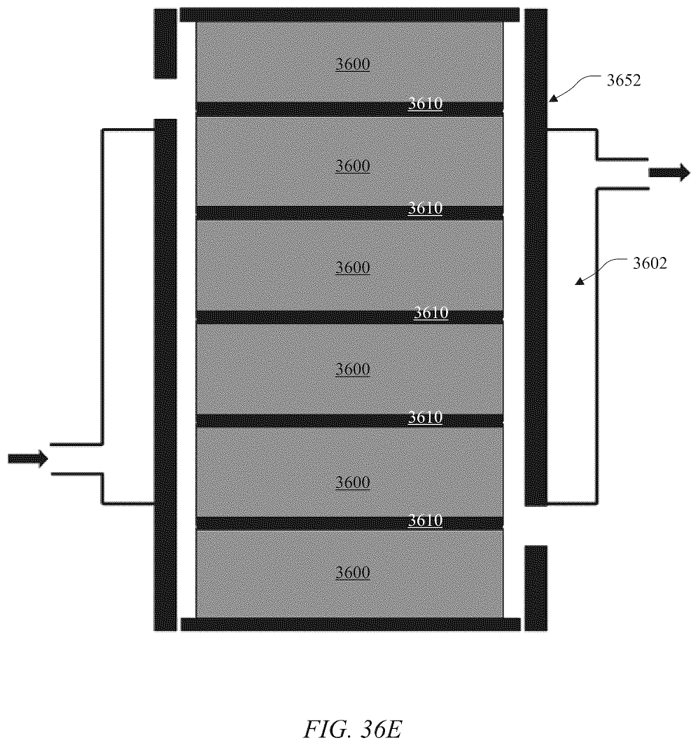

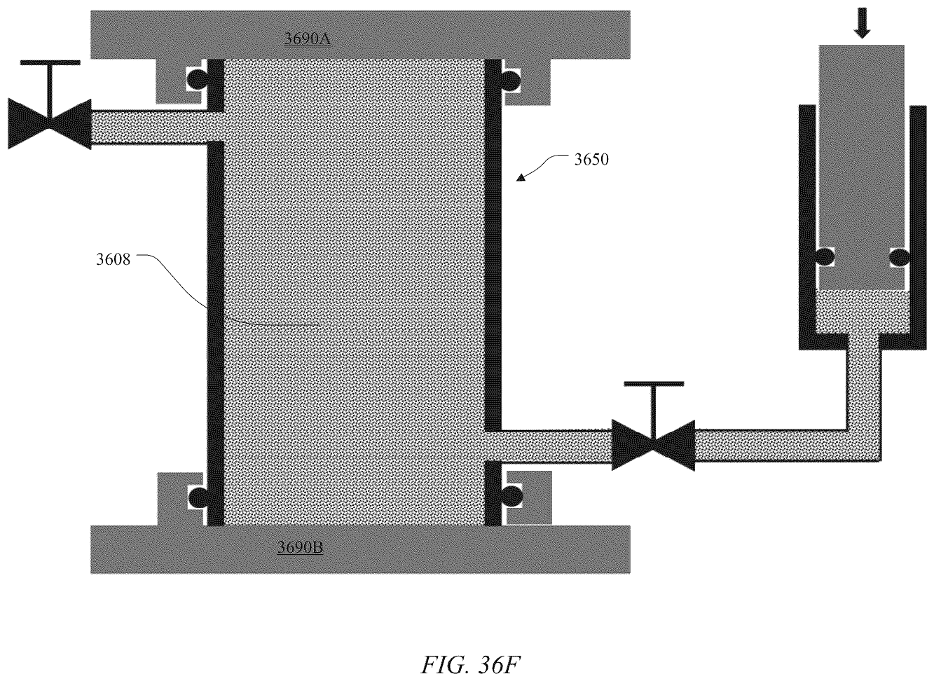

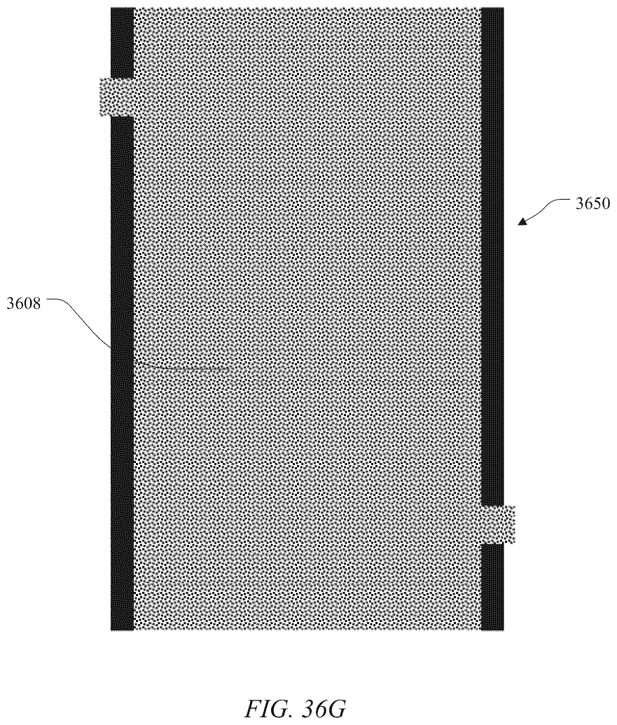

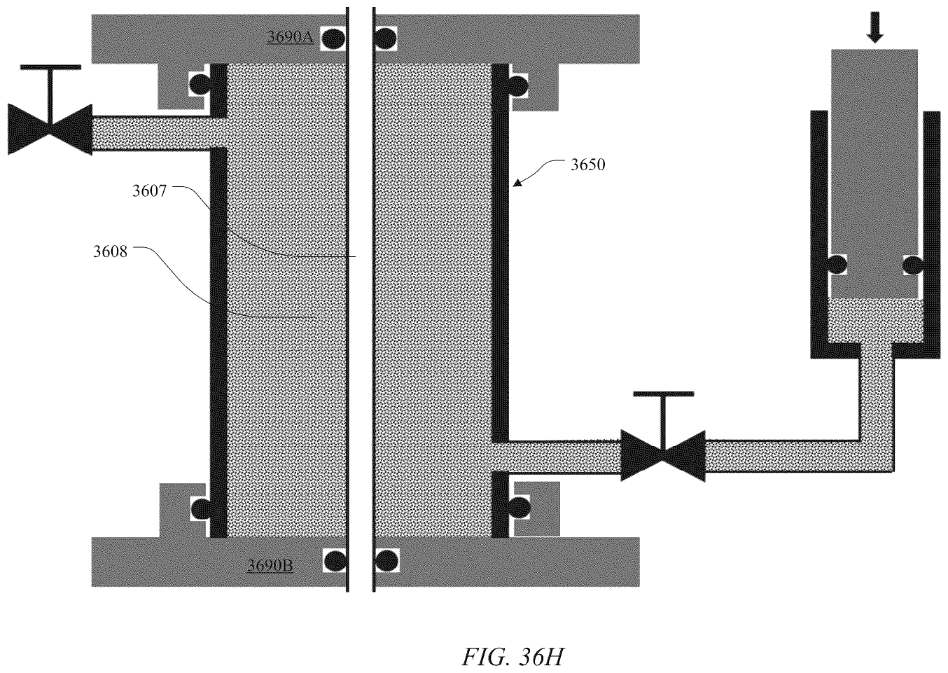

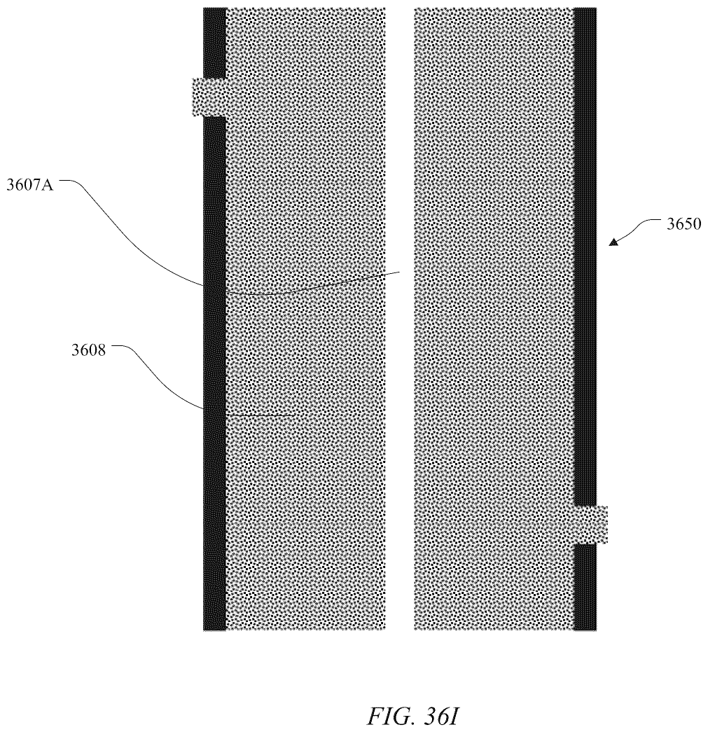

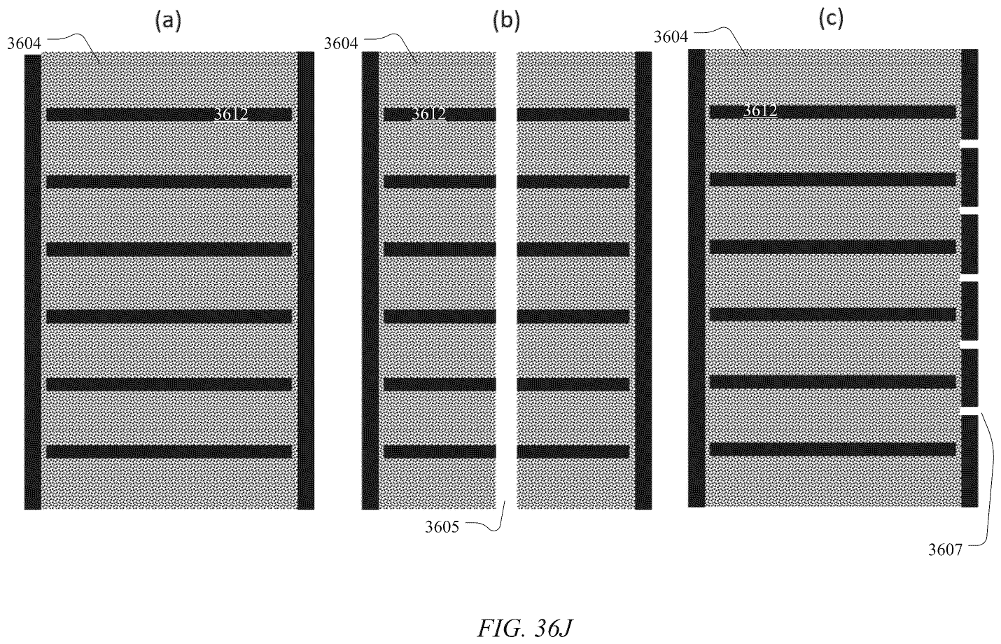

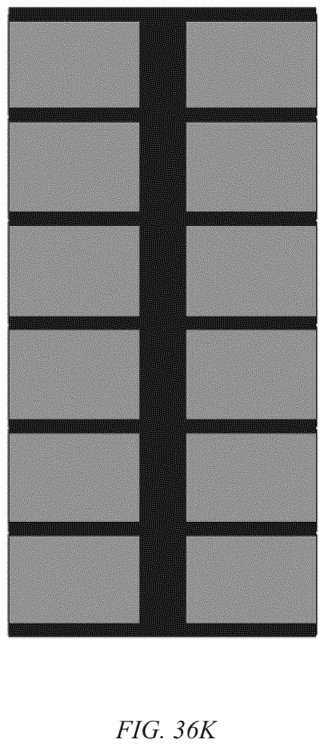

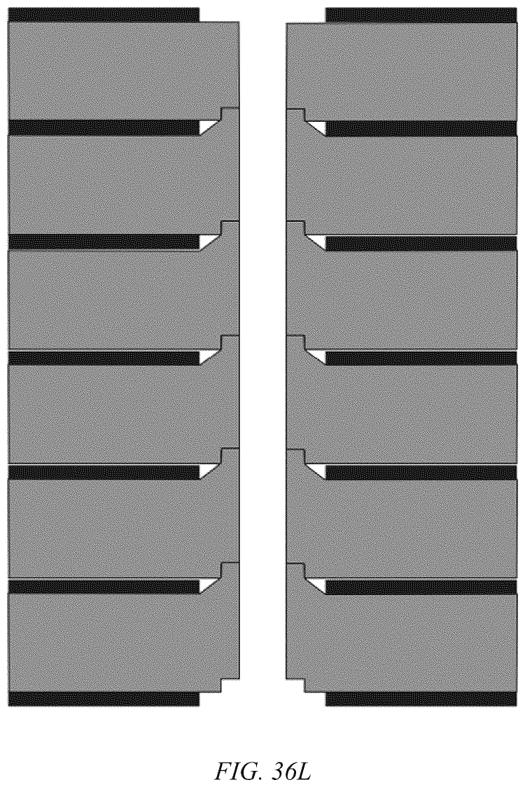

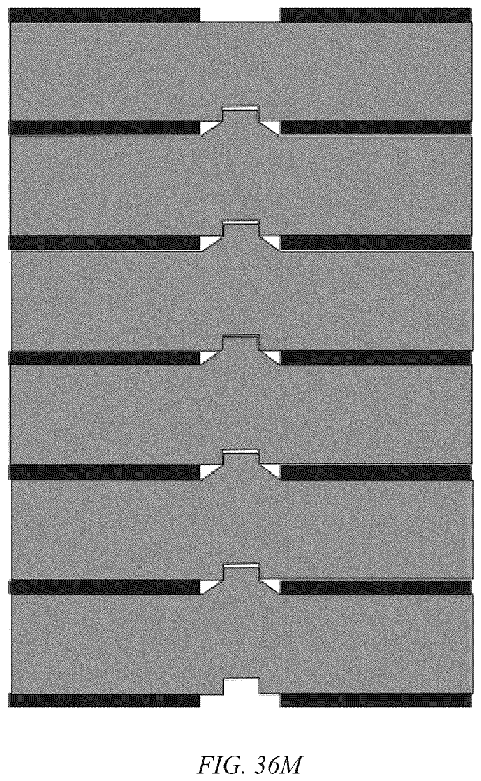

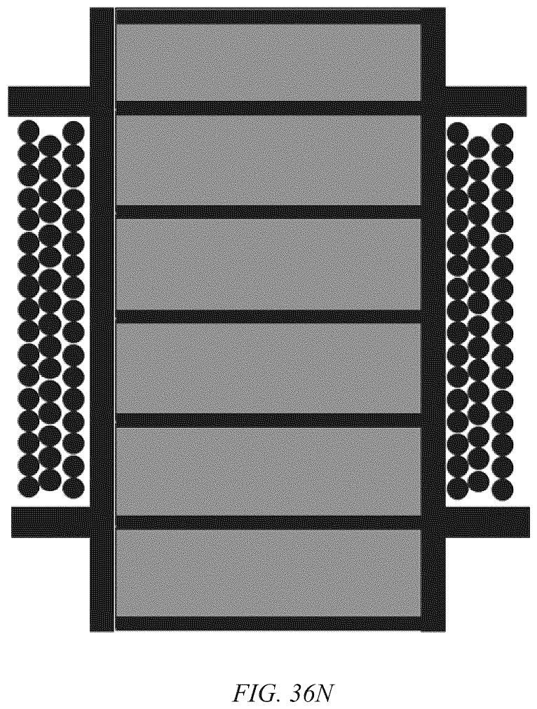

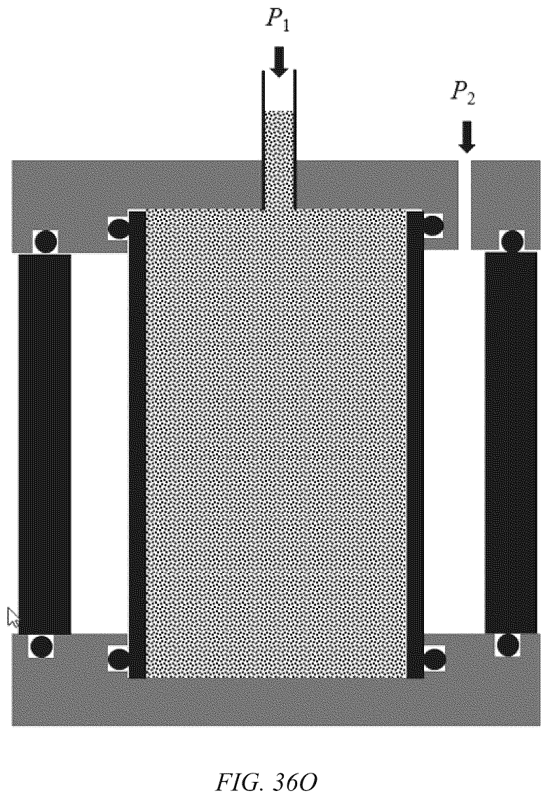

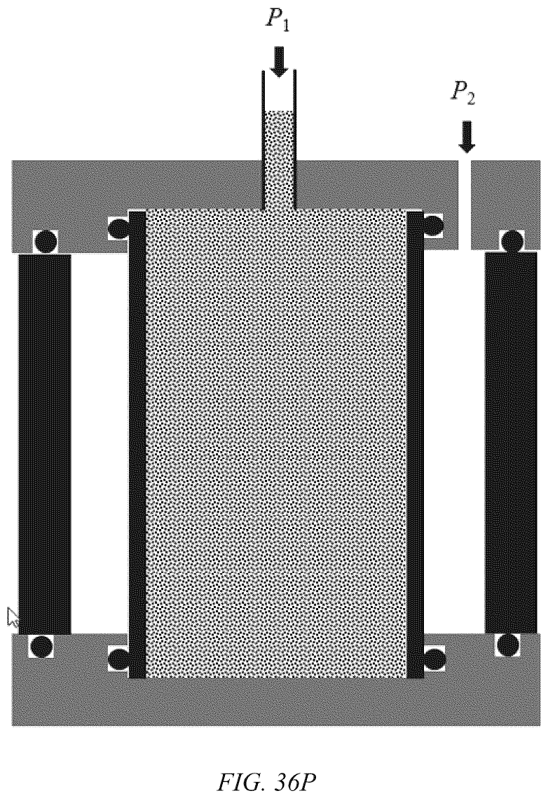

FIG. 36A shows prefabricated discs 3600 assembled into a column. If desired, each disc 3600 can be separated by a steel plate 3610 that serves as a crack arrester. If desired, the steel plates can be glued to the adjacent synthetic stone discs. The outer radius of the discs are surrounded by a material 3620 such as a tube of steel, fiberglass composite, carbon fiber composite, or other desired materials. To ensure good contact between the core and the tube, prior to assembly, the core can be chilled and the tube can be heated. When they equilibrate to the same temperature, the tube will shrink fit onto the core.

FIG. 36B shows prefabricated carbonated discs 3600 assembled into a column. If desired, each disc can be separated by a steel plate 3610 that serves as a crack arrester. If desired, the steel plates can be glued to the adjacent synthetic stone discs. The outer radius of the discs are wrapped with high-strength fibers 3630, such as those described in Table 18. Once wrapped, the fibers 3630 can be coated with epoxy or other suitable material that secures the fibers in place.

FIG. 36C shows an apparatus for creating high-strength, lightweight, steel-jacketed columns. Prefabricated discs 3600 are assembled into a column. If desired, each disc can be separated by a steel plate 3610 that serves as a crack arrester. If desired, the steel plates 3610 can be glued to the adjacent synthetic stone discs. The assembled column is coated with water-proof material, such as epoxy paint. Then, the coated column is inserted into the steel jacket 3650 End plates 3690A, 3690B seal each end of the column using O-rings 3680. The end plates 3690A, 3690B are secured by inserting the entire assembly into a rigid fixture (not shown) or by connecting the two plates via long thread rods (not shown). The annular space 3660 between the column and the jacket is filled with cement—preferably cement used in non-shrink grout. Initially, both valves 3652, 3656 are open, which allows the cement to flow through the annual space and thereby displace trapped air. Then, the outlet valve 3652 is closed while the inlet valve 3656 is open. Cement continues to be pumped in, which places the carbonated discs 3600 in compression and the steel 3650 jacket in tension. Once the desired pressure is reached, the inlet valve 3656 is closed, which seals the system under pressure while the cement cures. The valves can be mechanical valves, such as ball valves. Alternatively, the valve can consist of tubing that is pinched shut. To increase the strength of the steel jacket 3650, it can be wrapped with high-strength fibers, such as those described previously.

Preferentially, the grout cement cures while pressure is maintained; however, it can cure after the pressure is released. The end plates 3690A, 3690B are removed, which completes the steel-jacketed column 3652 (FIG. 36D). As shown in FIG. 36E, a jacket 3602 can be added to the steel-jacketed column 3652 that provides cooling in the event of fire.

FIG. 36F shows an embodiment in which the steel jacket 3650 is filled with pressurized wet pozzolanic material 3608 that is pumped in at high pressure, which places the cement/concrete in compression and the steel column in tension. Preferentially, the cement/concrete cures while pressure is maintained, as was previously described for the prefabricated carbonated discs. Alternatively, the cement/concrete cures after the pressure is removed. FIG. 36G shows the cement/concreted filled column after the end plates 3690A, 3690B have been removed.

FIG. 36H shows an embodiment similar to FIG. 36F, except a tube 3607 is inserted into the center of the steel jacket 3650. To facilitate later removal of the tube 3607, it can be coated with a hydrophobic material (e.g., grease, petroleum jelly, wax). Furthermore, the tube 3607 may be optionally filled with high-pressure fluid that inflates the diameter. Then, the jacket 3650 is filled with pressurized wet pozzolanic material 3607 that is pumped in at high pressure, which places the pozzolanic material in compression and the steel column in tension. Preferentially, the pozzolanic material cures while pressure is maintained on both the pozzolanic material 3608 and the tube 3607. Alternatively, it can cure after the pressure is removed. After curing is completed, the tube 3607 is deflated (if this step was taken) and removed.

FIG. 36I shows the pozzolanic material filled column after the end plates have been removed. The entire column can be placed in a high-pressure CO₂, which carbonates the pozzolanic material, which both sequesters CO₂ and potentially adds strength. The purpose of the tube is to facilitate CO₂ diffusion, which shortens the time required to achieve reaction with CO₂. After reacting the column with CO₂, the center hole 3607A can be filled with pozzolanic material.

FIG. 36J shows a pipe filled with a mixture of nonreactive components (e.g., sand, gravel, powdered limestone, powdered dolomite) and a reactive pozzolanic component (e.g., portland cement). Optionally, the mixture can also contain crack-arresting fibers (e.g., glass, steel, polypropylene, hemp) that increase mechanical strength. The mixture is segmented into sections by a crack-arresting steel discs 3612. In FIG. 36J, view (a), the reaction terminates with the hydration. In FIGS. 36J, views (b) and (c), after the hydration reaction is completed, the pipe is subjected to high-pressure carbon dioxide, which allows an addition carbonation reaction to occur. In FIG. 36J, view (b), contact between the carbon dioxide and the mixture is facilitated by a center hole 3605. In FIG. 36J, view (c), contact between the carbon dioxide and the mixture is facilitated by perforations 3607 in the pipe.

FIG. 36K shows an embodiment in which the stacked discs of cementitious material and steel have a center hole through which a rod or pipe is inserted. FIGS. 36L and 36M show embodiments in which the stacked discs self-align. In FIG. 36L, pozzolanic material can be poured into the center channel that unitizes the stack once it hardens.

FIG. 36N shows a pipe containing cementitious materials with optional guide discs at each end. The guide discs can have slots or holes that secure the origin and terminus of the wrapping material. In essence, the discs define the ends of a “spool” of wire, fiberglass, or carbon fiber. The pipe is filled with a cementitious material. Optionally, the cementitious material is segmented into short discs using metal plates that serve as crack arresters. If wire is used, during the wrapping process, the pipe and cementitious material are cold and the wire is hot. When the wire cools, it contracts and thereby places the pipe and cementitious material in compression.

FIG. 36O shows a pipe being filled with cementitious material. The annular space between the pipe and a jacket is filled with a high-pressure fluid (e.g., water). While filling the pipe, P₁ can be very large because the exterior of the pipe is balanced by P₂, which also can be very large by using a thick-walled jacket. While filling the pipe, if P₁>P₂, the pipe wall is in tension. Once the cementitious material cures, the pipe is removed from the jacket. The residual tension in the pipe places the cementitious material in compression, which strengthens it.

FIG. 36P shows an alternative embodiment in which the pozzolanic material in the pipe is compressed directly by a piston.

FIG. 36Q shows an alternative embodiment in which the pozzolanic material in the pipe is compressed directly by a piston. In this case, during the compression process, the pipe is contained within a thick-walled jacket. The gap between the pipe and thick-walled jacket determines the amount of pipe expansion during the compression process. If the pozzolanic material cures while under pressure, when removed from the thick-walled jacket, the residual stress in the pipe will place the pozzolanic material under radial compression and thereby increase its strength.

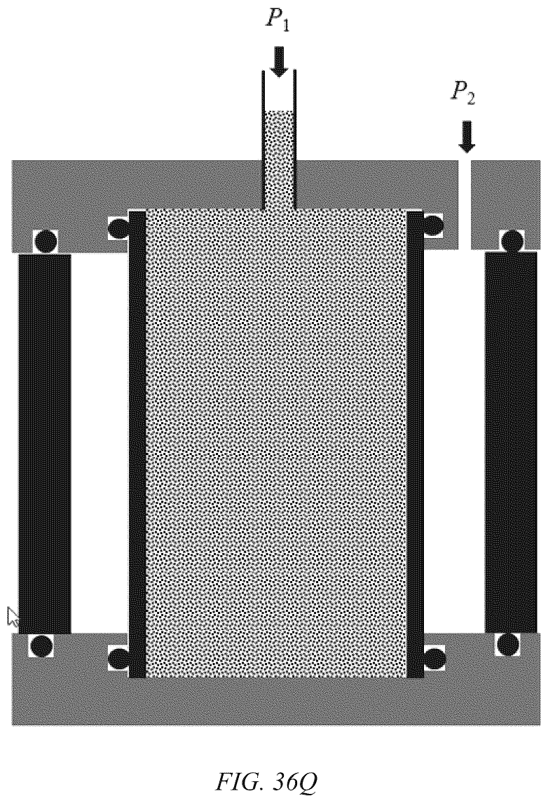

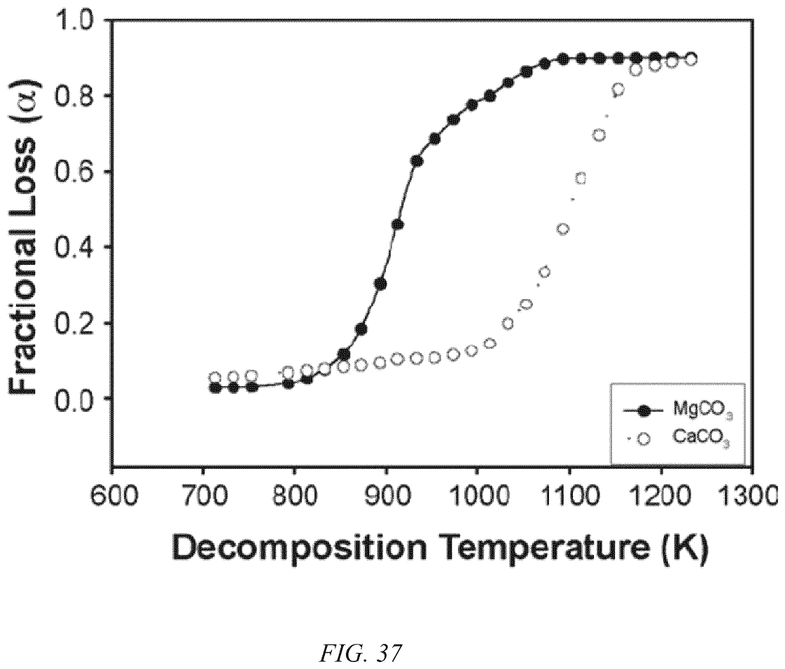

Steel begins to soften at 425° C. and loses half its strength at 600-650° C. [8] FIG. 37 shows the decomposition of calcium and magnesium carbonate as a function of temperature at 1 atm. Magnesium carbonate starts to decompose at 800 K (530° C.), and calcium carbonate starts to decompose at 990 K (720° C.). These temperatures are similar to the temperatures where steel loses it strength, so conventional fire protection measures used to protect steel (e.g., intumescent and cementitious coatings) should be sufficient to protect magnesium and calcium carbonate. If extra measures of protection are required, the cooling jackets described in FIG. 36E can be employed. Also, containing the magnesium or calcium carbonate in a sealed pressure vessel will allow CO₂ pressure to build, which raises the decomposition temperature by shifting the equilibrium.

In the above discussion, the jacket is made from steel; however, other materials can be employed such as other metals (e.g., titanium, aluminum, stainless steel), or composites made from fiberglass or carbon fiber.

### Column Couplers

The columns described above can be used to support floors in a multi-story building. To achieve this objective, couplers are required at each end of the column.

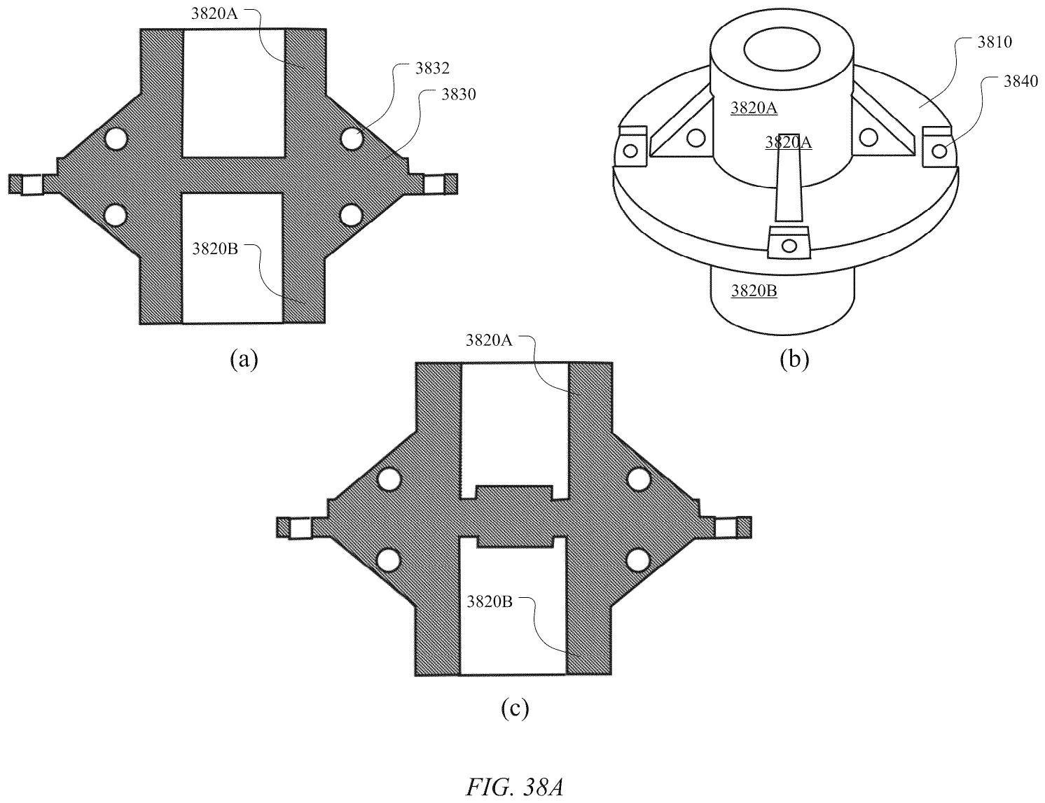

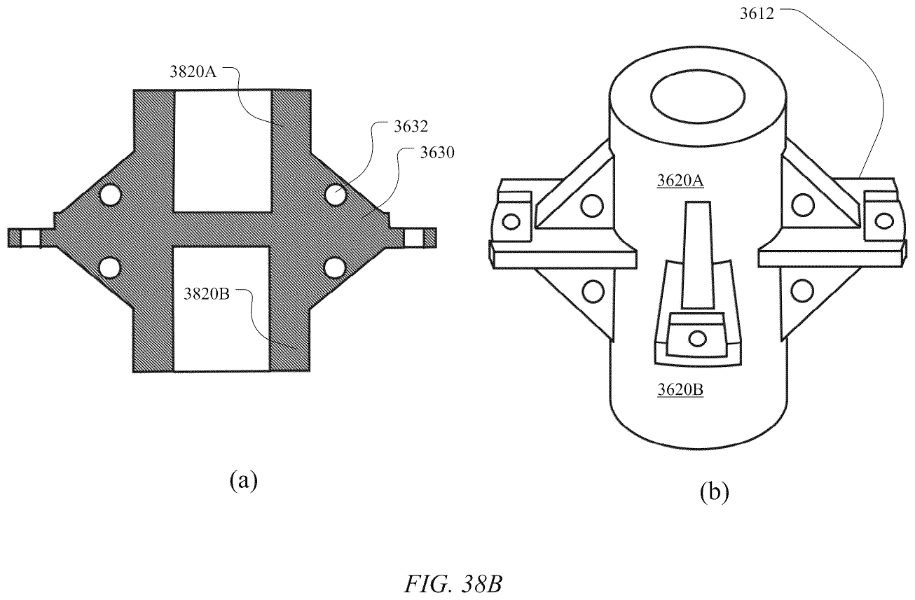

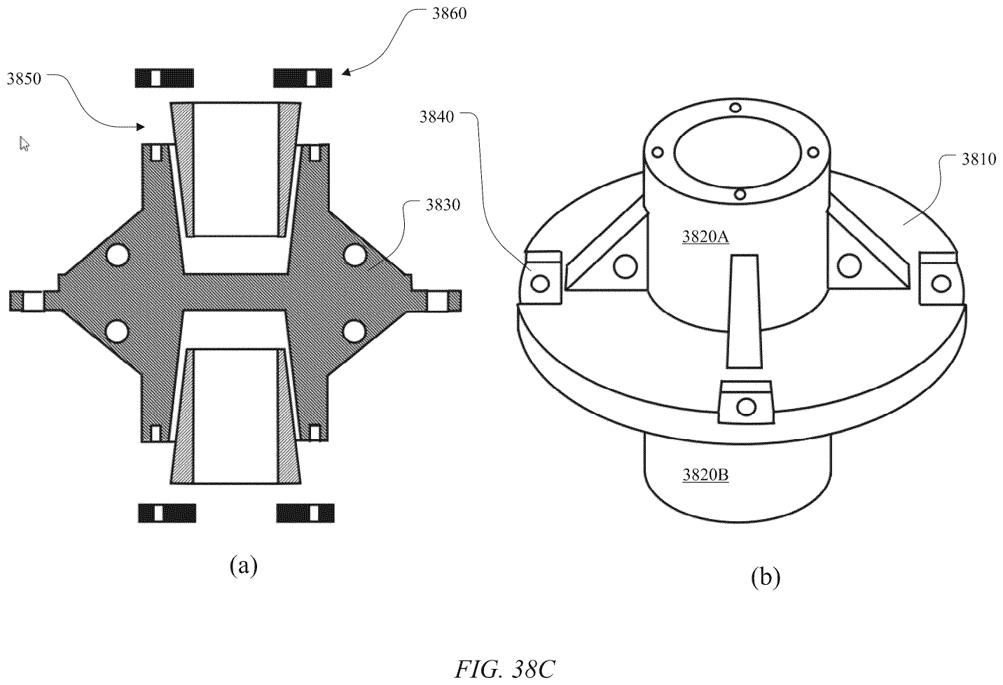

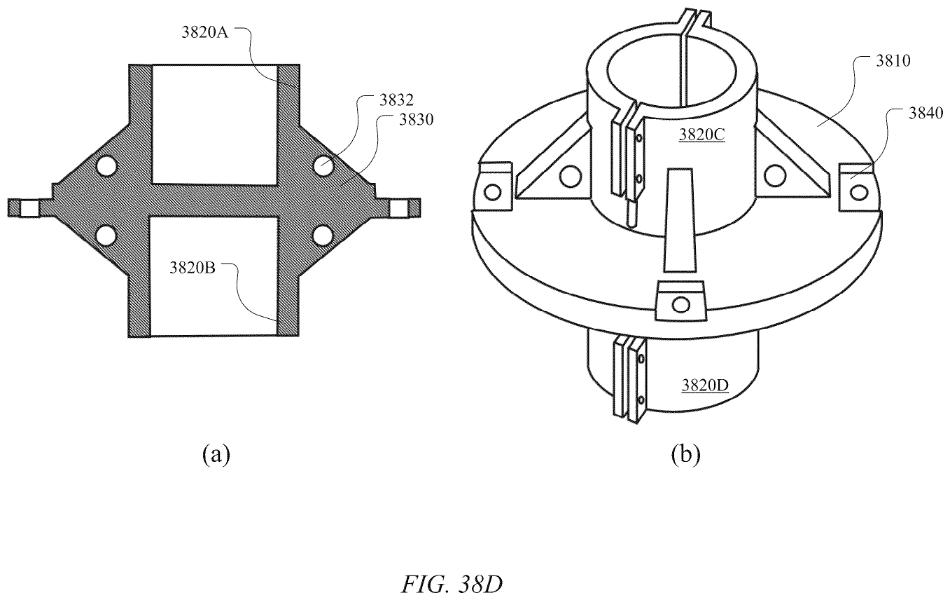

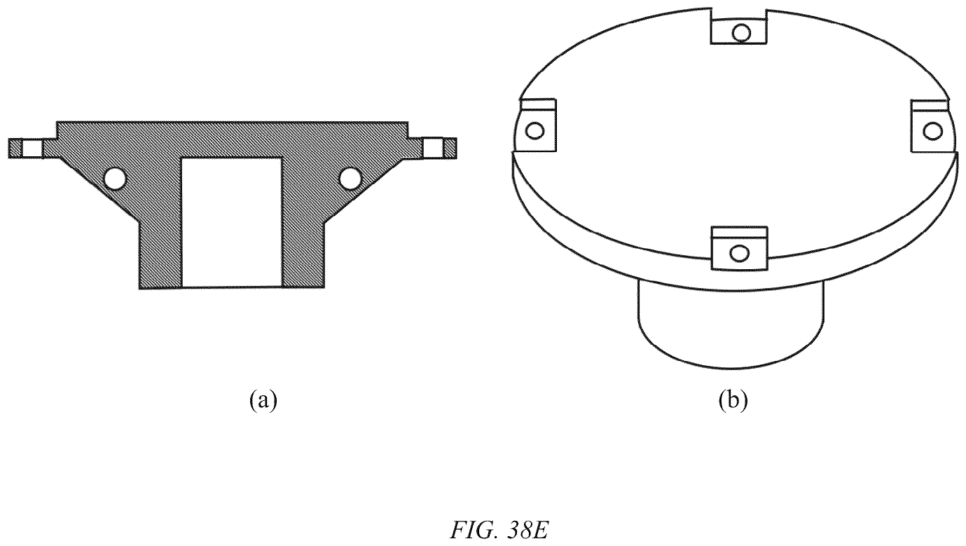

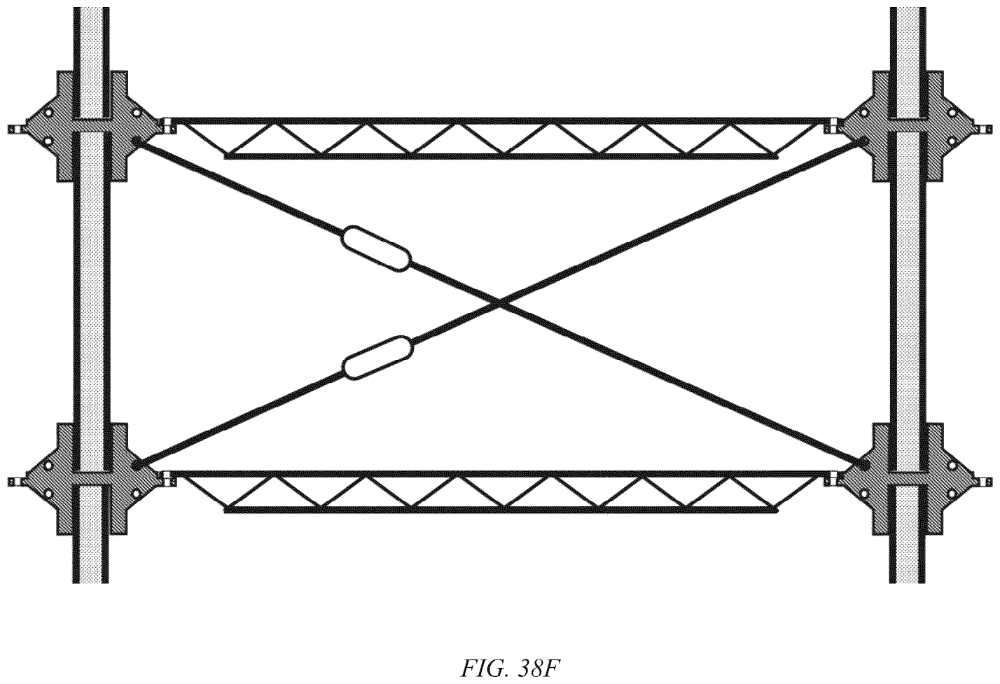

FIG. 38A shows Embodiment A. FIG. 38A view (a) is a cross section and FIG. 38A view (b) is a perspective view. Circular sleeves 3820A, 3820B are shown at each end of a circular plate 3810. Although a circular plate is shown, the plate can have other geometries such as a square. Furthermore, the plate can be perforated to reduce weight. Ribs 3830 stiffen the connection between the plate 3810 and the sleeves 3820A and 3820B. Optionally, each rib 3830 has a hole 3832, which lightens the coupling, and provides a feature that allows a cable to be attached (discussed below). At the base of each rib 3630 is a connection 3640 for a truss. Optionally, the connection 3640 can be recessed so that when the truss is connected, the upper surface is flat with the coupler. In Embodiment A, when the column is inserted into the coupler, is can be secured by various means, such as glue, solder, or cement. FIG. 38A view (c) shows a variant of Embodiment A where the compression load is transmitted only to the core and not the jacket. It is understood that this method of loading the core can be applied to the embodiments discussed subsequently.

FIG. 38B shows Embodiment B. FIG. 38B view (a) is a cross section and FIG. 38B view (b) is a perspective view. Embodiment B is identical to Embodiment A, except that material has been removed from the plate 3812 to lighten the coupling.

FIG. 38C shows Embodiment C. FIG. 38C view (a) is a cross section and FIG. 38C view (b) is a perspective view. Embodiment C is identical to Embodiment A, except that a collar 3860 pushes a circular wedge 3850 into the coupling. When tightened, the wedge secures the column in place.

FIG. 38D shows Embodiment D. FIG. 38D view (a) is a cross section and FIG. 38D view (b) is a perspective view. Embodiment D is identical to Embodiment A, except the circular sleeves 3820C, 3820D are split along the length. After the column is inserted, bolts tighten the sleeve so it firmly secures the column.

FIG. 38E is a top cap for the columns, such as would be used on the roof.

FIG. 38F shows multiple couplers connecting multiple columns. The couplers at a common vertical height are spanned by a truss. The truss supports floors, ceilings, and roofs, such as the example shown in FIGS. 38A and 38B. Optionally, to prevent racking, cables connect opposite couplers, creating an X-pattern. Turnbuckles adjust the tension on the cables, which allows adjustments so the columns are vertical. Rather than cables, rigid pipes or bars can create the X-pattern; however, with this option, it is more difficult to make adjustments to ensure the columns are vertical.

### Fabricated Items

The final carbonated material can be fashioned into a myriad of products, such as park benches, fences, decks, roads, walls, roofing tiles, floor tiles, magnetic coasters, magnetic fidgets, refrigerator magnets, magnetic children's blocks, magnetic roads for maglev trains, etc. Yet further types of materials will become apparent after having reviewed this disclosure.

### Blocks

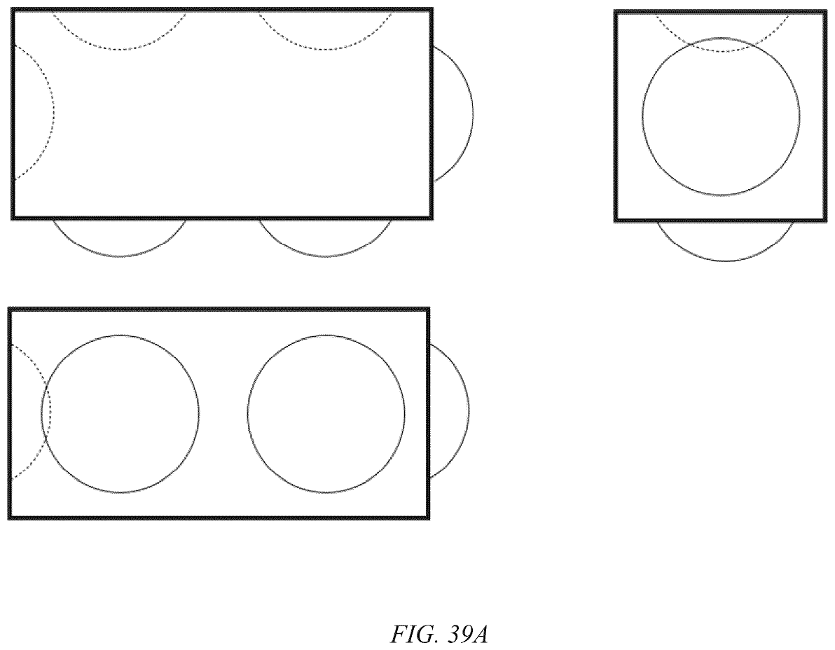

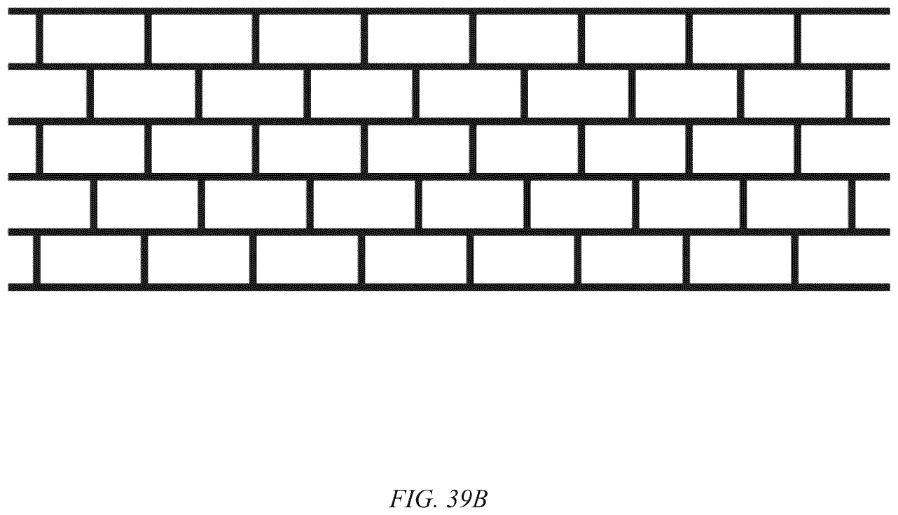

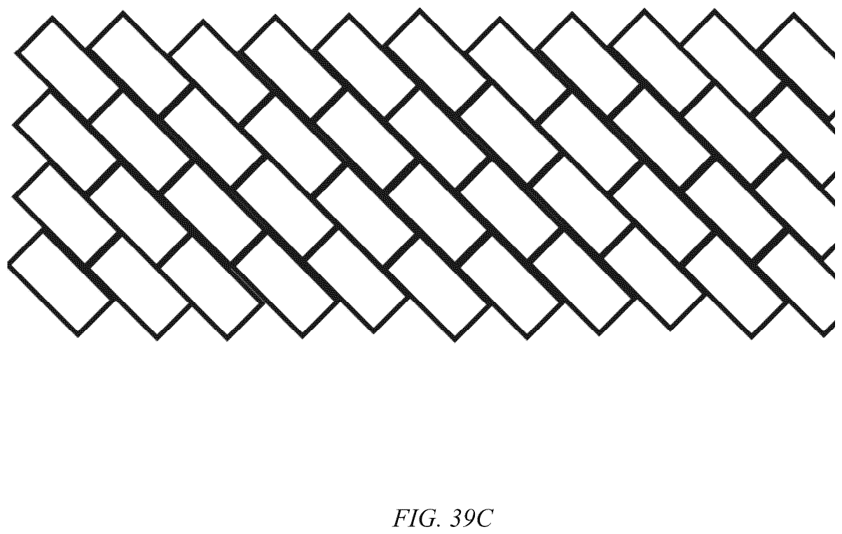

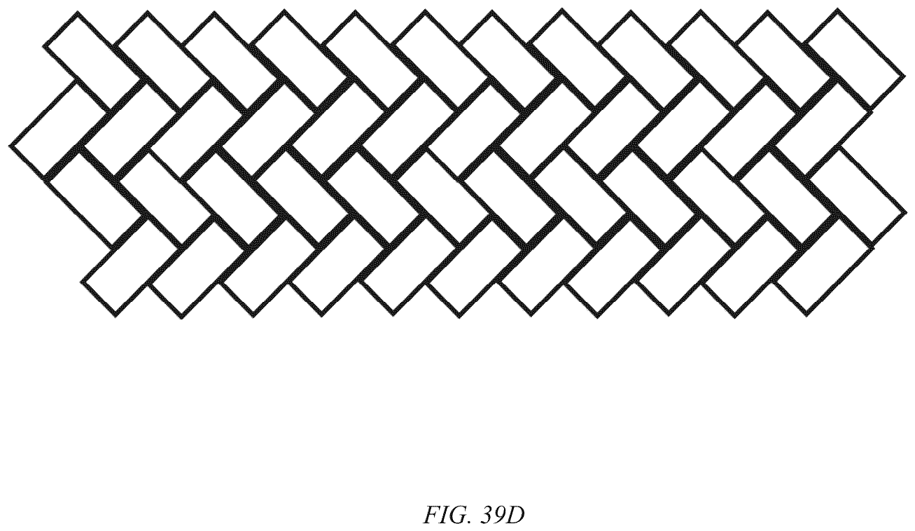

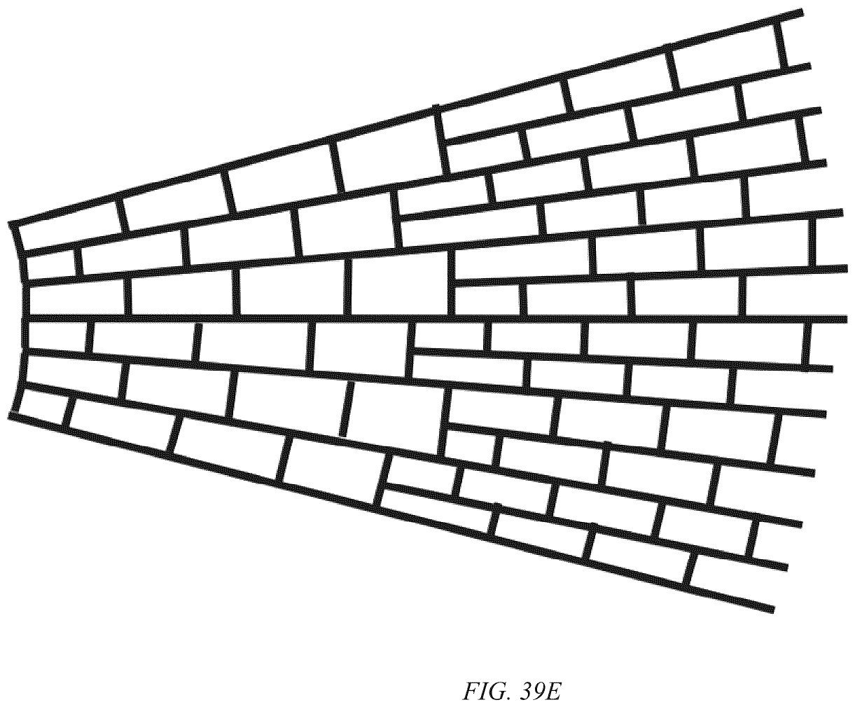

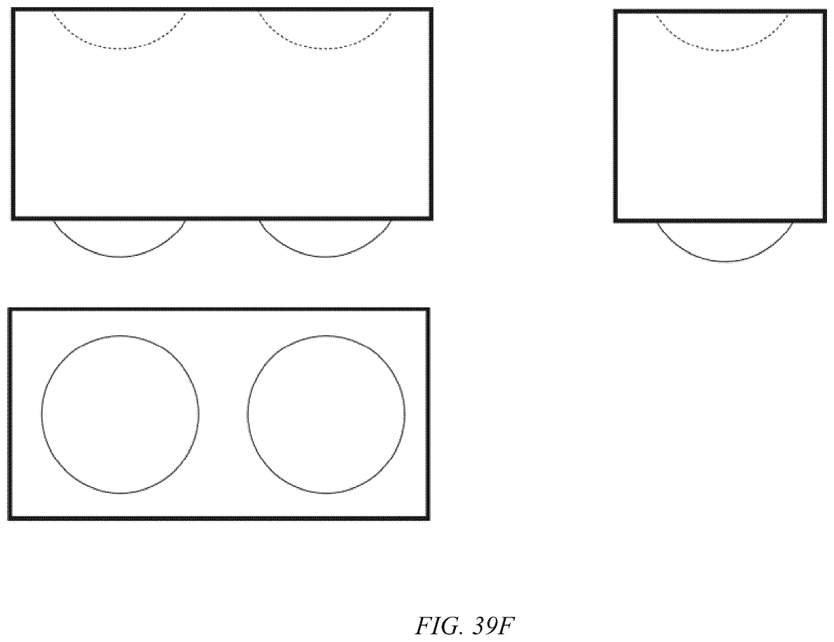

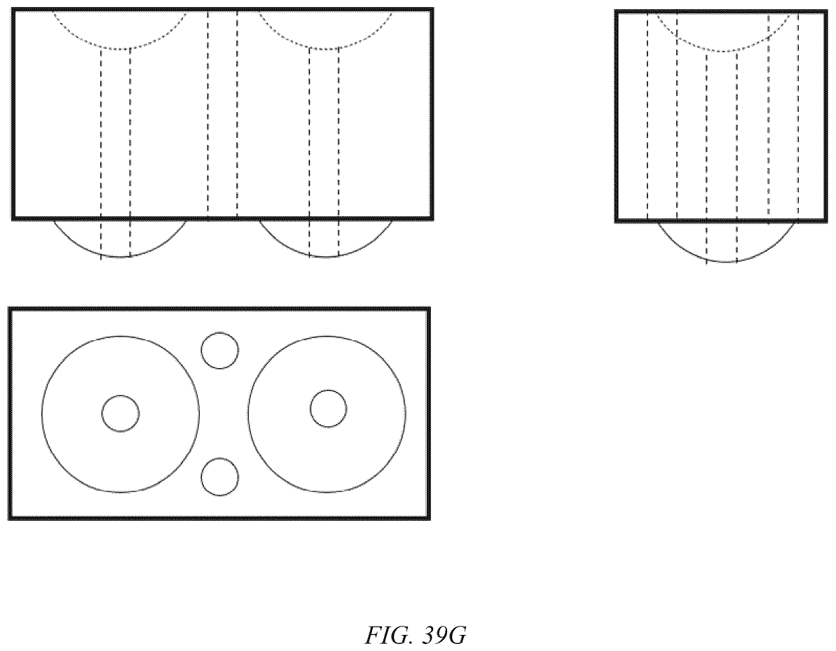

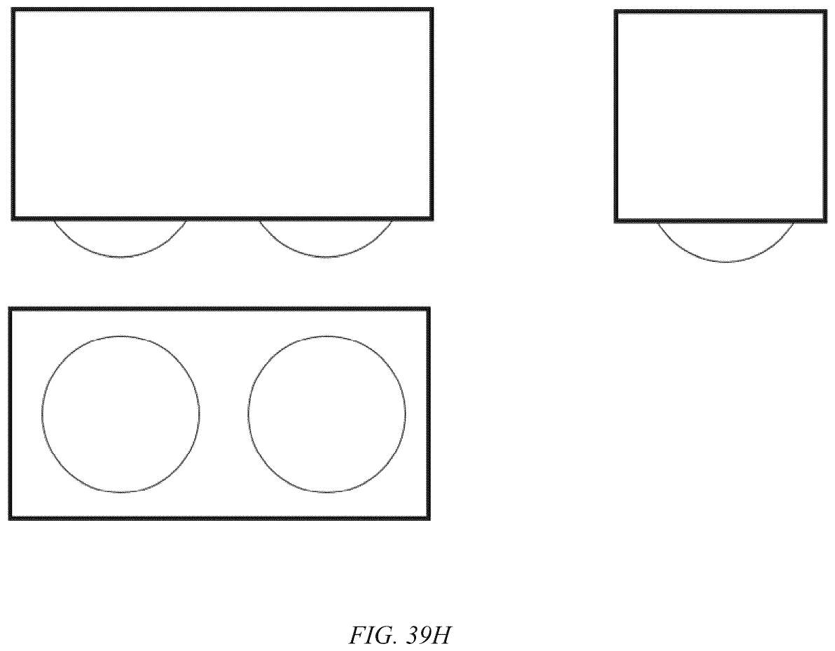

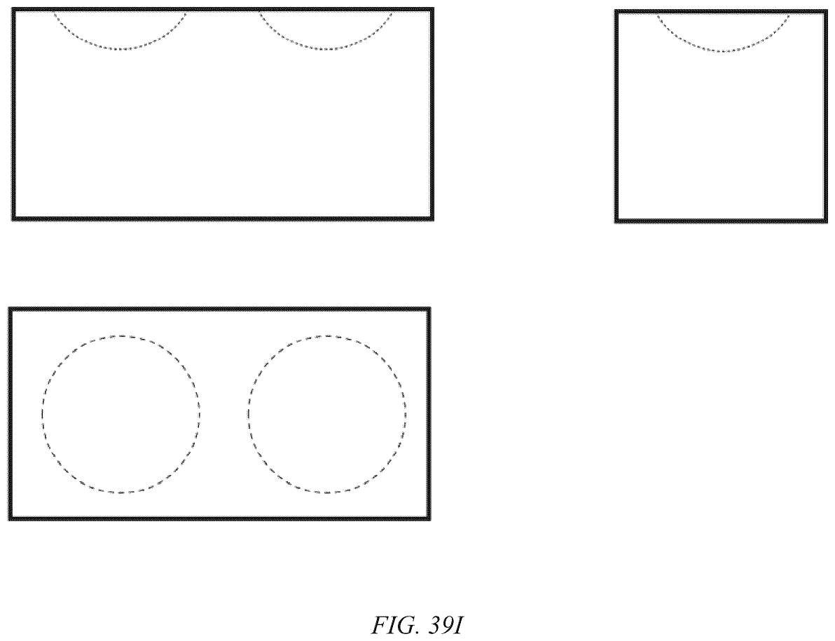

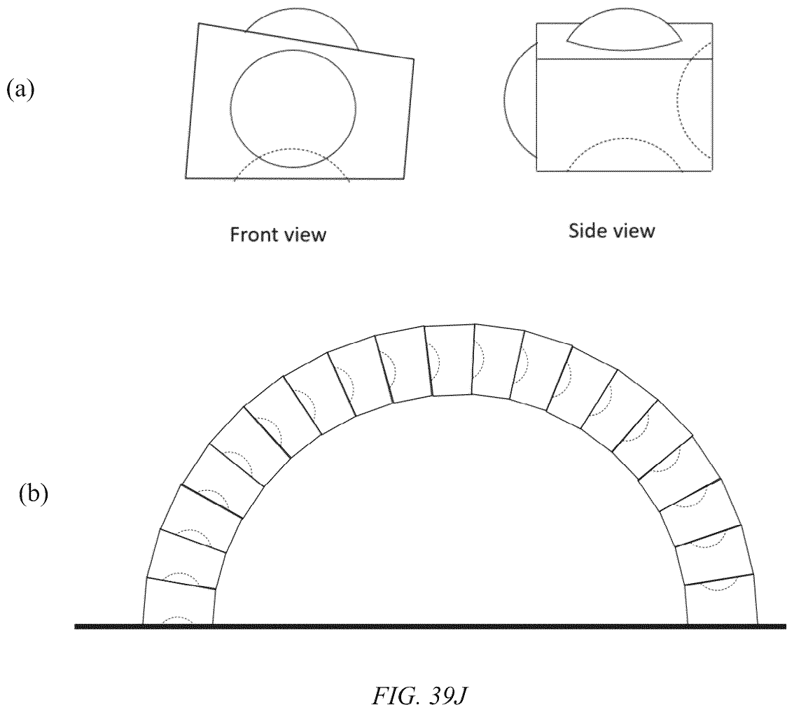

FIG. 39A shows a block with convex and concave alignments on four surfaces. As configured, this block can be used as pavers for roads. For centuries, bricks and cobblestones have been used to create roads, but they are rough surfaces unsuited for high-speed driving. In contrast, pavers made from blocks shown in FIG. 39A would be aligned, so the road surface would be smooth and suitable for high-speed driving. If desired, a tarry substance can be placed between the blocks to create a water-tight road. As described previously, hydrophobic materials can be infused into the blocks that prevent water from entering, thus reducing freeze/thaw cracking.

FIGS. 39B, 39C, and 39D show non-limiting examples of interlocking pattern for a straight road. FIG. 39E shows a non-limiting example of interlocking for curved sections of a road.

FIG. 39F shows a block with convex and concave alignments on two surfaces. As configured, this block can be used to build a wall in a manner analogous to conventional brick walls. Because of the alignments, it would not be necessary to use mortar; the blocks could simply be stacked to make a wall.

FIG. 39G shows a version that contains holes that serve two functions: (1) increase carbonation rate, and (2) provide path for water drainage. Similarly, holes can be included in the other embodiments of the blocks.

FIG. 39H shows a version that has no alignments on the upper surface so it can serve as the upper layer of a wall.

FIG. 39I shows a version that has no alignments on the bottom surface so it can serve as the bottom layer of a wall.

FIG. 39J) view (a) shows the front and side views of a wedge-shaped block that can be assembled into an arch (FIG. 39J view (b)). Optionally, each block can have convex and concave alignments that help position the block properly. If this structure were erected on the Moon, the inner surface could hold a gas-impermeable bladder, thus forming a habitat. To increase protection from space weather (e.g., cosmic rays, radiation) and to provide thermal insulation, Moon regolith can be place on top of the arched structure.

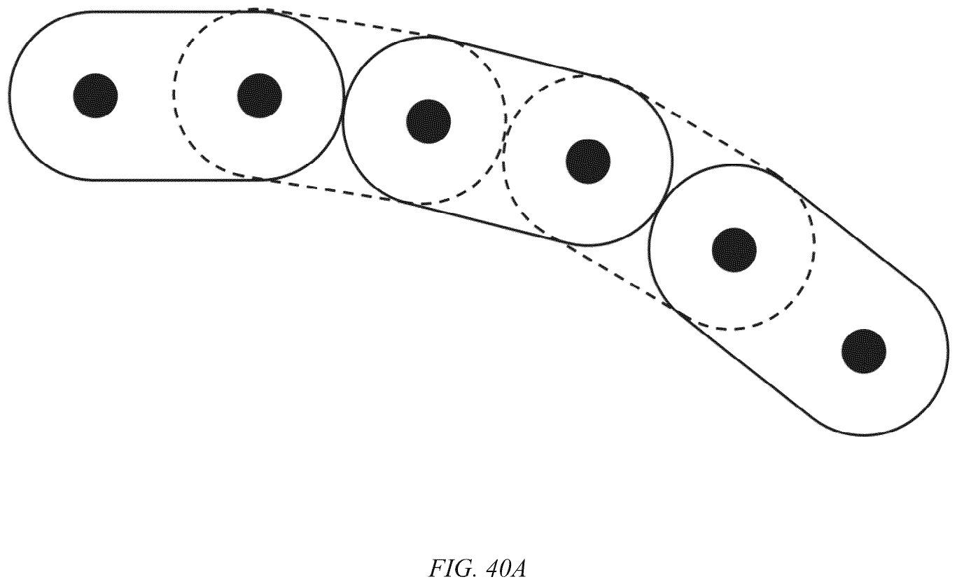

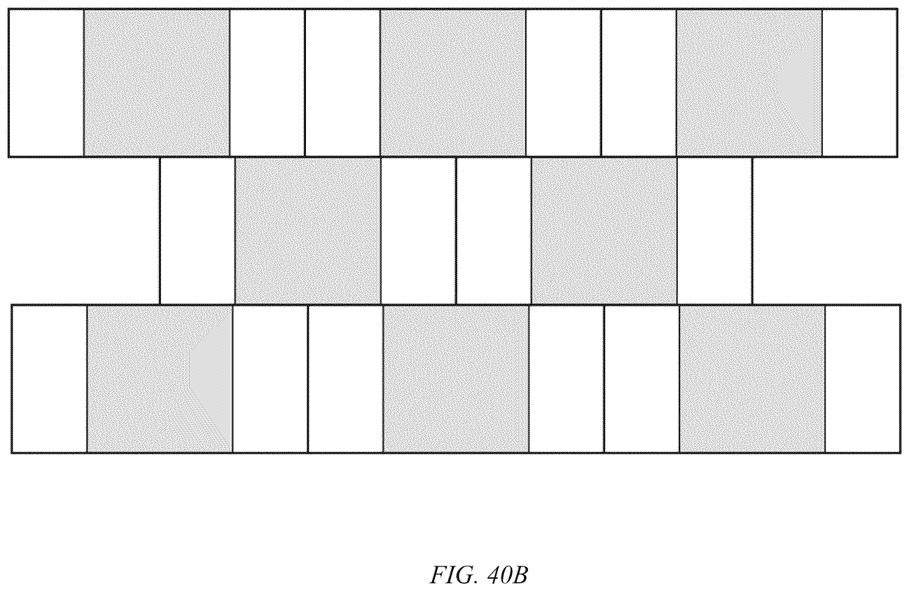

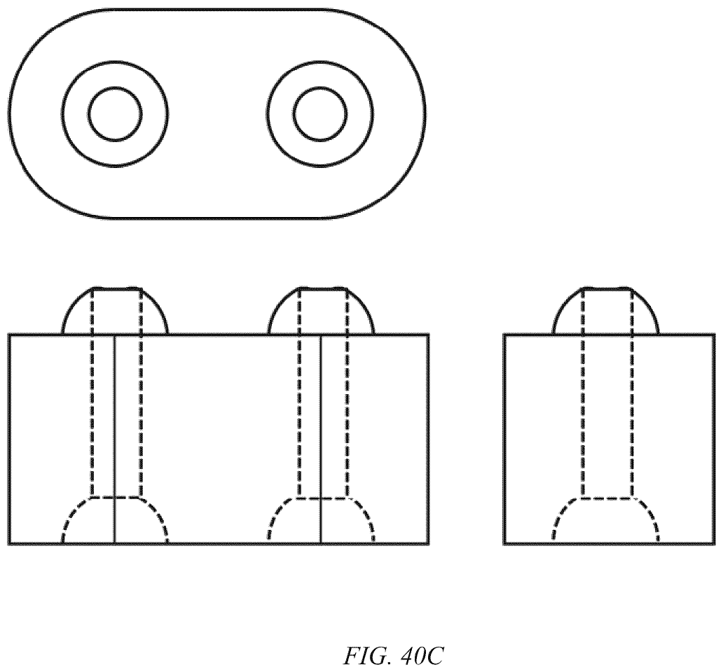

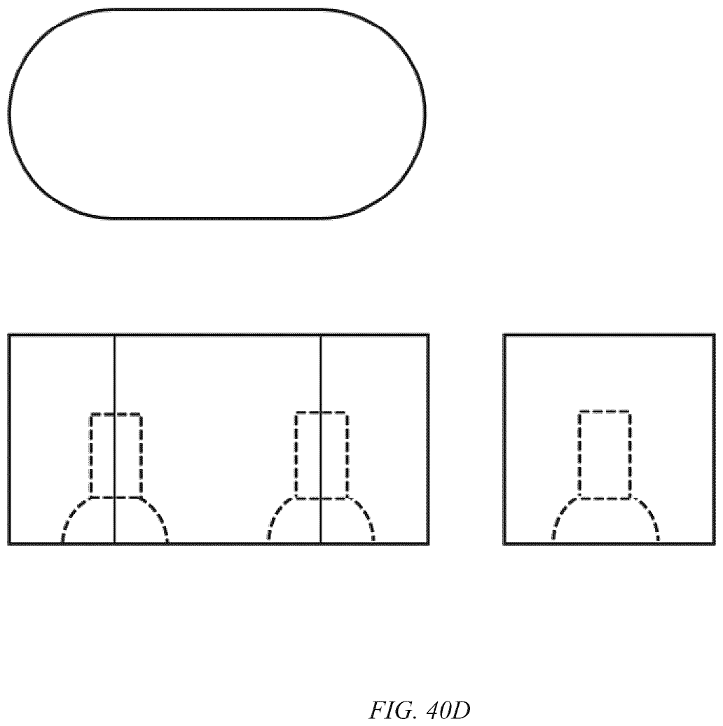

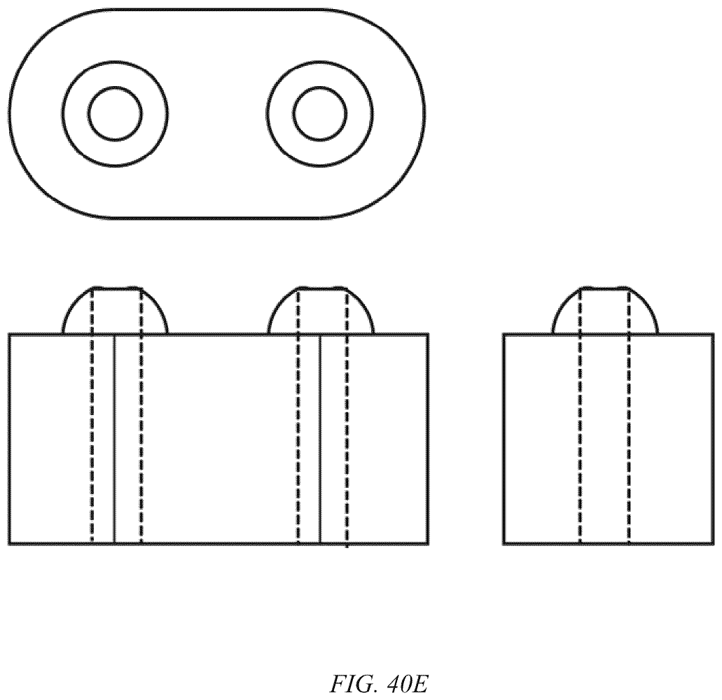

FIG. 40A shows the top view of an articulating block wall. The solid lines represent the first layer and the dashed lines represent the second layer.

FIG. 40B shows a front view of an articulating block wall. The shaded regions represent the flat faces and the white regions represent the round faces.

FIG. 40C shows three views of an articulating block that forms an intermediate section of a wall. The hole in the concave and convex alignments provides for facilitated gas transfer during carbonation. Furthermore, after the wall is formed, a steel rebar can be placed in the hole to strengthen the wall. Concrete or cement fills the annular space between the steel rebar and the block.

FIG. 40D shows three views of an articulating block that forms the top section of a wall.

FIG. 40E shows three views of an articulating block that forms the bottom section of a wall.

### Artificial Reefs

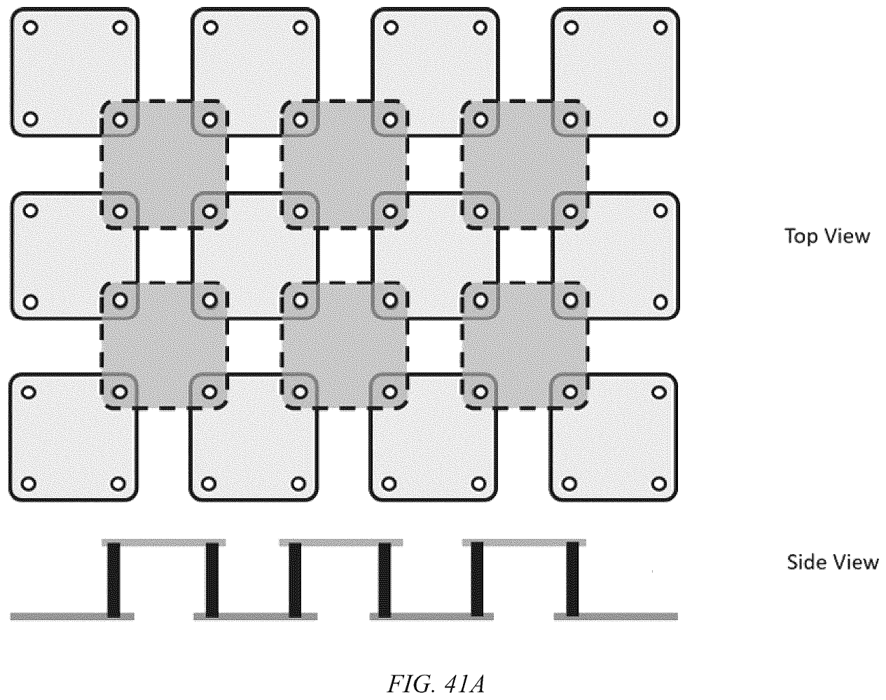

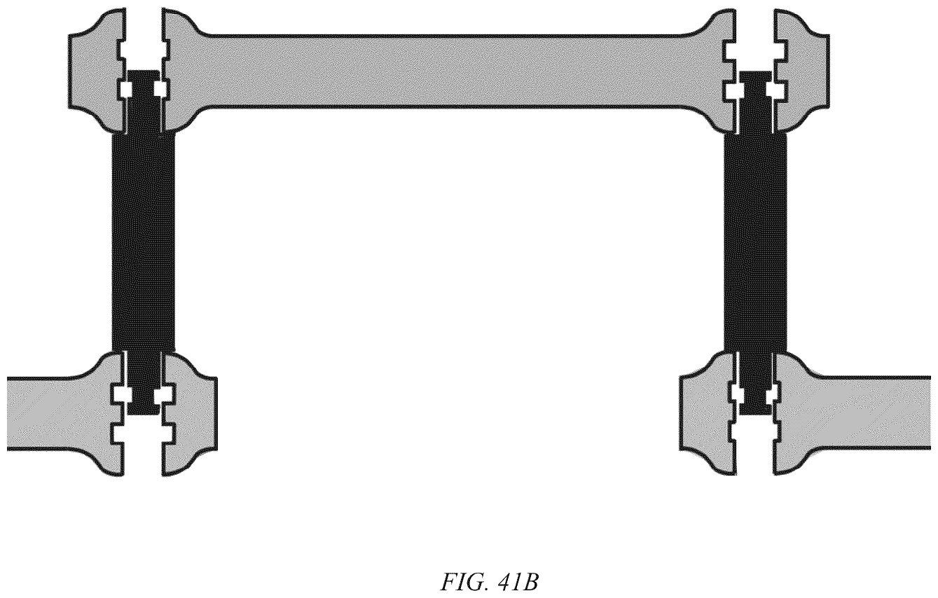

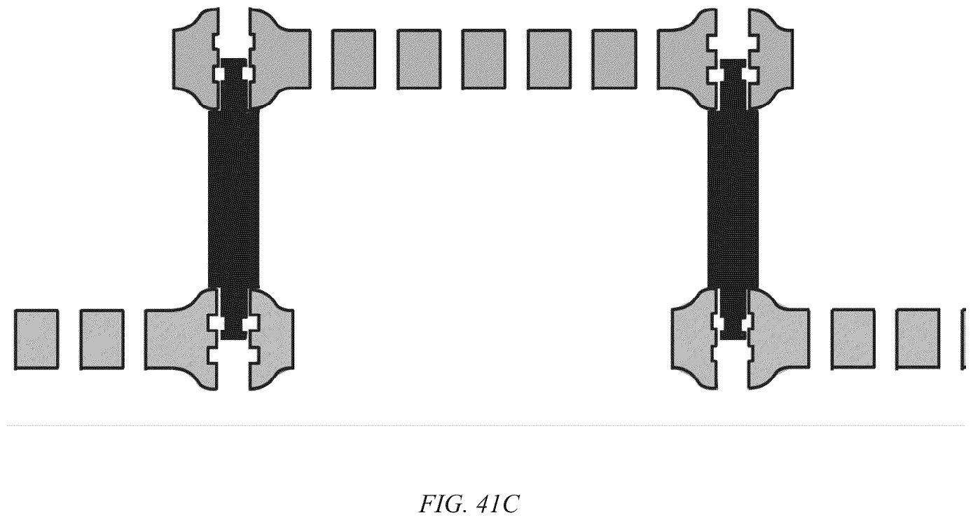

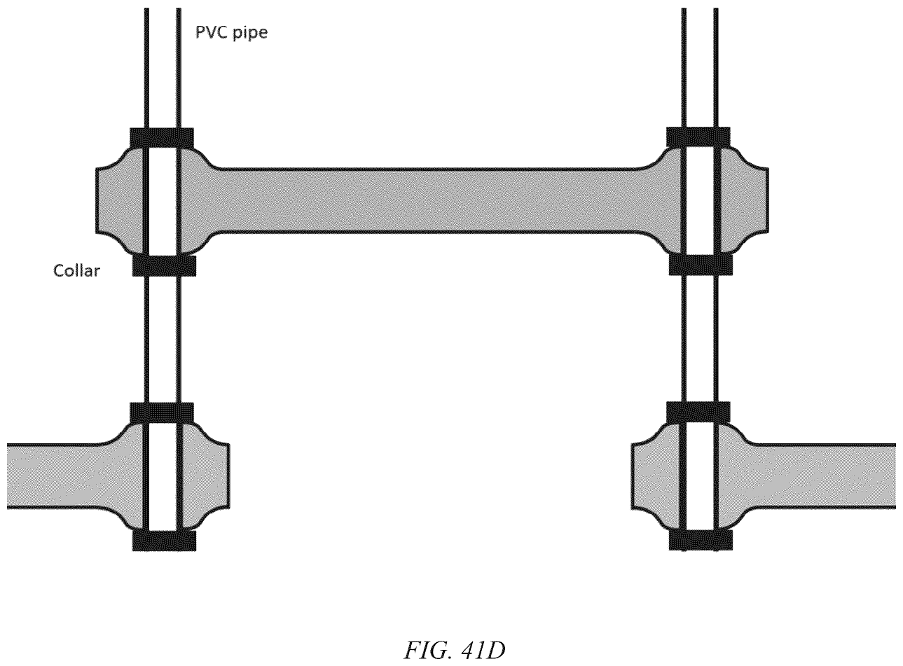

Artificial reefs can be placed under the ocean to serve as habitat for fish and a substrates for coral attachments. FIG. 41A shows a top and side view. Plates are arranged in a grid pattern separated by vertical columns. FIG. 41B shows one option in which the columns are made from cementitious material secured with grout. Once the grout hardens, it creates a rigid ring that makes it difficult to separate the plates and columns. FIG. 41C shows that the plates can be perforated, which reduces material, fabrication, and transport costs. FIG. 41D shows the columns are made from PVC pipe secured with glued collars.

### Walls, Ceilings, and Floors for Buildings

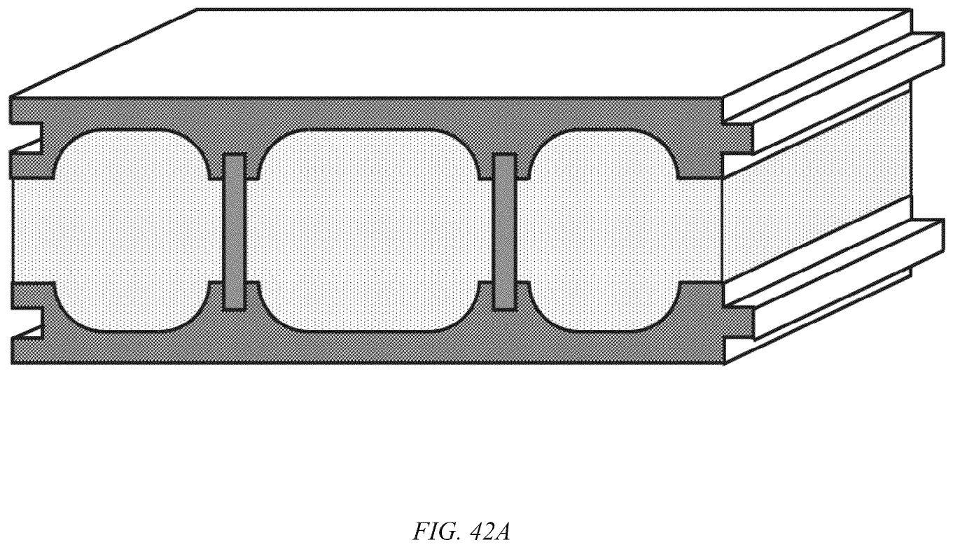

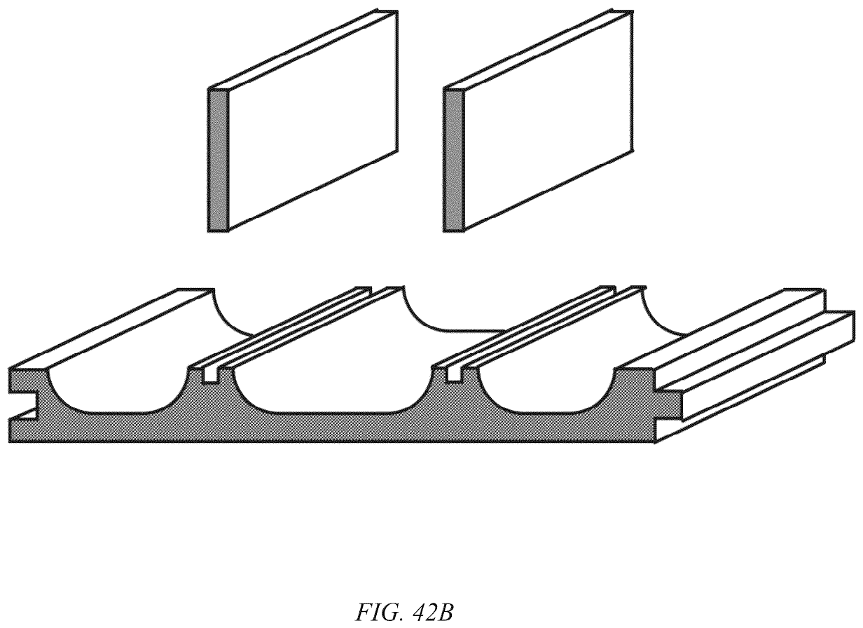

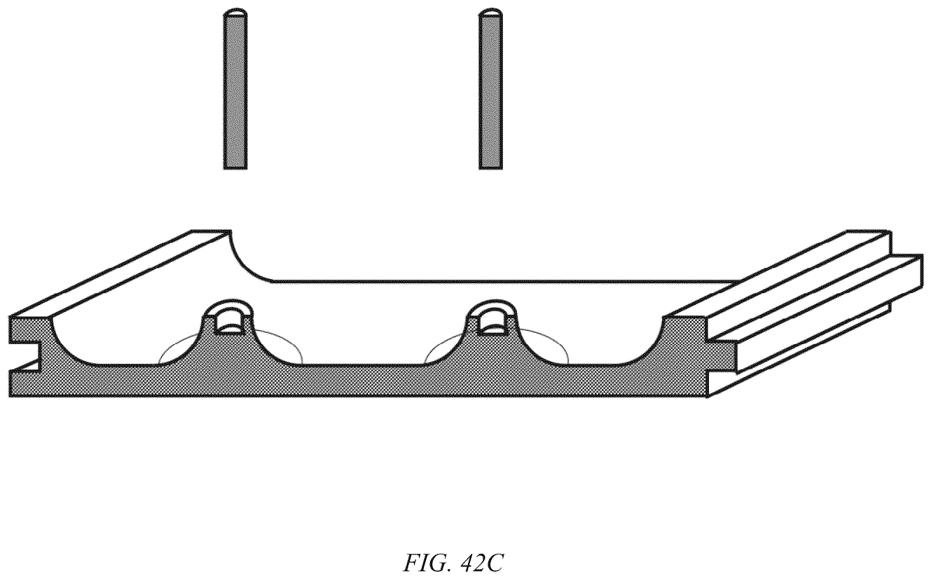

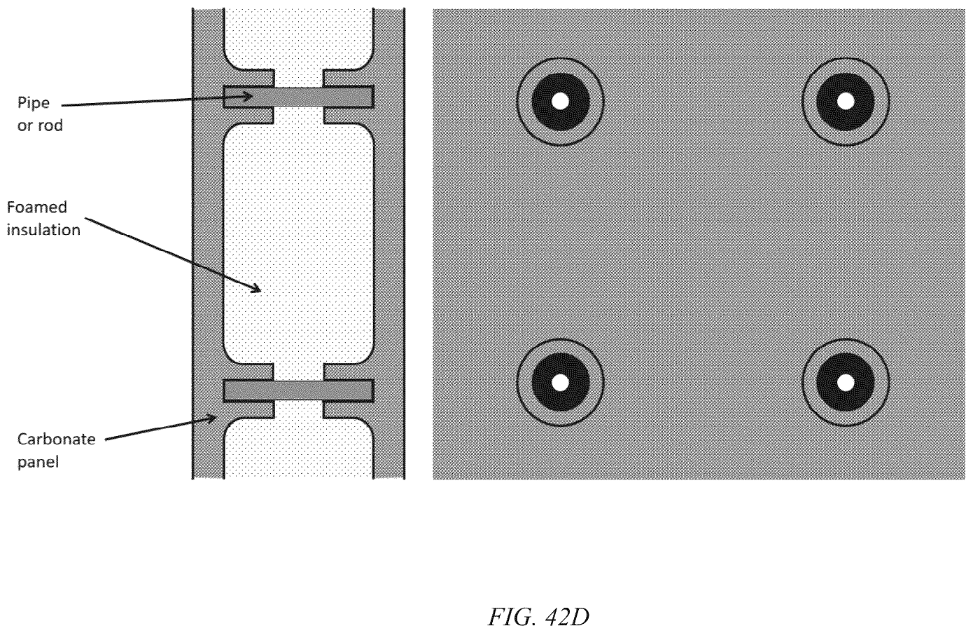

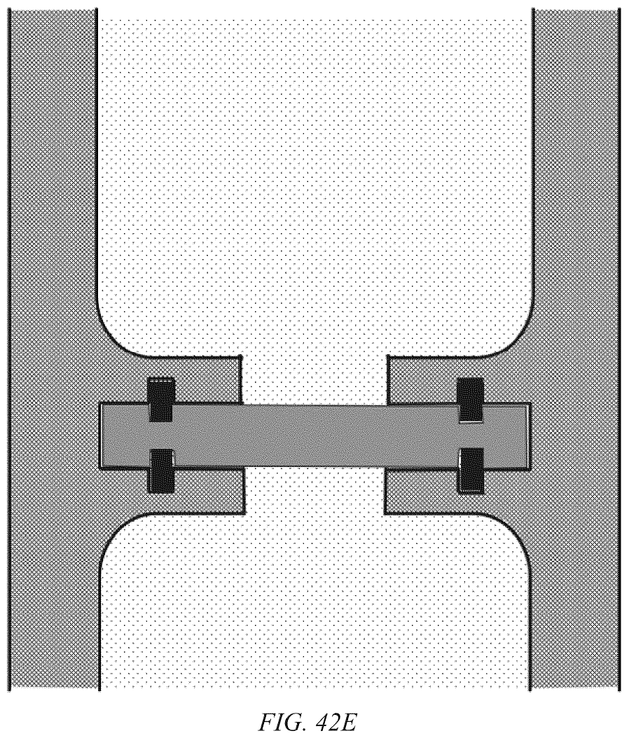

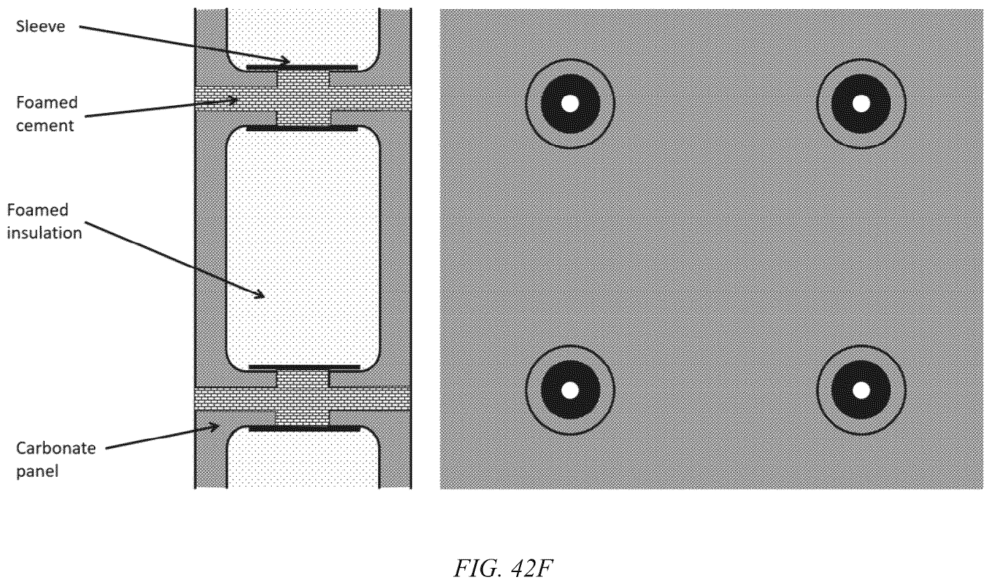

FIG. 42A shows a section of the wall, ceiling, or floor. Two flat panels are separated by spacers consisting of either boards (FIG. 42B) or rods (FIGS. 42C, 42D, and 42E). The edges of the flat panels are joined by tongue-and-groove joints. The space between the panels can be empty (not shown), or filled with insulation (shown). Preferably, the insulation is a foamed material, such as polyurethane, magnesium hydroxide (AirKrete), calcium hydroxide, foamed sodium silicate [11]. Preferably, the boards or rods have a low thermal conductivity (e.g., wood, bamboo, PVC).

FIG. 42F shows an alternative embodiment in which sleeves are used to define a tube, which is filled with foamed cement or other suitable material.

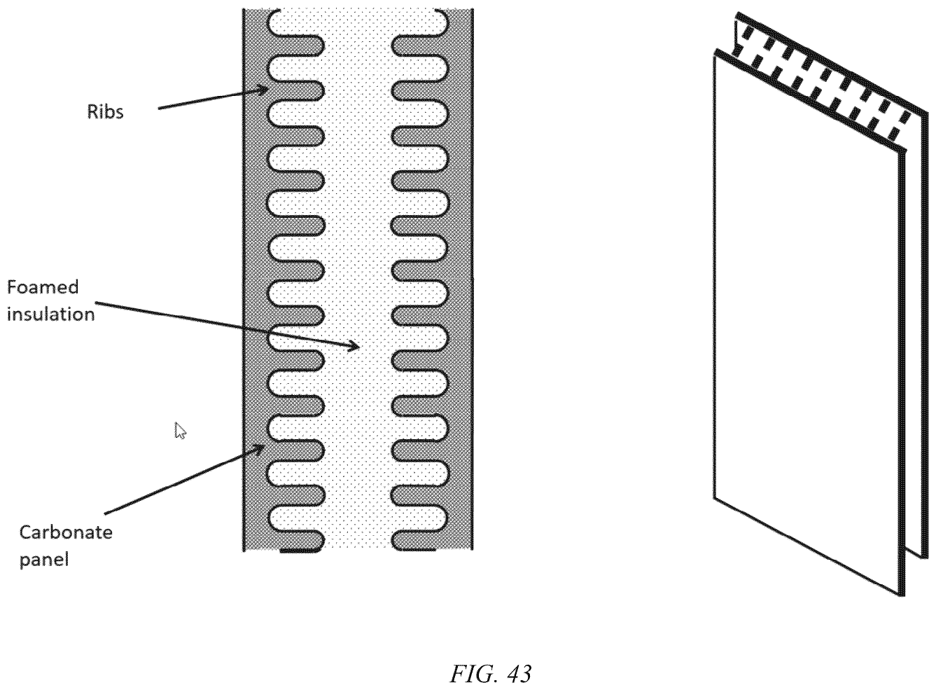

FIG. 43 shows an alternative embodiment that does not employ spacers. Ribs provide stiffness. When employed as a vertical wall, the space between the panels can be filled with an insulating material, such as polyurethane foam or AirKrete. When employed as a floor or ceiling, the space between the panels can be filled with foamed cement. The panel that is in tension can contain reinforcement (e.g., wire or glass mesh) embedded in the panel or adhered to the surface.

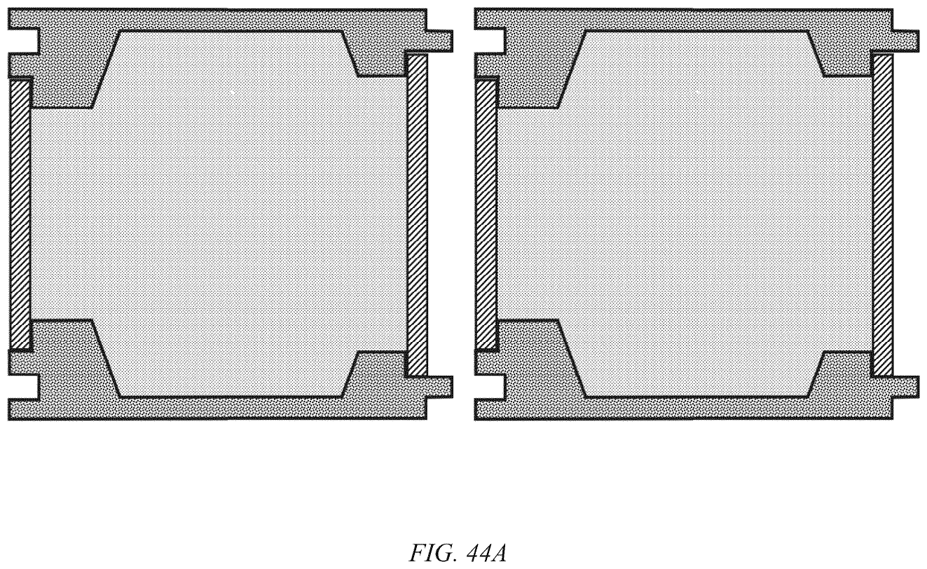

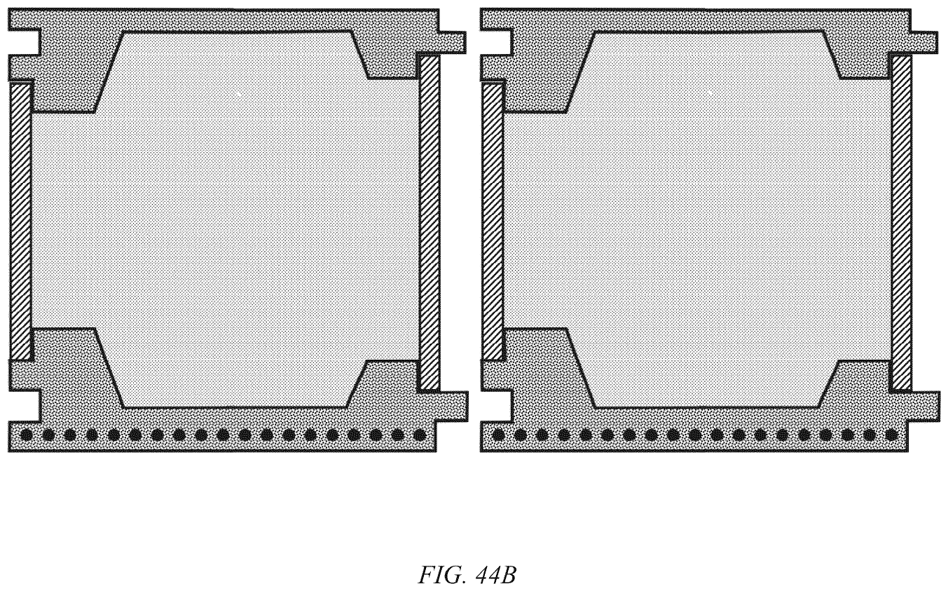

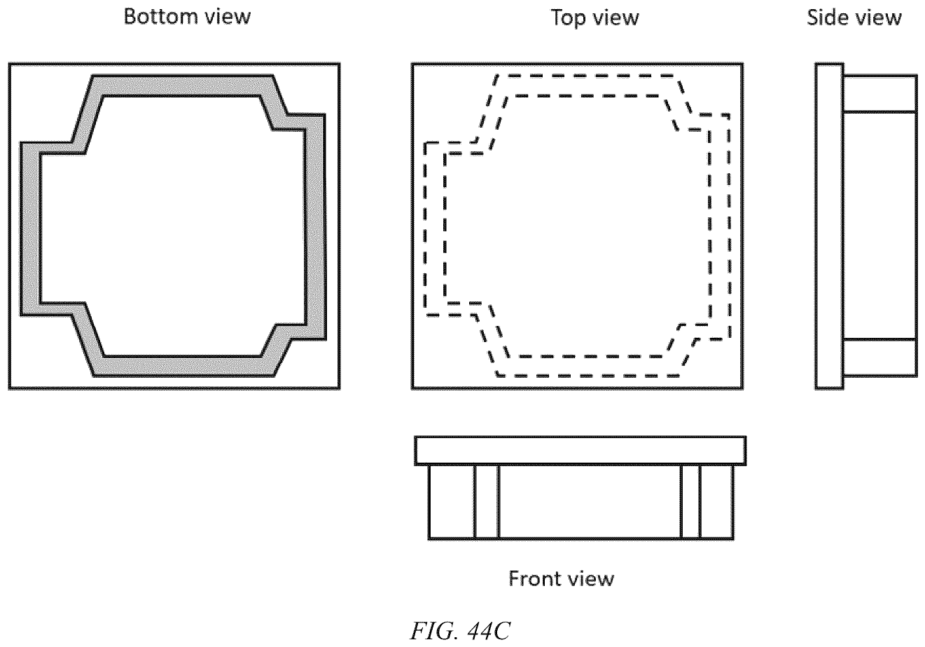

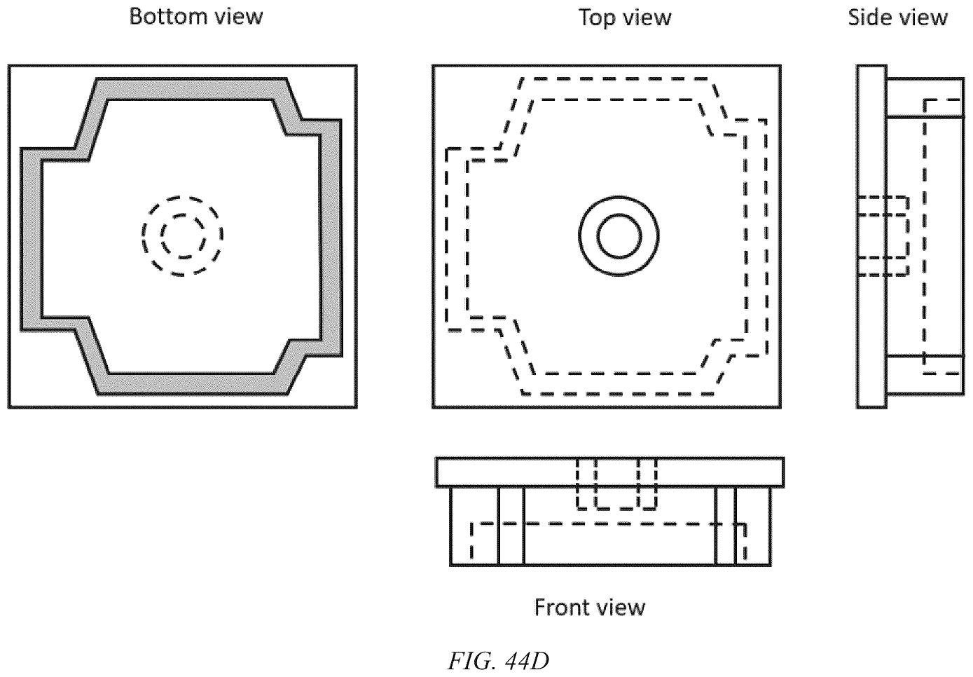

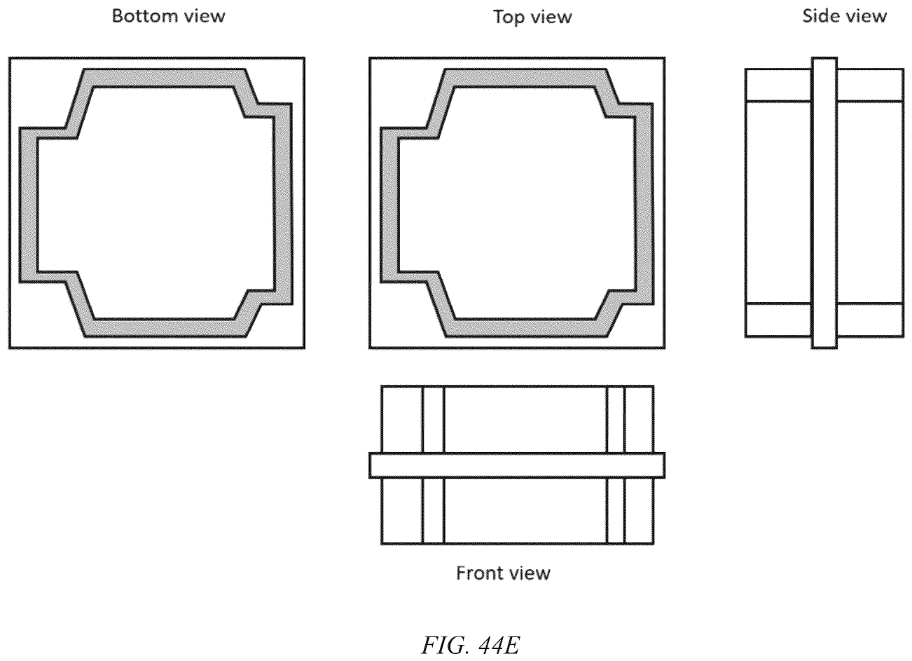

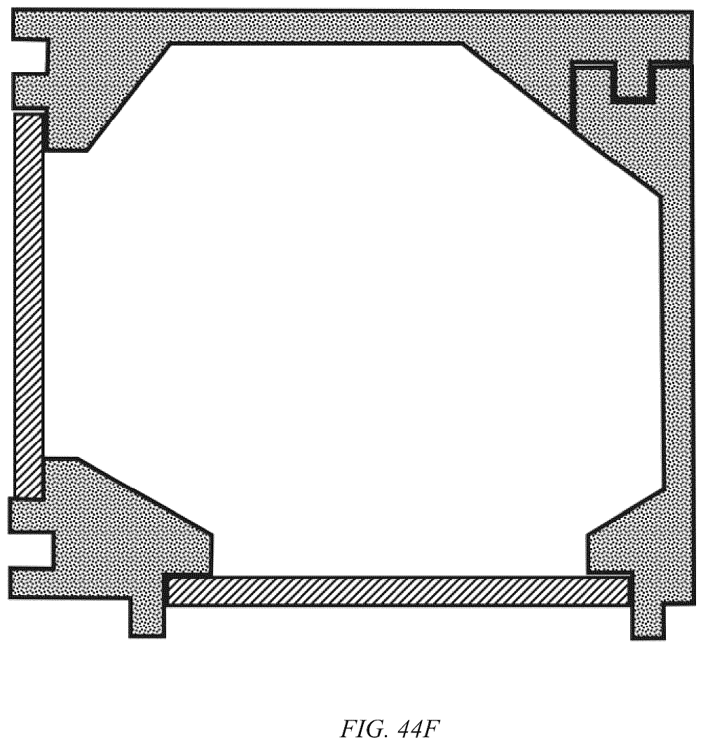

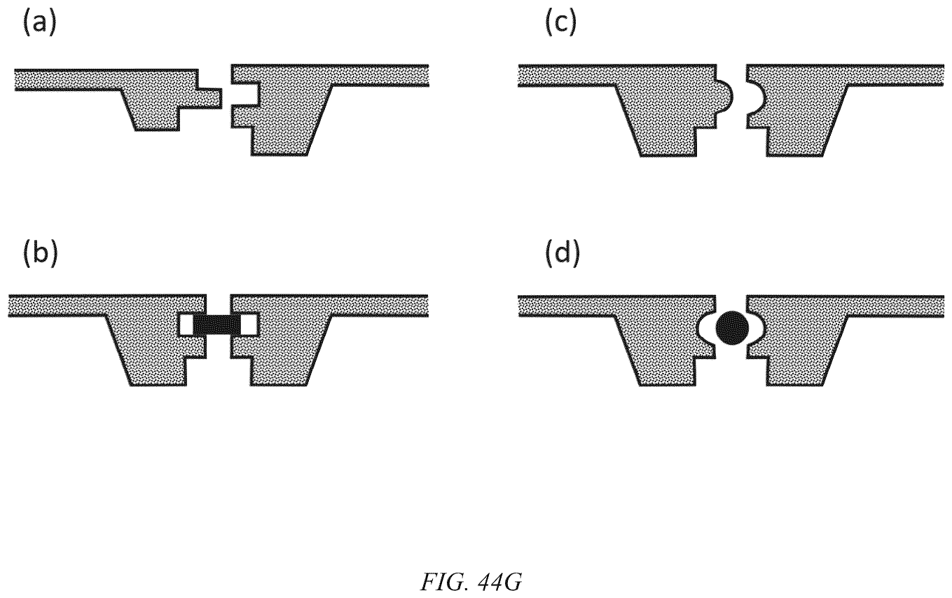

FIG. 44A shows two sections of hollow columns of a wall that are joined by a tongue-and-groove interlocking system. Each cementitious panel has a tongue at one end and a grove at the other end. These connector systems also stiffen the panels and thereby reduce the potential for buckling. The volume between the panels is filled with insulation, such as foamed magnesium oxide (AirKrete). Sheets located at each end of the cementitious panel serve as spacers, and also define the boundaries of the insulation. Preferably, the sheets have a low thermal conductivity. Examples of potential sheet materials are shown in Table 19.

FIG. 44B shows two sections of hollow columns of a floor or ceiling that are joined by a tongue-and-groove interlocking system. The panels at the bottom are in tension, which is where cementitious materials are week. To reinforce the members in tension, the panels can use embedded mesh made from materials that are strong in tension, such as metal, plastic, glass, or carbon fiber. Alternatively (not shown), the reinforcement can be bonded to the exterior surface rather than embedded. To reduce heat transfer, the volume between the panels is filled with insulation, such as foamed magnesium oxide (Airkrete). Sheets located at each end of the cementitious panel serve as spacers, and also define the boundaries of the insulation. Preferably, the sheets have a low thermal conductivity, but also must have the required strength to bear loads.

FIG. 44C shows an optional end cap that can be inserted into each end of the hollow columns described in FIGS. 44D and 44E.

FIG. 44D shows an end cap that has an embedded threaded insert, which allows components to be attached to the end cap.

FIG. 44E shows a splicing insert that joins two hollow columns together.

FIG. 44F shows a right-angle corner for wall.

FIG. 44G shows various methods for joining hollow columns besides the tongue-and-groove system described previously.

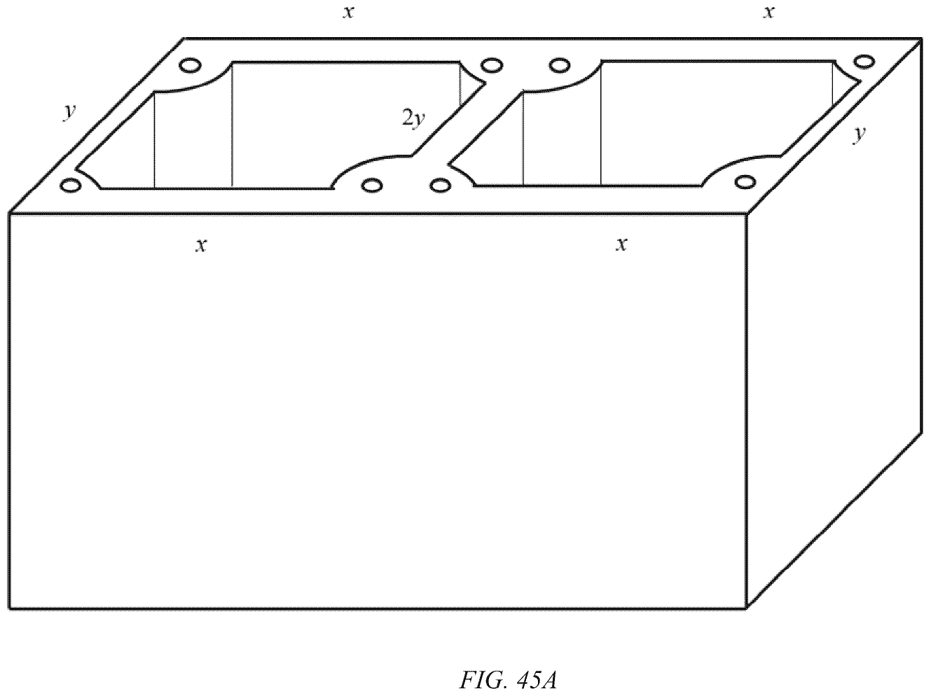

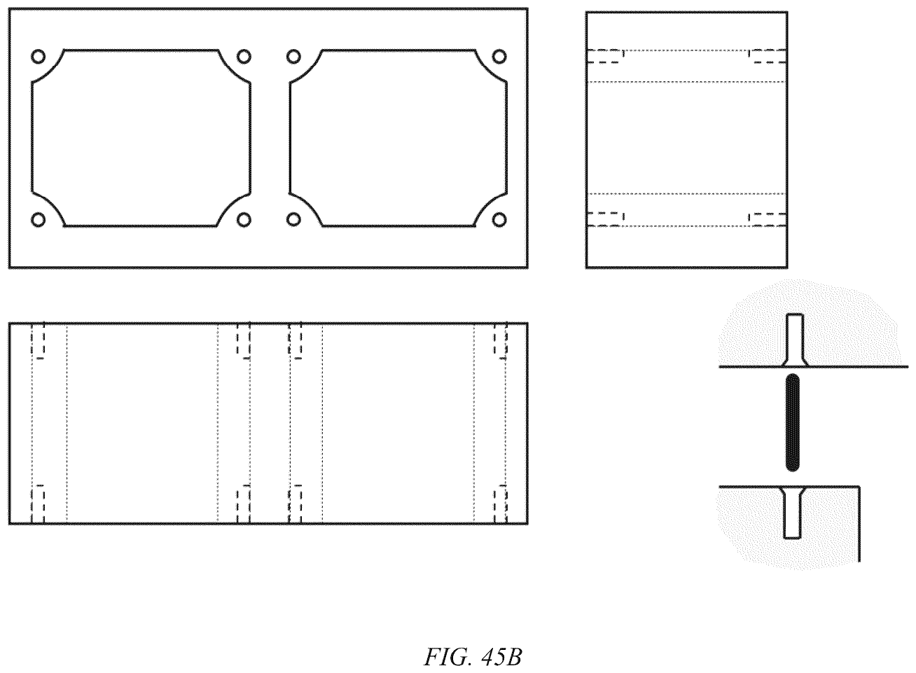

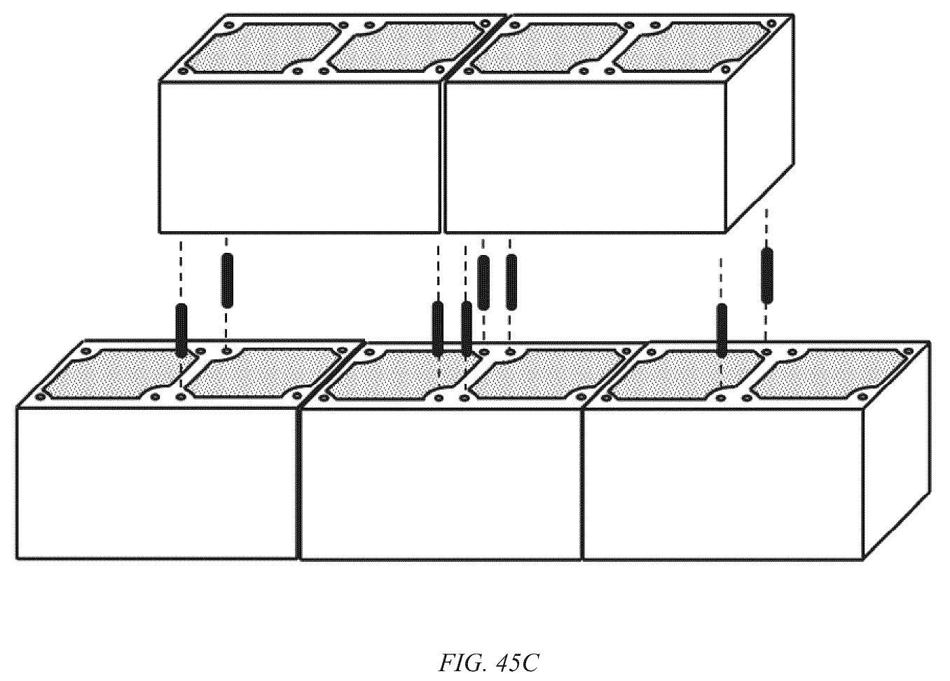

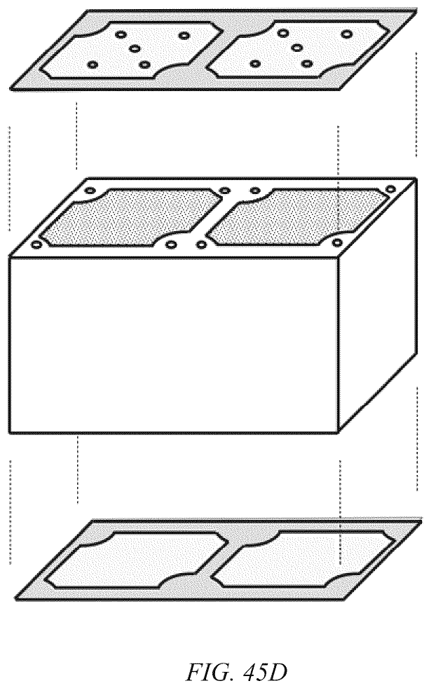

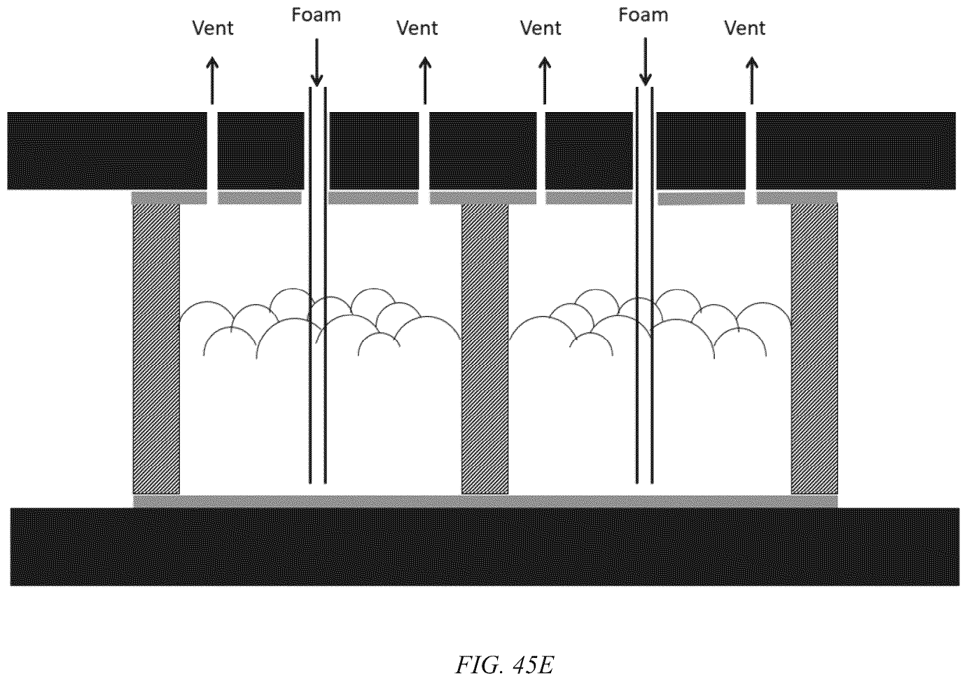

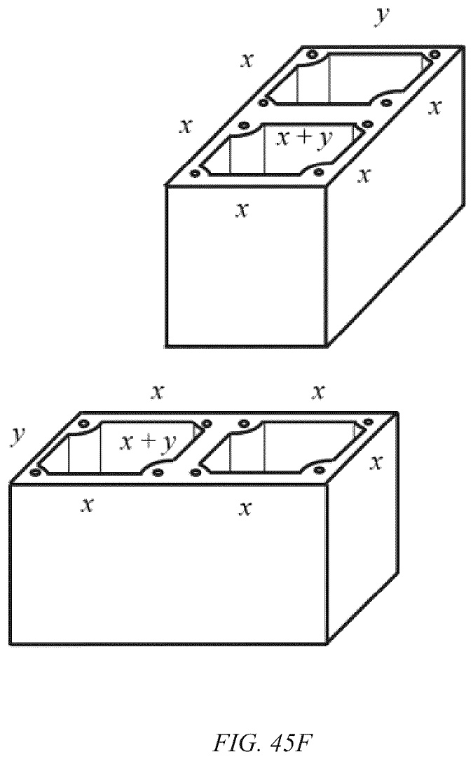

FIGS. 45A and 45B show stackable blocks that are aligned with pins. To facilitate installation, the pins are tapered at each end and the holes are flared (see detail in FIG. 45B). In FIG. 45A, the letters x and y refer to the thickness of the wall.

In a preferred embodiment, the hollow core of the blocks will contain foamed insulation. FIG. 45C shows the center of the block filled with insulating foam. In some cases (e.g., AirKrete), the foam is fragile. To protect it during shipping, the open faces can be covered with removable plastic film (FIG. 45D). In a preferred embodiment, the portion of the film that contacts the block has an adhesive whereas the portion that contacts the insulating foam is adhesive-free. The top film has holes that are used when filling the void with insulating foam.

In a preferred embodiment, the plastic film is installed before the foam is added. FIG. 45E shows the block with the installed film is sandwiched between two rigid plates. One of the plates has holes that allow tubes to be inserted through the holes in the plastic film. Foam flows through the tube into the empty chambers while air flows out of the vent holes. When the chambers are filled with foam, the tubes are removed and the block is removed from between the rigid plates while the film still attached. The film can stay attached, which protects the insulating foam during shipping. As a step in the assembly process, the plastic film is removed prior to final installation.

FIG. 45F shows the blocks that allow for a right-angle corner. In FIG. 45F, the letters x and y refer to the thickness of the wall, and they have the same numerical value for both types of blocks.

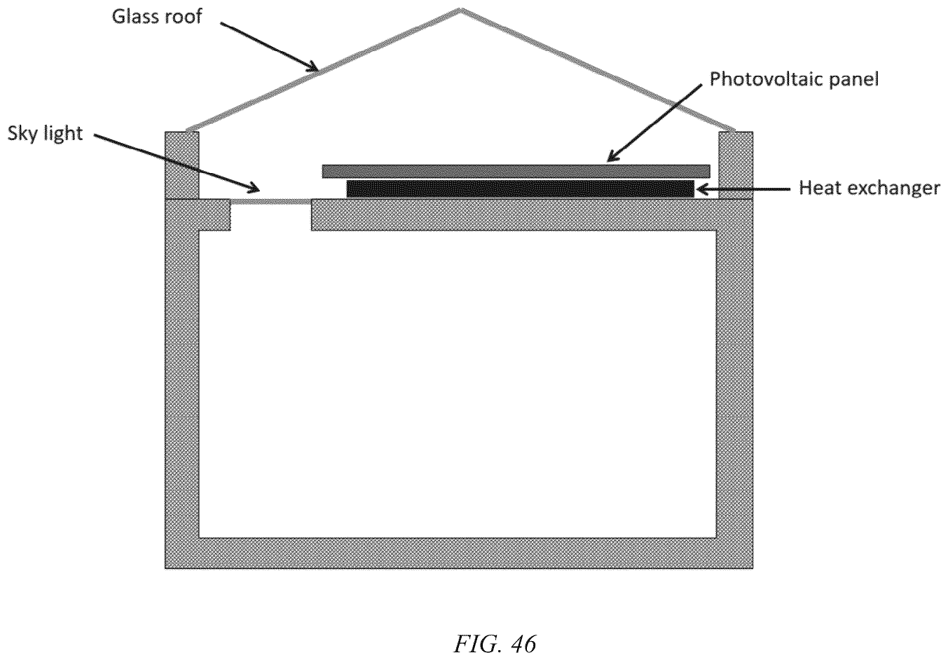

FIG. 46 shows how the walls, ceilings, and floors can be assembled into a building. The roof would be glass, which allows light to enter through sky lights and thereby provide natural light into the interior space. Photovoltaic solar panels are placed in the attic to generate electricity. Heat exchangers below the photovoltaic solar panels remove heat, which extends the life of the solar panels and improves efficiency. In the winter, the collected heat can be used to provide warmth to the interior. Throughout the year, the collected heated can be used to provide hot water for washing clothes, bathing, etc.

Although the fabricated items were described as being constructed from synthetic stone, they could be fabricated from conventional pozzolanic materials, such as cement or concrete.

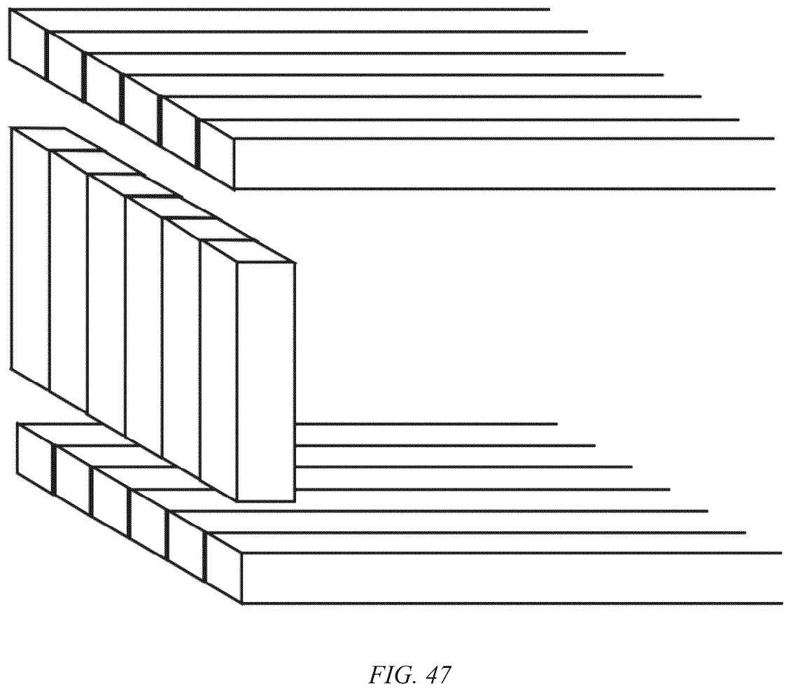

FIG. 47 shows how walls, floors, and ceilings can be assembled from hollow columns.

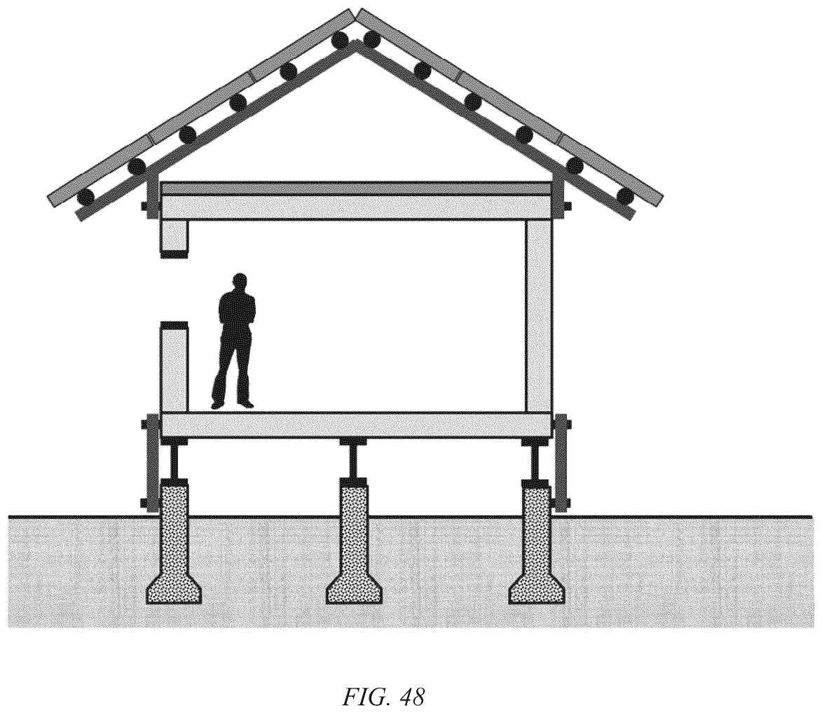

FIG. 48 shows a house constructed from the hollow columns. The walls and ceiling could be placed on a conventional concrete slab foundation; however, the slab conducts heat and interferes with thermoregulation of the house. As shown in FIG. 48, the floor is constructed from hollow columns. Although the hollow-column floor could be placed on a conventional slab, in this case, to reduce costs, the house is supported by a pier-and-beam system. As shown, steel I-beams rest on the piers and the hollow columns rest on the steel I-beams. To ensure the entire structure is secure if confronted with strong winds, the structure is tied down to the piers, which are embedded securely into the soil. The straps couple to fittings embedded into the piers and to the end caps that have embedded threaded inserts (FIG. 44D). The upper surface of the ceiling is sealed with a roofing membrane. Optionally, a frame secures solar panels onto the structure. To improve solar panel efficiency, a fan flows ambient air under the panels to keep them cool.

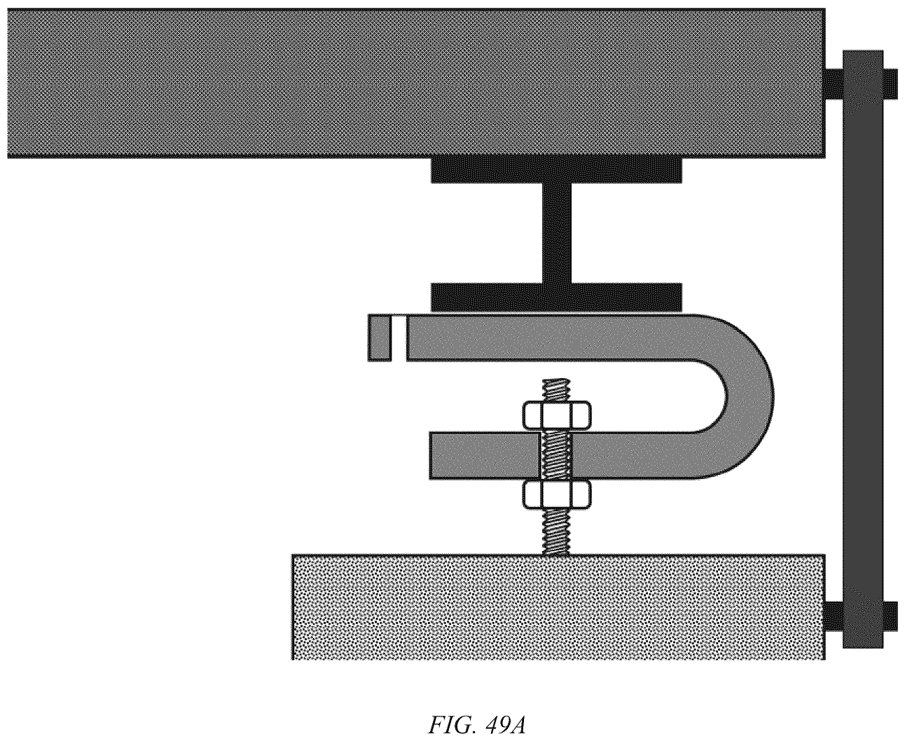

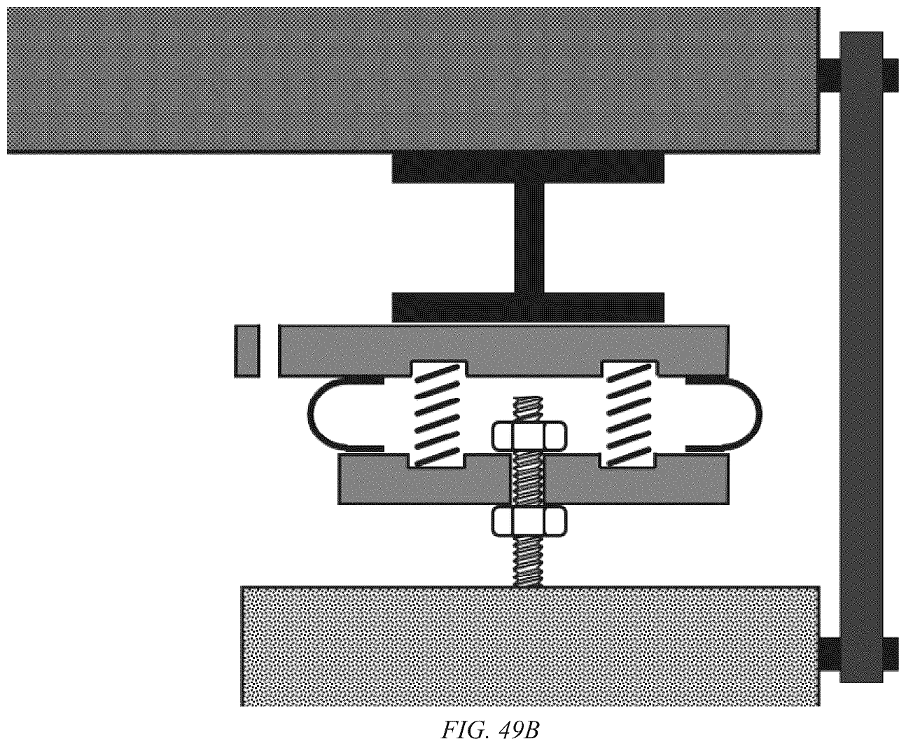

FIG. 49A shows a U-spring coupling between the floor and the pier. A mounting hole is included that can hold a scale used while laser leveling the home by adjusting the nuts.

FIG. 49B shows a similar coupling that uses helical springs. U-shaped metal sheets ensure the two end plates are properly aligned.

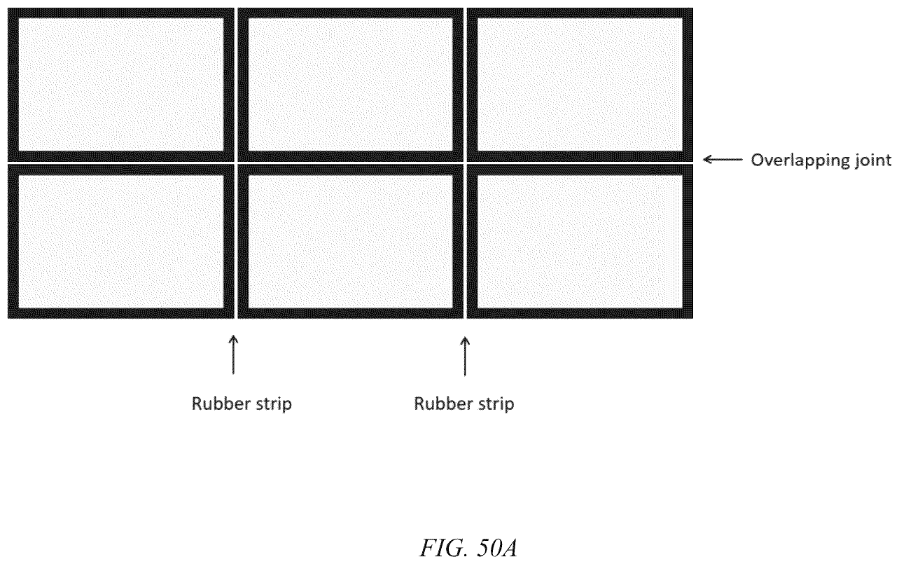

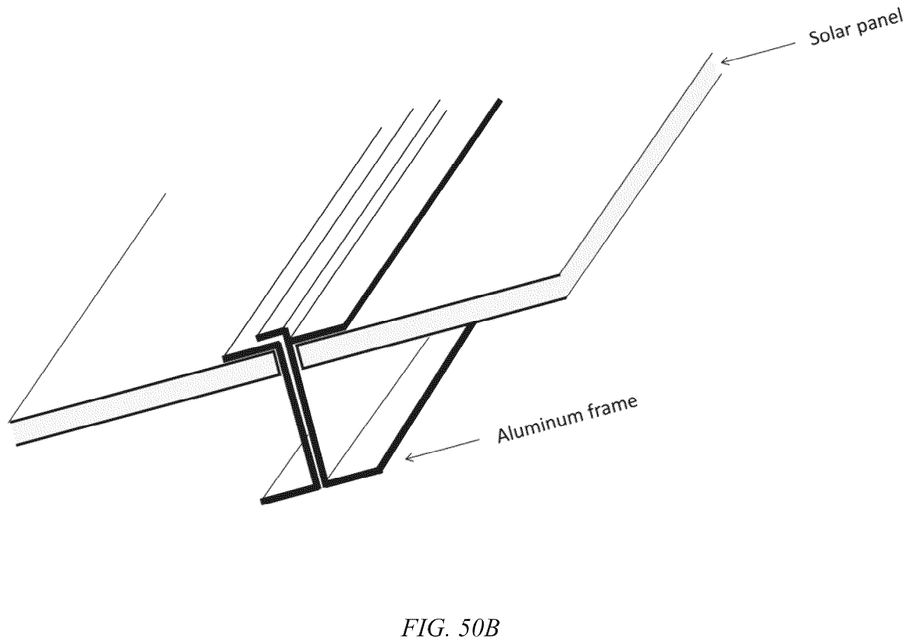

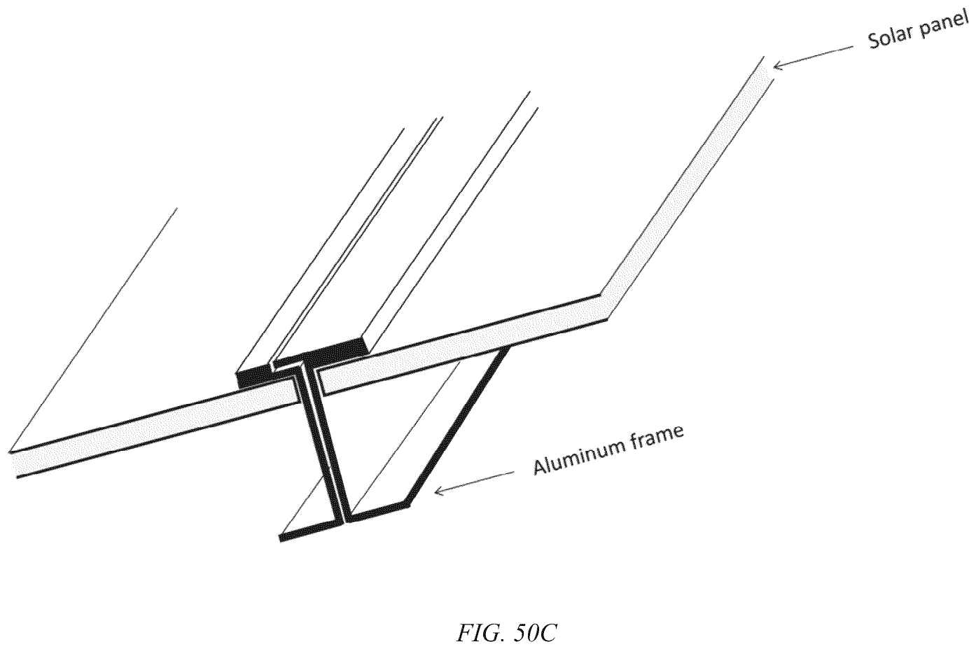

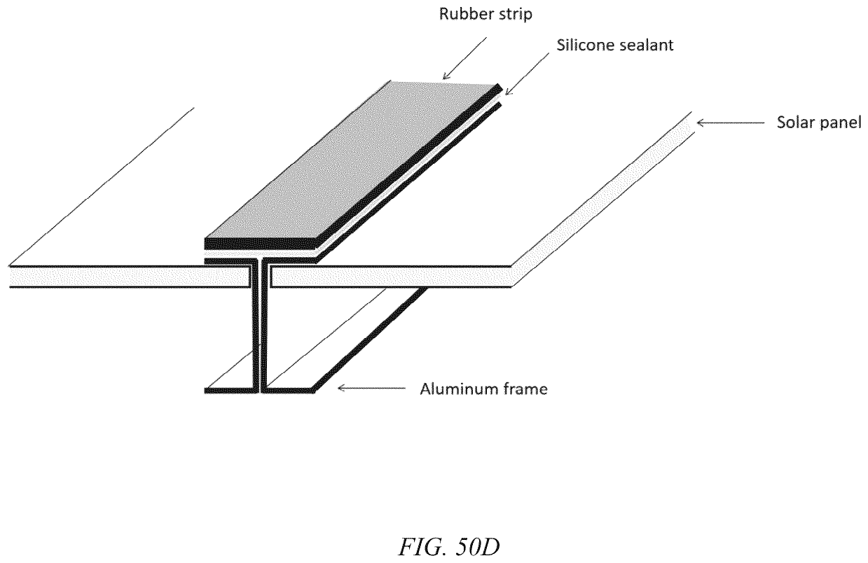

FIG. 50A shows a solar array that can optionally be added to the home.

FIGS. 50B and 50C show overlapping joints for the solar array.

FIG. 50C shows how to seal the individual solar panels to reduce or eliminate water leakage. The joints between the solar panels would be overlaid with a weather-resistant rubber strip, which could be made from EPDM (ethylene propylene diene monomer) rubber. The EPDM could be secured using silicone sealant designed to bond to EPDM (e.g., Akfix 907N EPDM Silicone Sealant, Dicor 501LSB-1 EPDM Lap Sealant, or Rust-Oleum EPDM Butyl Lap Sealant).

Although this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure,

### References

[1] https://www.nrcs.usda.gov/Internet/FSE_DOCUMENTS/nrcs143_024034.pdf

[2] Weili Wu, Qingtao Wang, and Wei Li, Comparison of Tensile and Compressive Properties of Carbon/Glass Interlayer and Intralayer Hybrid Composites, Materials, 11, 1105 (2018).

[3] M. Cao, L. Li, M. Khan, Effect of hybrid fibers, calcium carbonate whisker and coarse sand on mechanical properties of cement-based composites, Materiales de Construccion, 68(330), 1-13 (2018).

[4] https://www.corrosion-doctors.org/Household/Glass.htm

[5] https://www.greefield.com/iron-oxide-brown-663_pigment.html

[6] https://www.gloeffex.com/collections/super-phosphorescent-glow-powder

[7] Roland Benedix, Frank Dehn, Jana Quaas, Marko Orgass, Application of Titanium Dioxide Photocatalysis to Create Self-Cleaning Building Materials. https://d3pcsg2wjq9izr.cloudfront.net/files/24683/download/23222/Self-CleanMaterials.pdf

[8] https://clmfireproofing.com/how-does-fire-affect-structural-steel/

[9] https://www.researchgate.net/figure/Variation-of-fractional-decomposition-with-temperature-in-the-decomposition-range-of-SrCO_fig2_250982511

[10] Xiaoming Liu, Haifang Wen, Tuncer Edil, and Craig H. Benson, Stabilization of Flue Gas Desulfurization By-Products with Fly Ash, Cement, and Sialite, Journal of the Transportation Research Board, Transportation Research Record 2204 (December 2011).

[11] S. Zhang, Y-R Lee, J-W Ahn, W-S Ahn, Sodium silicate insulating foam reinforced with acid-treated fly ash, Materials Letters, 218, 56-59 (2018). https://www.sciencedirect.com/science/article/pii/S0167577X18301678

[12] https://www.climate-policy-watcher.org/geological-storage/info-wta.html

[13] https://link.springer.com/article/10.1007/s12665-022-10320-0

[14] https://www.matweb.com/search/datasheet_print.aspx?matguid=d1844977c5c8440cb9a3a967f8909c3a

[15] https://www.linkedin.com/pulse/reactive-powder-concrete-rpc-alireza-tayari/

[16] Richard P, and Cheyrezy M, Composition of Reactive Powder Concrete, Cement and Concrete Research, Vol. 25, No.7, pp. 1501-1511 (1995).

[17] Blais P. Y, and Couture M, Precast, Prestressed Pedestrian Bridge—World's first reactive powder concrete structure, PCI Journal, Vol. 44, pp. 60-71 (1999).

[18] Matte V and Moranville M, Durability of Reactive Powder Composites: Influence of Silica Fume on the leaching properties of very low water/binder pastes, Cement and Concrete Composites, 21, pp. 1-9 (1999).

[19] Staquet S, and Espion B, Influence of Cement and Silica Fume Type on Compressive Strength of Reactive Powder Concrete, 6th International Symposium on HPC, University of Brussels, Belgium, pp. 1-14 (2000).

[20] http://www.theconcreteportal.com/reac_pow.html

[21] https://www.hindawi.com/journals/amse/2019/9271507/

[22] S. K. Agarwal, Pozzolanic activity of various siliceous materials, Cement and Concrete Research, 36, 1735-1739 (2006).

[23] P. De Silva, L Bucea, V. Sirivivatnanon, Chemical, microstructural and strength development of calcium and magnesium carbonate binder, Cement and Concrete Research, 39, 460-465 (2009).

[24] https://www.nature.com/articles/s41598-019-42761-2

D. K. Potter, T. M. AlGhamdi, and O. P. Ivakhnenko, Sensitive carbonate rock characterization from magnetic susceptibility: Mineral quantification, correlation with petrophysical properties, and anisotropy, SCA2008-10, International Symposium of the Society of Core Analysts, Abu Dhabi, UAE, 29 October to 2 Nov. 2008.

What is claimed is:

1. The embodiments disclosed.
